(19) United States
(12) Patent Application Publication
(10) Pub. No.: US 2016/0337105 A1
(43) Pub. Date: Nov. 17, 2016

(54) CHANNEL AND NOISE ESTIMATION FOR DOWNLINK LTE

(71) Applicant: INTERDIGITAL TECHNOLOGY CORPORATION, Wilmington, DE (US)

(72) Inventors: William E. Lawton, Pottstown, PA (US); Manasa Raghavan, Sunnyvale, CA (US); Lakshmi R. Iyer, King of Prussia, PA (US); Muhammad U. Fazili, Audubon, PA (US); Louis E. Pouliot, Montreal (CA); Allan Y. Tsai, Boonton, NJ (US); Alpaslan Demir, East Meadow, NY (US); Shane S. Supplee, Downingtown, PA (US)

(73) Assignee: INTERDIGITAL TECHNOLOGY CORPORATION, Wilmington, DE (US)

(21) Appl. No.: 15/156,148

(22) Filed: May 16, 2016

Related U.S. Application Data
(60) Provisional application No. 62/161,774, filed on May 14, 2015.
(60) Provisional application No. 62/161,689, filed on May 14, 2015.
(60) Provisional application No. 62/161,781, filed on May 14, 2015.

(51) Int. Cl. H04L 5/00; H04W 72/04; H04L 12/26

(52) U.S. Cl. CPC H04L 5/0057; H04L 5/0007; H04L 5/006; H04L 43/16; H04W 72/042

(57) ABSTRACT

Systems, methods, and instrumentalities for a WTRU to perform channel estimation and/or noise estimation are provided. The techniques described herein may be used to perform channel estimation and/or noise estimation that meet certain performance and latency goals while utilizing a lower cost design than previous channel/noise estimation techniques. For example, the channel estimation/noise estimation techniques described herein may be implemented using less memory (e.g., less memory for storing filter coefficients) while still achieving the desired latency and performance goals. The techniques described herein may be implemented by any WTRU and/or by a WTRU specifically designed to be low-cost.

### CROSS-REFERENCE TO RELATED APPLICATIONS

This application claims the benefit of U.S. Provisional Patent Application No. 62/161,774, filed May 14, 2015; U.S. Provisional Patent Application No. 62/161,689, filed May 14, 2015; and U.S. Provisional Patent Application No. 62/161,781, filed May 14, 2015, the contents of all of which are incorporated by reference as if fully set-forth herein in their respective entirety, for all purposes.

### BACKGROUND

Orthogonal Frequency Division Multiplexing (OFDM) is a spectral efficient technique that facilitates communication over frequency selective fading channels. It has been adopted as the basic modulation scheme for many modern broadband wireless communication systems, such as Institute of Electrical and Electronics Engineers (IEEE) 802.11a/g/n Wireless Local Area Networks (WLAN), IEEE 802.16d/e Wireless Metropolitan Area Networks (WiMAX) and Third Generation Partnership Project (3GPP) Long Term Evolution (LTE) systems.

In OFDM, a large number of closely spaced orthogonal subcarriers are used to transmit data. The data are divided into several parallel data streams, one for each sub-carrier. Each sub-carrier is modulated with a conventional modulation scheme such as QAM, PSK, BPSK, or QPSK, at a low symbol rate while maintaining total data rate similar to single carrier modulation schemes in the same channel bandwidth. The baseband signal in an OFDM system is the sum of these modulated sub-carriers, which is then used to modulate a main RF signal. An important aspect of the demodulation of such a signal, and thereby retrieving the underlying baseband signal, involves processing it by a Fast Fourier Transform (FFT). The benefits of OFDM are high spectral efficiency, resiliency to radio-frequency (RF) interference and multi-path propagation.

In a communication system (e.g., LTE) variations in the phase and amplitude may be introduced into the transmitted signals as they propagate along the channel. These variations may be referred to as the channel response. The channel response may be frequency and/or time-dependent. If the receiver can determine the channel response, the received signal may be corrected to compensate for the channel degradation. Channel estimation may include determining the channel response.

A resource element may carry a reference symbol (e.g., reference signal). One or more reference symbols may be used for channel estimation purposes. Channel response may be determined by comparing a received signal with an expected signal (i.e., one that the receiver would have received under ideal channel conditions). A plurality of resource elements may be distributed in the time and frequency domains in a reference symbol pattern. The reference symbol pattern may permit the channel response to be determined. The channel response may be determined by interpolating the channel responses determined for the reference symbol-carrying resource elements. Conventional interpolation methods include minimum mean-square error (MMSE) estimation, least-square (LS) estimation, linear interpolation and averaging. Traditional channel estimation procedures may require large amounts of memory (e.g., to store filter coefficients).

### SUMMARY

Systems, methods, and instrumentalities for a WTRU to perform channel estimation and/or noise estimation are provided. The techniques described herein may be used to perform channel estimation and/or noise estimation that meet certain performance and latency goals while utilizing a lower cost design than previous channel/noise estimation techniques. For example, the channel estimation/noise estimation techniques described herein may be implemented using less memory (e.g., less memory for storing filter coefficients) while still achieving the desired latency and performance goals. The techniques described herein may be implemented by any WTRU and/or by a WTRU specifically designed to be low-cost.

For example, channel estimation techniques may include receiving CRS symbols (e.g., de-rotated CRS symbols). A 2D (e.g., in time and frequency) mid-point calculation/interpolation may be performed based on the received CRS. EMA-FFT filtering may be performed. EMA-FFT filtering may include performing a symmetric band edge extension in order to extend the CRS sampling to the size of the FFT to be used. Windowing may performed in order to minimize errors near the band edge. An IFFT may be performed to determine a signal that is associated with the impulse response of the channel. An EMA filter may be applied to the signal after the IFFT, for example in order to average the impulse response on a per resource element basis and/or reduce noise. The EMA filter may be based on an estimated delay spread, an estimated Doppler shift (e.g., effect), and/or an estimated signal to noise ratio (SNR). A Zero Forcing function may be applied, for example in order to zero out portions of the impulse response that are determined to be outside of the cyclic prefix of the transmission and/or below a threshold. The zero forcing function may include a roll-off which may partially zero out certain portions of the impulse response and may completely zero out other portions of the impulse response (e.g., completely zero out portions known to be outside the cyclic prefix). An FFT may be performed, for example to convert the signal back to the frequency domain. De-windowing and band-edge removal and/or replacement may then be performed. As a result, a signal representing a channel estimation may be achieved.

The noise estimation may be based on the signal has been converted to an impulse response by the IFFT (e.g., prior to EMA filtering and/or zero forcing). The noise region may be extracted from the signal representing the impulse response. In order to reduce correlation between symbols for noise estimation, a summation of adjacent symbols may be performed; for example, to suppress image(s) created during to mid-point calculation/interpolation. A noise power estimation may be performed by multiplying the impulse with its conjugate. A mean sample per signal may be performed. A mean over the NEST CRS ports may be performed. An EMA filtering function may be applied. As a result, an estimate of the noise power may be achieved.

Techniques for channel estimation may be performed in a wireless transmit/receive unit. Techniques may include receiving, via a receiver for example, a downlink Orthogonal Frequency Division Multiplexing (OFDM) signal. Techniques may include determining one or more Cell-Specific Reference Signal (CRS) symbols from the OFDM signal. Technique may include determining a mid-point resource element (RE) in time-domain (TD mid-point RE), perhaps for example using CRS from at least two of the one or more CRS symbols. Techniques may include determining a mid-point resource element (RE) in frequency-domain (FD mid-point RE), perhaps for example using a multiple-tap sinc filter. The FD mid-point RE may be based on at least one of the one or more CRS symbols that aligns with the TD mid-point RE. Techniques may include determining a weighted average of the TD mid-point RE and the FD mid-point RE. The weighted average may be a two-domain (2-D) mid-point RE. Techniques may include performing channel estimation based, at least in part, on the 2-D mid-point RE.

Detailed design requirements for a Layer 1 (L1) Feedback component for a Long Term Evolution (LTE) communication device (e.g., a LTE modem) are described. Component description including major functions, component architecture, modes of operation (transmission modes and CQI reporting modes), input and output interfaces, parameters and/or timeline of L1 Feedback are described. L1 Feedback algorithms (for example, including estimating Signal to Noise and Interference Ratio (SINR) and/or phase compensation, and/or a CQI mapping), functional and/or performance requirements are described. An exponential effective SINR mapping (EESM) is described. The upper bounds of Exponential Effective Signal to Noise Ratio (EESNR), performance comparisons between Joint RI/PMI/CQI, disjoint RI/PMI, and/or CQI generation. CQI distribution relative to initial CQI are described.

Techniques for generating a channel quality indicator (CQI) signal may be performed by a wireless transmit/receive unit (WTRU). Techniques may include determining a first interim effective Signal to Noise and Interference Ratio (ESINR) (first ESINR) value corresponding to a first code word (first CW) of one or more code words using a first beta value. Techniques may include determining a second ESINR value corresponding to the first CW using a second beta value. Techniques may include determining a third ESINR value corresponding to the first CW using a third beta value. Techniques may include mapping the first ESINR value to a first interim CQI index based on a linear SINR to CQI mapping. Techniques may include mapping the second ESINR value to a second interim CQI index based on the linear SINR to CQI mapping. Techniques may include mapping the third ESINR value to a third interim CQI index based on the linear SINR to CQI mapping. Techniques may include determine a final CQI from the first interim CQI index, the second interim CQI index, or the third interim CQI index. Techniques may include generating the CQI signal based at least in part on the final CQI. Techniques may include sending, via a transmitter for example, the CQI signal.

Systems, methods, and instrumentalities are disclosed for LTE cell search and measurements component design. Cell search operating modes may comprise, for example, initial cell selection, stored information cell selection and target cell selection. An LTE cell search (CS) may be performed, for example, by acquiring a coarse estimate of a carrier frequency offset (CFO), detecting a primary synchronization signal (PSS) index, e.g., by maximum likelihood (ML) PSS detection, determining a secondary synchronization sequence (SSS), extracting from the SSS a cell identity (ID) group, a frame boundary and a cyclic prefix (CP) length or type and/or determining a cell ID.

Cell search (CS) may be used by a wireless transmitter/receiver unit (WTRU) to detect, acquire information about, select and/or communicate with a cell.

Techniques for primary synchronization sequence (PSS) detection may be performed by a wireless transmit/receive unit (WTRU). Techniques may include receiving, via an antenna for example, a signal. Techniques may include performing Maximum Likelihood (ML) PSS detection on the signal. The ML PSS detection may produce one or more PSS correlation values for one or more frequency bins. Techniques may include performing parabolic interpolation using the one or more PSS correlation values between the one or more frequency bins. Techniques may include determining a first frequency bin of the one or more frequency bins. The first frequency bin may include a largest PSS correlation value of the one or more PSS correlation values. Techniques may include determining an initial estimate of a frequency offset (FO) for the PSS, perhaps for example, based at least in part on the parabolic interpolation. Techniques may include determining a PSS timing, perhaps for example, based at least in part on the first frequency bin.

Techniques for secondary synchronization sequence (SSS) detection may be performed by a wireless transmit/receive unit (WTRU). Techniques may include determining a plurality of SSS candidate locations in time domain. Techniques may include grouping one or more of the plurality of SSS candidate locations into one or more clusters, perhaps for example, based on a proximity of the SSS candidate locations to each other. Techniques may include selecting a first cluster of the one or more clusters. Techniques may include determining a reference location for the first cluster. Techniques may include performing a Fast Fourier Transform (FFT) on the reference location of the first cluster. Techniques may include applying an output of the FFT to a first SSS candidate location of the first cluster along with a first phase correction to produce a frequency domain representation of the first SSS candidate location. Technique may include applying the output of the FFT to a second SSS candidate location of the first cluster along with a second phase correction to produce a frequency domain representation of the second SSS candidate location.

### BRIEF DESCRIPTION OF THE DRAWINGS

FIG. 1A is a system diagram of an example communications system in which one or more disclosed embodiments may be implemented.

FIG. 1B is a system diagram of an example wireless transmit/receive unit (WTRU) that may be used within the communications system illustrated in FIG. 1A.

FIG. 1C is a system diagram of an example radio access network and an example core network that may be used within the communications system illustrated in FIG. 1A.

FIG. 1D is a system diagram of another example radio access network and an example core network that may be used within the communications system illustrated in FIG. 1A.

FIG. 1E is a system diagram of another example radio access network and an example core network that may be used within the communications system illustrated in FIG. 1A.

FIG. 2A and FIG. 2B depict an example diagram of a cell-specific reference signal (CRS) structure in a Sub-frame for Normal Cyclic Prefix (CP).

FIG. 3A and FIG. 3B depict an example diagram of a CRS structure in a Sub-frame for Extended CP.

FIG. 4 depicts an example diagram of a CRS and Mid-point resource element (RE) structure for Normal CP.

FIG. 5 is a block diagram depicting an example channel estimation and noise estimation system.

FIG. 6 is a block diagram depicting an example CRS CHEST Core Logic.

FIG. 7 is a chart depicting an example time domain (TD) Mid-Point for Normal CP.

FIG. 8 is a chart depicting an example frequency domain (FD) Mid-Point of a mid-band and band edges.

FIG. 9 is a chart depicting an example non-uniform sub-carrier (SC) spacing for direct current (DC) compensation.

FIG. 10 is a block diagram of an example of CIR post-processing.

FIG. 11 is a block diagram depicting an example Zero Forcing (ZF) Mask Generation.

FIG. 12 is a diagram depicting example ZF masks with roll-off and wrap-around.

FIG. 13 is a chart depicting an example channel impulse response (CIR) with CRS and CSI-RS channel estimates.

FIG. 14 is a block diagram of an example CRS based Noise Estimation.

FIG. 15 is a chart depicting an example Noise Extraction Region.

FIG. 16A and FIG. 16B are diagrams depicting example CSI-RS structure for Config 0 and Normal CP.

FIG. 17A and FIG. 17B are diagrams depicting example CSI-RS structure with Mid-point REs for Config 0 and Normal CP.

FIG. 18 is a block diagram depicting an example CSI-RS CHEST processing chain.

FIG. 19 is a diagram depicting an example CSI-RS Mid-point calculation.

FIG. 20 is a system diagram of an example Layer 1 Feedback (L1FB) overall component architecture.

FIG. 21 is an example timeline of L1FB for a normal Cyclic Prefix (CP) case.

FIG. 22 is an example illustration of periodic report for 20 MHz bandwidth (BW) (J=4): Q=4, L=1, G=2, O=−3 (unit is sub-frame).

FIG. 23 is an example algorithm block diagram for top level L1FB.

FIG. 24 is a block diagram of an example phase correction.

FIG. 25 is an example top level diagram for Channel Quality Indicator (CQI) generation.

FIG. 26 is an example top level diagram of exponential Signal to Noise and Interference Ratio (SINR) mapping.

FIG. 27 is an example flow chart of CQI generation.

FIG. 28 is an example illustration of the region of operation for radio link monitoring IN-SYNC.

FIG. 29 is an example performance comparison between disjointed PMI/RI, CQI and jointed PMI/RI/CQI.

FIG. 30 is an example histogram of CQI relative to the initial CQI.

FIG. 31 is an example of frame structure in LTE physical signaling.

FIG. 32 is an example of Cell Search components.

FIG. 33 is an example of cell search.

FIG. 34 is an example 3D plot of an LTE PSS aperiodic autocorrelation property for varying parameters of frequency offset (FO) and time delay (τ).

FIG. 35 is an example of an ML PSS detector.

FIG. 36 is an example of a time-frequency synchronization property of ML PSS detection.

FIG. 37 is an example diagram of a PSS correlation unit.

FIG. 38 is an example of a PSS autocorrelator.

FIG. 39 is an example of polyphase decomposition for generation of even and odd sample vectors.

FIG. 40 is an example of mapping a PSS sequence to subcarriers.

FIG. 41 is an example of an FFT-based correlator.

FIG. 42 is an example of even and odd polyphase combining.

FIG. 43 is a block diagram of an example of a peak detector.

FIG. 44 is an example of subcarrier mapping for two SSS short sequences.

FIG. 45 is a diagram of an example of a second stage of cell search.

FIG. 46 is a diagram of an example of channel estimation (CHEST) and/or noise estimation (NEST) based on knowledge of P-SCH.

FIG. 47 is a diagram of an example of an SIC processor.

FIG. 48 is a diagram of an example of maximum likelihood based peak detection.

FIG. 49 is a diagram of an example of maximum likelihood based SSS Detection.

FIG. 50 is a diagram of an example of peak detector logic.

FIG. 51 is a diagram of an example of accumulator logic.

FIG. 52 is an example of deployment to analyze scenario dependent features.

FIG. 53A and FIG. 53B show an example architecture of SSS detection.

FIG. 54A, FIG. 54B, and FIG. 54C show the example probabilities of detection of Pa with and without clustering.

### DETAILED DESCRIPTION

A detailed description of illustrative embodiments will now be described with reference to the various Figures. Although this description provides a detailed example of example implementations, it should be noted that the details are intended to be examples and in no way limit the scope of the application.

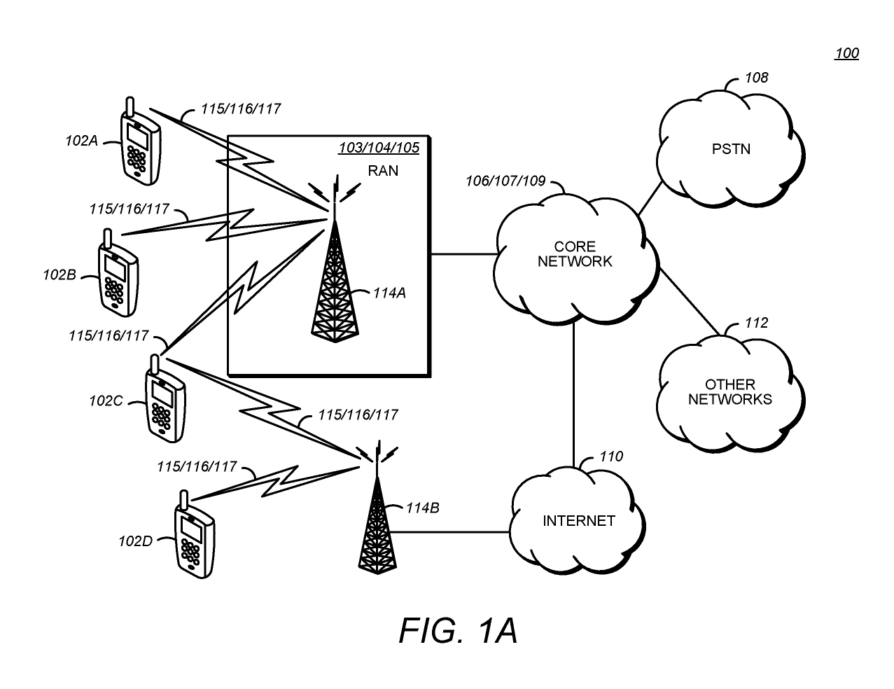

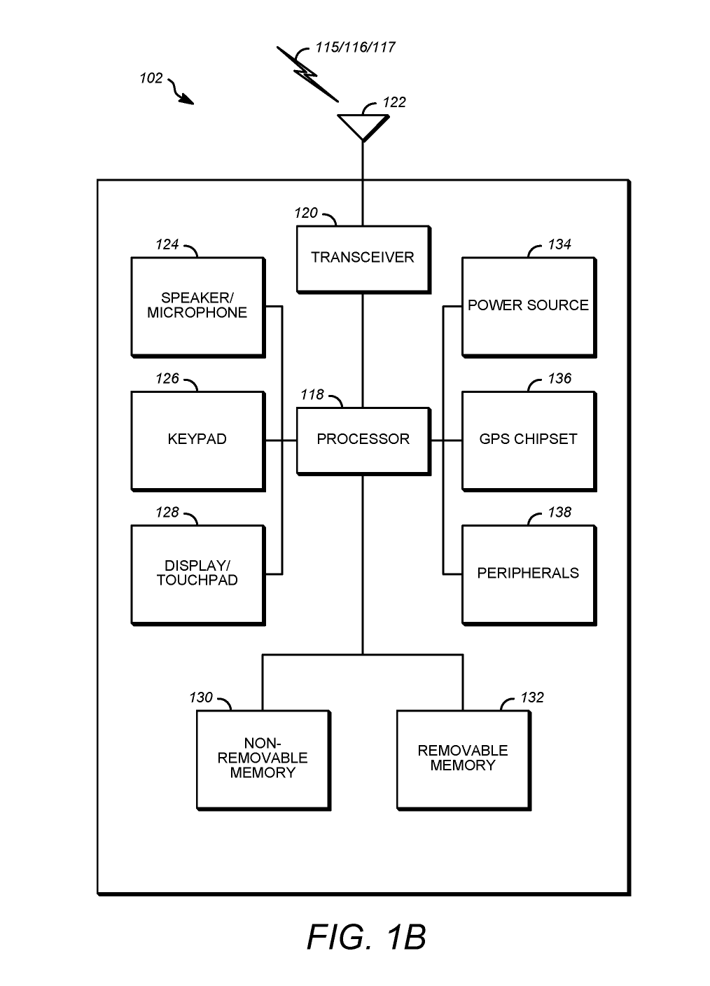

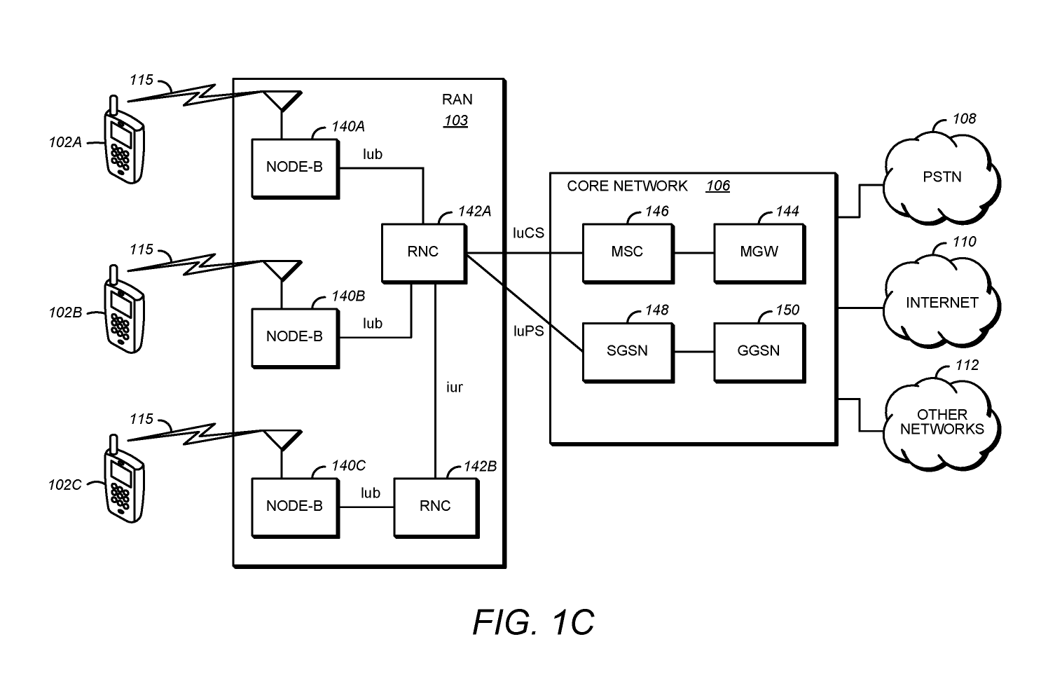

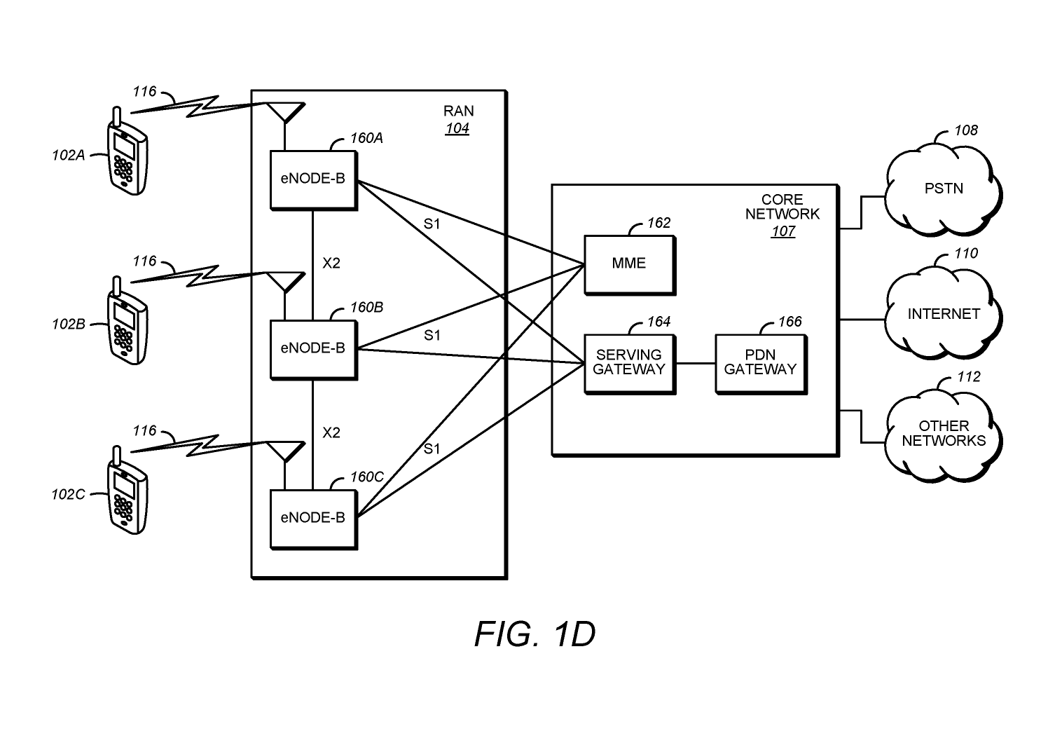

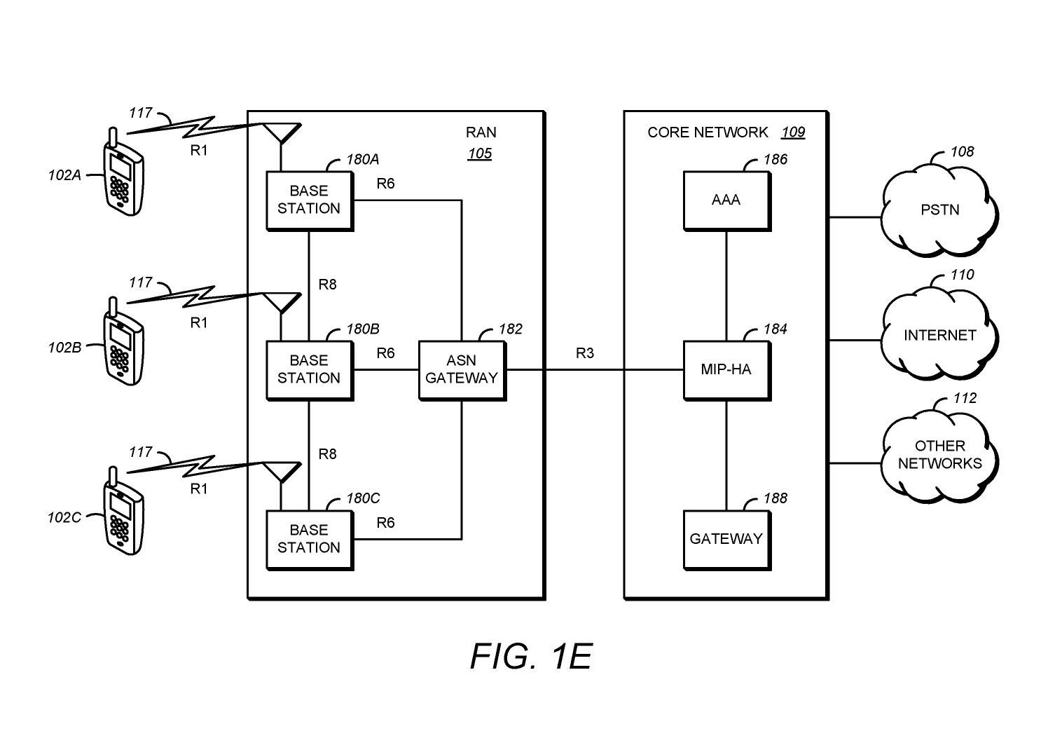

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, e.g., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, e.g., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

In view of FIGS. 1A-1E, and the corresponding description of FIGS. 1A-1E, one or more, or all, of the functions described herein with regard to one or more of: WTRU 102a-d, Base Station 114a-b, Node B 140a-c, RNC 142a-b, MSC 146, SGSN 148, MGW 144, CGSN 150, eNode-B 160a-c, MME 162, Serving Gateway 164, PDN Gateway 166, Base Station 180a-c, ASN Gateway 182, AAA 186, MIP-HA 184, and/or Gateway 188, or the like, may be performed by one or more emulation devices (not shown) (e.g., one or more devices configured to emulate one or more, or all, of the functions described herein).

The one or more emulation devices may be configured to perform the one or more, or all, functions in one or more modalities. For example, the one or more emulation devices may perform the one or more, or all, functions while being fully or partially implemented/deployed as part of a wired and/or wireless communication network. The one or more emulation devices may perform the one or more, or all, functions while being temporarily implemented/deployed as part of a wired and/or wireless communication network. The one or more emulation devices may perform the one or more, or all, functions while not being implemented/deployed as part of a wired and/or wireless communication network (e.g., such as in a testing scenario in a testing laboratory and/or a non-deployed (e.g. testing) wired and/or wireless communication network, and/or testing performed on one or more deployed components of a wired and/or wireless communication network). The one or more emulation devices may be test equipment.

Some definitions and abbreviations of 3GPP terms can be found in TR 21.905, Vocabulary for 3GPP Specifications. Other abbreviations are defined here (others will be defined later in the description):
BE Band Edge
BW Bandwidth
CHEST Channel Estimation
CIR Channel Impulse Response
CP Cyclic Prefix
CRS Cell Specific Reference Signal
CSI-RS Channel State Information Reference Signal
DC Direct Current
DS Delay Spread
EMA Exponential Moving Average
FD Frequency Domain
FFT Fast Fourier Transform
IFFT Inverse Fast Fourier Transform
MBSFN Multimedia Broadcast over a Single Frequency Network
NEST Noise Estimation
OFDM Orthogonal Frequency Division Multiplexing
PRB Physical Resource Block
RE Resource Element
RMS Root Mean Square
RS Reference Signal
Rx Receiver
SC Sub-carrier
SF Sub-frame
SNR Signal to Noise Ratio
TD Time Domain
TTI Transmission Time Interval
Tx Transmitter
ZF Zero Forcing

A WTRU may perform channel estimation and/or noise estimation. Channel estimation and/or noise estimation may include one or more of the following functions: performing channel estimation based on cell specific reference signal (CRS); performing noise estimation based on CRS; estimating a channel delay spread; estimating downlink (DL) symbol timing; and/or performing channel estimation based on channel state information reference signal (CSI-RS).

One or more inputs to channel estimation may be received. The one or more channel estimation inputs may be used in channel estimation and/or noise estimation. Table 1 identifies example inputs that may be used for performing channel and/or noise estimation. Other inputs may be used, and the names included in Table 1 are for examples and not for identification purposes.

TABLE 1
Example Inputs to CHEST

| | | | Data | |
|---|---|---|---|---|
| | | Example | Format | |
| Input Name | Example Description | Source(s) | <T, I, S> | Comment |
| Ofdmp_CRS | De-rotated CRS symbols from OFDM | OFDM | — | Input per RS |
| | processor | Processor | | symbol, per Tx- |
| | | | | Rx pair |
| L1fdbk_chest_snr | Wideband SNR estimate for CHEST for | L1fdbk | — | Input per slot/ |
| | coefficient mapping | | | sub-frame |
| Afc_doppler_est | Doppler estimate from AFC | AFC | — | Input rate |
| Ofdmp_csirs | De-rotated CSI-RS symbols from OFDM | OFDM | — | Input per RS |
| | processor | Processor | | symbol, per Tx- |
| | | | | Rx pair |
| Ofdmp_crs_valid | Indicates which CRS ports the CRS | OFDM | <2, 1, t> | Input at |
| | input is associated with. The input is 3 | Processor | | Symbol rate |
| | valued. | | | |
| | −1: output not valid, | | | |
| | 0: CRS ports 0 and 1 | | | |
| | 1: CRS ports 2 and 3 | | | |
| Ofdmp_csirs_valid | Indicates which CSI-RS ports the | OFDM | <3, 2, t> | Input at |
| | CSIRS input is associated with. The | Processor | | Symbol rate |
| | output is 4 valued. | | | |
| | −1: output not valid, | | | |
| | 0: CSI-RS ports 15/16 | | | |
| | 1: CSI-Rs ports 15/16 and 17/18 | | | |
| | 2: CSI-RS ports 15/16, 17/18, 19/20 and | | | |
| | 21/22 | | | |

The one or more channel estimation inputs may include Ofdmp_CRS. The Ofdmp_CRS input may include a de-rotated cell specific reference signal (CRS) symbol from an orthogonal frequency division multiplexing (OFDM) processor. The Ofdmp_CRS input may be received per reference signal (RS) symbol and/or per Tx-Rx pair.

The one or more channel estimation inputs may include L1fdbk_chest_snr. The L1fdbk_chest_snr input may include a wideband signal to noise ratio (SNR). The L1fdbk_chest_snr SNR estimate may be used in channel estimation for coefficient mapping. The L1fdbk_chest_snr may be received from a L1fdbk. The L1fdbk_chest_snr may be received per slot and/or per sub-frame.

The one or more channel estimation inputs may include Ofdmp_csirs. The Ofdmp_csirs input may include a de-rotated channel state information reference signal (CSI-RS) from an OFDM processor. The Ofdmp_csirs input may be received per RS symbol and/or per Tx-Rx pair.

The one or more channel estimation inputs may include Ofdmp_crs_valid. The Ofdmp_crs_valid input may indicate which CRS port the CRS input is associated with. The Ofdmp_crs_valid input may include three (3) example values. For example, a value of −1 may indicate output not valid; a value of 0 may indicate CRS ports 0 and 1; or a value of 1 may indicate CRS ports 2 and 3. The Ofdmp_crs_valid input may be received from an OFDM processor (e.g., at a symbol rate).

The one or more channel estimation inputs may include Ofdmp_csirs_valid. The Ofdmp_csirs_valid input may indicate which CSI-RS port the CSIRS input is associated with. The Ofdmp_csirs_valid input may include four (4) example values. For example, a value of −1 may indicate output not valid; a value of 0 may indicate CSI-RS ports 15 and 16; a value of 1 may indicate CSI-RS ports 15, 16, 17 and 18; or a value of 2 may indicate CSI-RS ports 15, 16, 17, 18, 19, 20, 21 and 22. The Ofdmp_csirs_valid input may be received from an OFDM processor (e.g., at a symbol rate).

Channel estimation and/or noise estimation may include one or more parameters. The parameters may be determined during the channel estimation and/or noise estimation process. Table 2 identifies example parameters that may be determined when performing channel and/or noise estimation. Other parameters may be determined.

TABLE 2
Example Parameters of CHEST

| | | Type (e.g., Design, SW |
|---|---|---|
| Parameter | Example Values | Compile Time, Run Time) |
| System bandwidth | System Bandwidth the UE is | Run Time (e.g., changes |
| | configured for. | less than once per frame, |
| | | but can change at any |
| | | sub-frame |
| | | boundary; value known |
| | | more than a frame in |
| | | advance) |
| NR = number of receive antennas | 1 or 2 | SW Compile Time |
| N_{CP} | Normal CP indicator, 1 for normal | Run Time (e.g., changes |
| | CP and 0 for extended CP, for time | less than once per frame, |
| | factor in mid-point calculation | but can change at any |
| | | sub-frame |
| | | boundary; value known |
| | | more than a frame in |
| | | advance) |
| Vshift | Values of 0 to 5. This is a cell- | Run Time (e.g., changes |
| | specific frequency shift that will | less than once per frame, |
| | determine the starting location of | but can change at any |
| | the reference signals at the first | sub-frame |
| | OFDM symbol in each sub-frame. | boundary; value known |
| | Top level control will alternate | more than a frame in |
| | between Vshift and Vshift + 3 mod 6 | advance) |
| | based on the symbol count. | |
| C-RS antenna ports | Number of CRS ports for Cell | Run Time (e.g., changes |
| | Specific Reference signal. Example | less than once per frame, |
| | values 1, 2 or 4. Can be less than or | but can change at any |
| | equal to the number of physical | sub-frame |
| | transmit antenna on the eNode B | boundary; value known |
| | | more than a frame in |
| | | advance) |
| CSI-RS antenna ports | Number of ports for CSI Reference | Run Time (e.g., changes |
| | signal. Example values 1, 2, 4 or 8. | less than once per frame, |
| | Must be equal to the number of | but can change at any |
| | physical transmit antenna at the | sub-frame |
| | eNode B except for 2 Tx. For 2 Tx | boundary; value known |
| | antenna on the eNode B, the | more than a frame in |
| | number of CSI-RS ports could be 2, | advance) |
| | 4 or 8. | |

The one or more channel estimation and/or noise estimation parameters may include system bandwidth. The system bandwidth may indicate the amount of bandwidth that a WTRU is configured for. The system bandwidth may be a run time parameter. For example, a run time parameter may change less than once per frame, may change at a sub-frame boundary, and/or may be determined more than a frame in advance.

The one or more channel estimation and/or noise estimation parameters may include a number of receive antennas (NR). Supported values of NR may include 1 and 2. The NR may be a software compile time parameter.

The one or more channel estimation and/or noise estimation parameters may include a normal cyclic prefix (N_{CP}) indicator. The N_{CP} may indicate whether the CP is normal, extended, etc. For example, a value of 1 may indicate a normal CP and a value of 0 may indicate extended CP (e.g., for time factor in mid-point calculation). The N_{CP} may be a runt time parameter.

The one or more channel estimation and/or noise estimation parameters may include Vshift. Vshift may indicate a cell-specific frequency shift. The cell-specific frequency shift may determine a starting location of the RS at the first OFDM symbol in each sub-frame. Vshift may include supported values from zero (0) to five (5). For example, top level control may alternate between Vshift and Vshift+3 mod 6 (e.g., based on a symbol count). Vshift may be a run time parameter.

The one or more channel estimation and/or noise estimation parameters may include CRS antenna ports. The CRS antenna ports parameter may indicate a number of CRS ports for CRS. A value of CRS antenna ports may include one (1), two (2) or four (4). The value of CRS antenna ports may be less than or equal to a number of physical transmit antenna on an eNodeB. CRS antenna ports may be a run time parameter.

The one or more channel estimation and/or noise estimation parameters may include CSI-RS antenna ports. The CSI-RS antenna ports parameter may indicate a number of ports for CSI-RS. A value of CSI-RS antenna ports may include one (1), two (2), four (4) or eight (8). The value of CSI-RS antenna ports may be equal (e.g., must be equal) to a number of physical transmit antenna at an eNodeB. When there are two (2) Tx antenna on the eNodeB, the value of CSI-RS antenna ports may be two (2), four (4) or eight (8). CSI-RS antenna ports may be a run time parameter.

Channel estimation and/or noise estimation may include one or more outputs. The outputs may be determined during the channel estimation and/or noise estimation process. Table 3 identifies example outputs that may be determined when performing channel and/or noise estimation. Other outputs may be determined. The output names are listed for purposes of identification.

TABLE 3
Example Outputs of CHEST

| Output Name | Example Description | Example Rate |
|---|---|---|
| crs_chest_out | Channel Estimates for CRS and | Output at RS |
| | mid-point Sub carriers. 4 Per PRB | symbol rate |
| | for entire BW | |
| cir_afc | Unfiltered and masked CIR output | To AFC |
| | | Output at RS |
| | | symbol rate |
| nest_out | Noise Estimate per Rx antenna | Output at RS |
| | | symbol rate for |
| | | port 0/1, |
| csirs_chest_out | Channel Estimates for CSI-RS and | Output on symbol |
| | mid-point sub carriers. 2 per PRB | 2 in CSI-RS |
| | for entire system BW | enabled sub- |
| | | frames |

The one or more channel estimation and/or noise estimation outputs may include crs_chest_out. The crs_chest_out output may include a channel estimate for a CRS and/or a mid-point sub-carrier. A physical resource block (PRB) may include a plurality (e.g., 4) crs_chest_out outputs (e.g., for the entire bandwidth). The crs_chest_out may be output at a RS symbol rate.

The one or more channel estimation and/or noise estimation outputs may include nest_out. The nest_out output may include a noise estimate for each Rx antenna. The nest_out may be output at a RS symbol rate (e.g., for port 0/1 only).

The one or more channel estimation and/or noise estimation outputs may include csirs_chest_out. The csirs_chest_out output may include a channel estimate for a CSI-RS and/or a mid-point sub-carrier. A PRB may include a plurality of (e.g., 2) csirs_chest_out outputs (e.g., for the entire system bandwidth). The csirs_chest_out may be output on symbol 2 in a CSI-RS enabled sub-frame.

The CHEST/NEST functions may be configured to support different system bandwidths (e.g., 1-4 MHz-20 MHz), to support the normal and extended cyclic prefix, support 1, 2, and/or 4 CRS ports, support 1, 2, 4, or 8 CSI-RS ports, support operation during the presence of MBSFN sub-frames, and/or support Vshift from 0 to 5. CHEST/NEST functions may provide one or more estimates of RMS delay spread for up to 5 uS and/or provide one or more timing estimates for example in the range of −4 to 4 uS.

CRS based Channel Estimation (CHEST) may include CRS CHEST Core Logic, CIR Post Processing, Zero Forcing (ZF) Mask generation, Delay Spread Estimation, and or Downlink timing estimation.

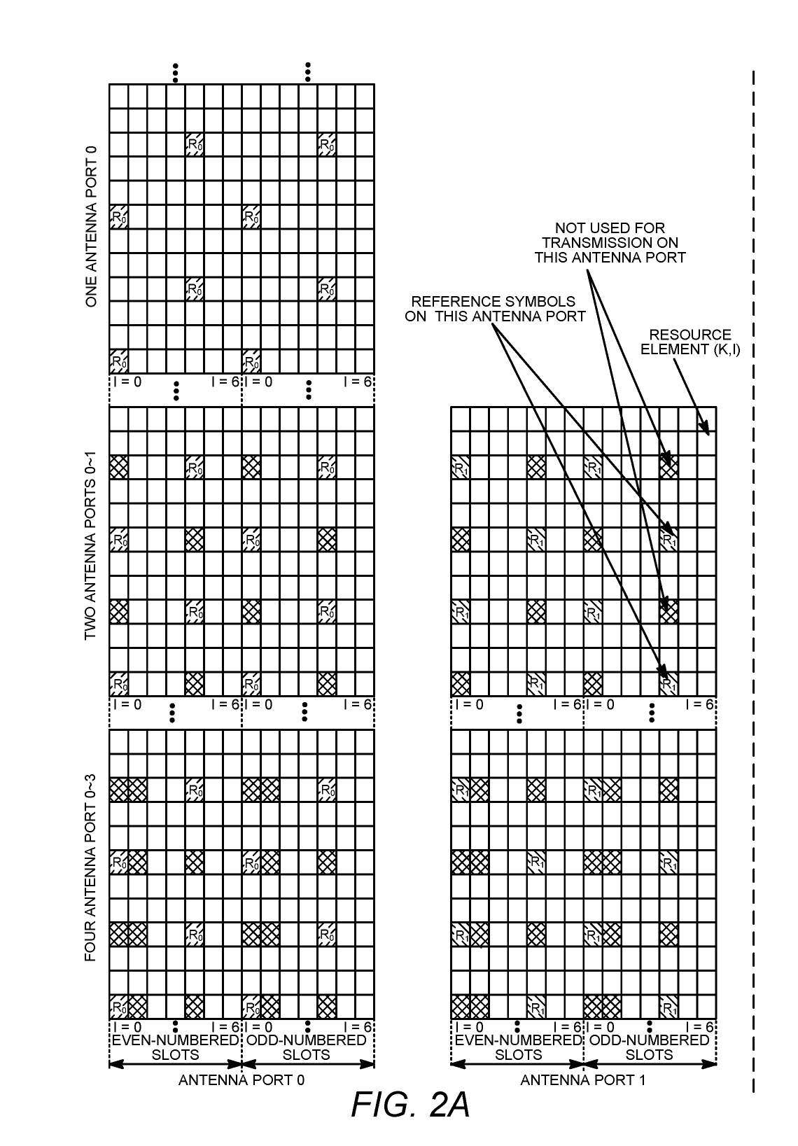

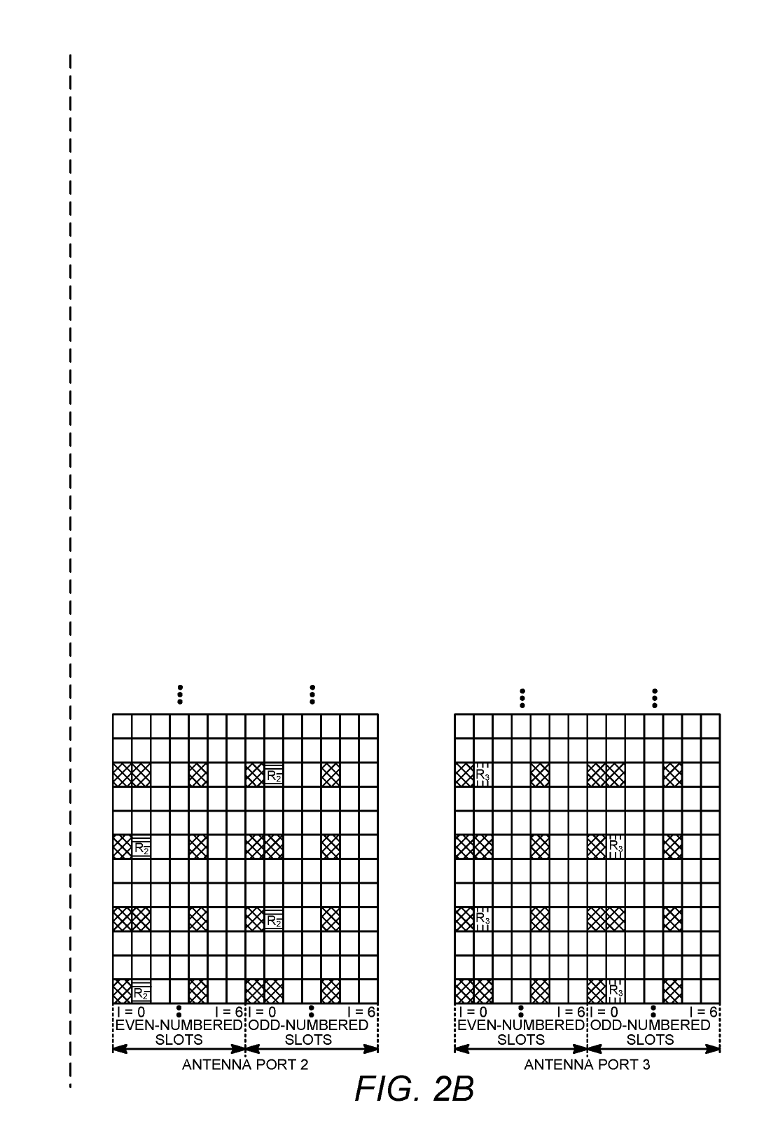

FIG. 2A and FIG. 2B depict an example CRS structure in a sub-frame for Vshift 0 for normal CP for ports 0-3. The example CRS structure may include 1, 2 and 4 antenna configurations. The horizontal axis of the example CRS structure may represent the time domain. The vertical axis of the example CRS structure may represent the frequency domain. The example CRS structure may include seven even numbered OFDM symbols and seven odd numbered OFDM symbols in a sub-frame and/or transmission time interval (TTI). The example CRS structure may indicate a plurality of reference symbols. For example, port 0 and port 1 may include 2 reference symbols per slot. Port 2 and port 3 may include 1 symbol per slot. The CRS may be spaced by 6 sub-carriers in frequency.

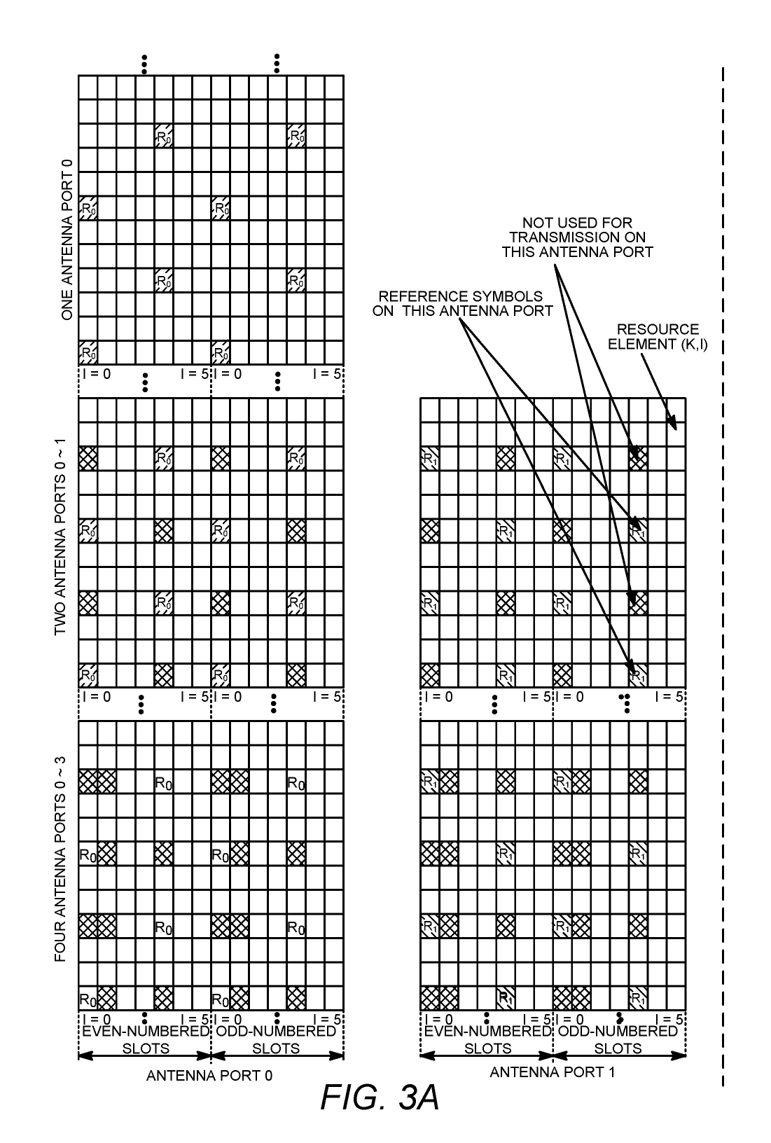

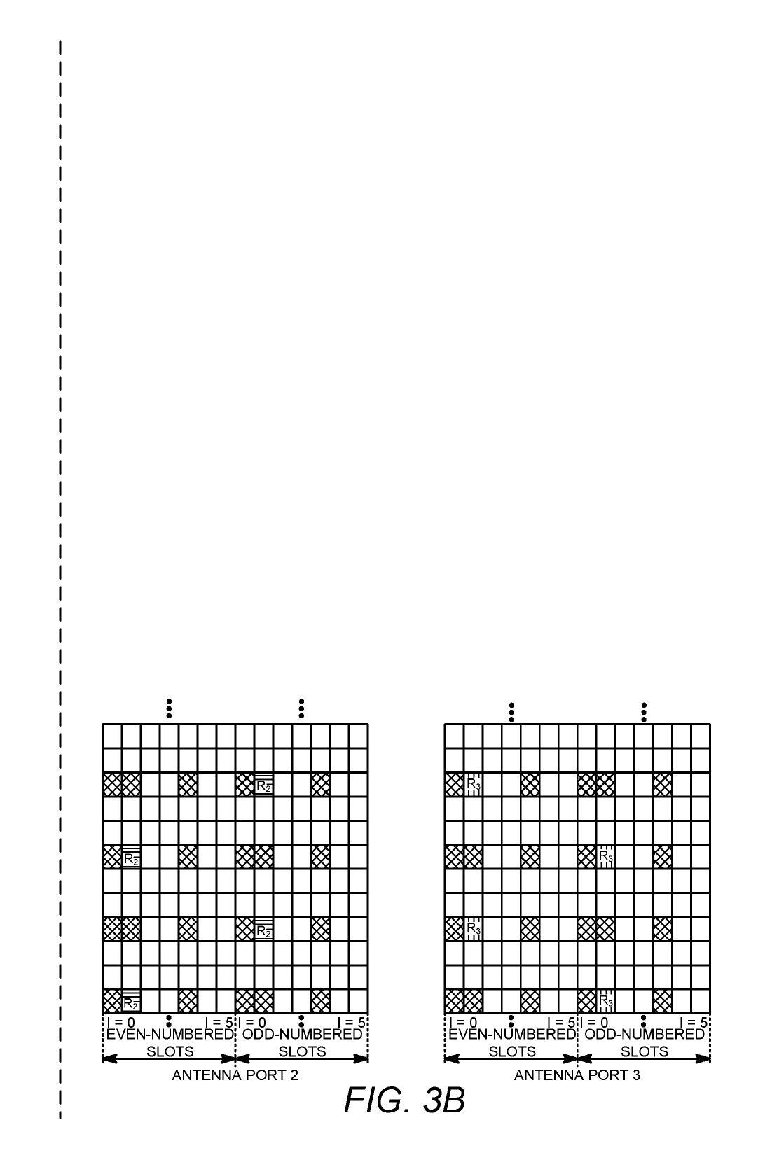

FIG. 3A and FIG. 3B depict an example CRS structure in a sub-frame for extended CP for ports 0-3.

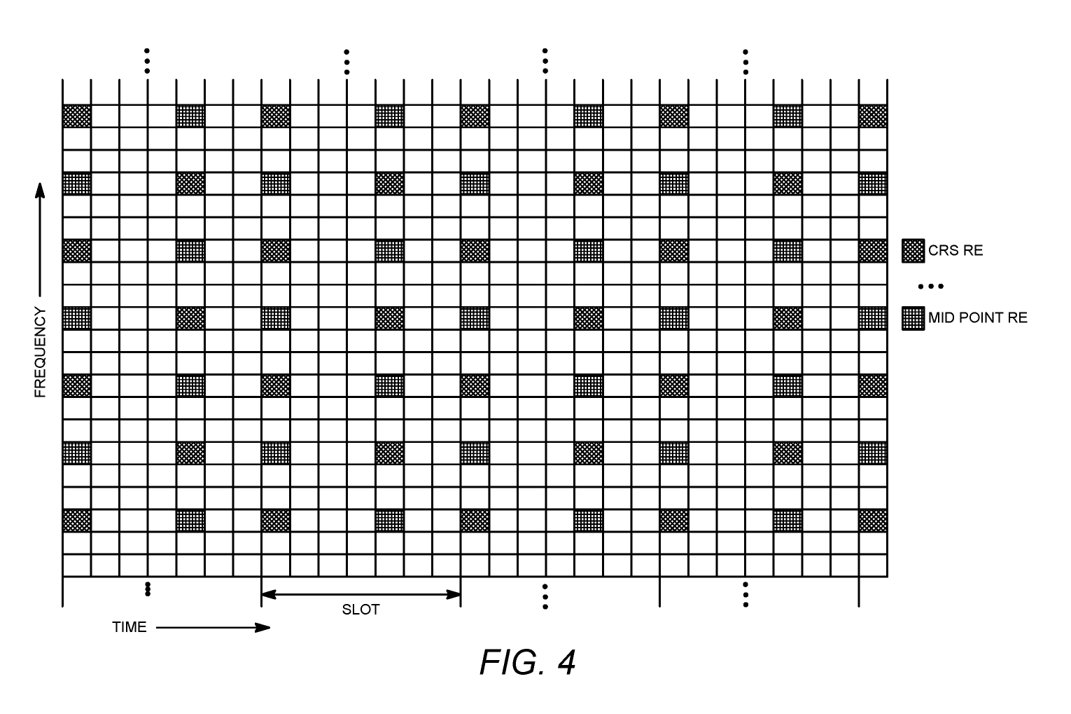

FIG. 4 depicts an example CRS and mid-point resource element (RE) structure for normal CP for ports 0 and 1. A mid-point RE may be between 2 CRS REs in time and frequency. The mid-point RE may be spaced evenly between 2 CRS REs within a slot. The mid-point RE may not be spaced evenly between 2 CRS REs across a plurality of slots.

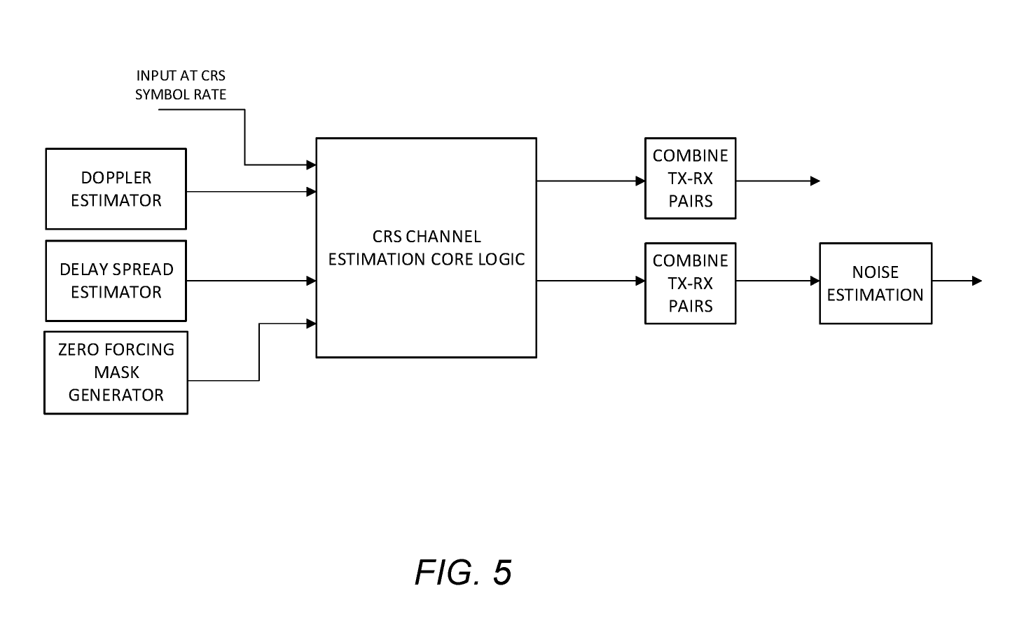

FIG. 5 is a block diagram depicting an example CHEST/NEST system. The example system may include CRS CHEST Core Logic. The CRS CHEST Core Logic may receive a de-rotated CRS symbol as an input. The CRS CHEST Core Logic may receive input from a doppler estimator, a delay spread estimator, and/or a ZF mask generator. The CRS CHEST Core Logic may receive one or more de-rotated CRS symbols. The CRS CHEST Core Logic may determine (e.g., by interpolation) one or more mid-point REs of the one or more de-rotated CRS symbols. The CRS CHEST Core Logic may perform filtering in time and frequency. The CRS CHEST Core Logic may improve a quality of one or more initial estimates at the CRS and/or mid-point REs.

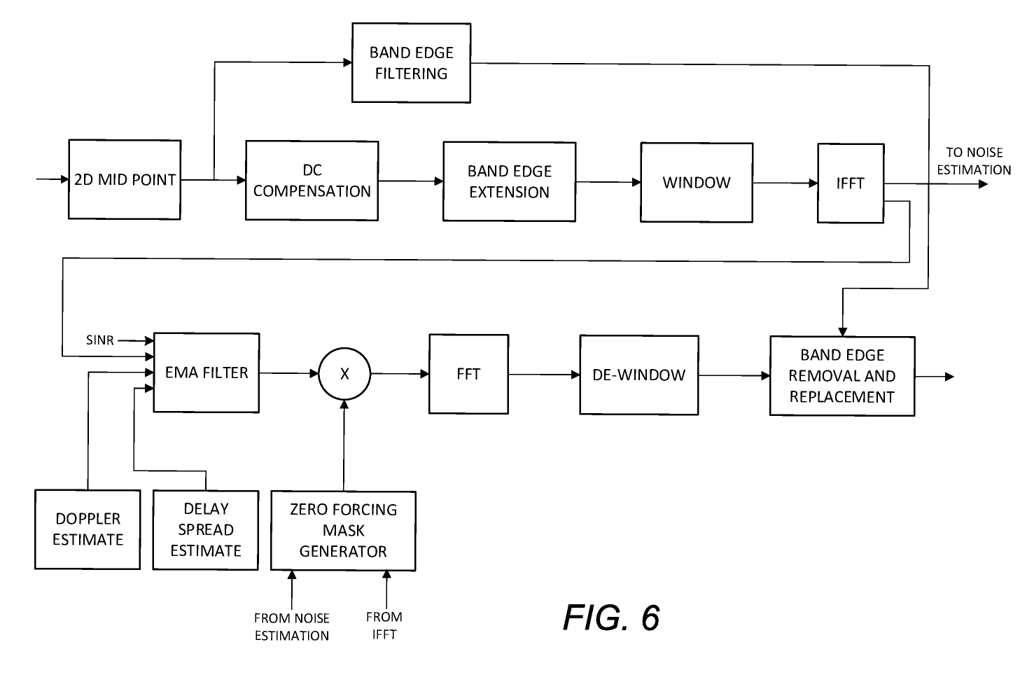

FIG. 6 is a block diagram depicting an example CRS CHEST Core Logic. The CRS CHEST Core Logic may receive de-rotated CRS symbols from an OFDM processor. The CRS CHEST Core Logic may be applied for each Tx-Rx link. The CRS CHEST Core Logic may be performed (e.g., executed) at a RS symbol rate. A 2D mid-point may be determined (e.g., calculated) based on the de-rotated CRS symbols. The CRS CHEST Core Logic may perform DC compensation, band edge filtering, and/or exponential moving average—fast fourier transform EMA-FFT filtering. EMA-FFT filtering may include band edge extension, windowing, inverse fast fourier transform (IFFT), applying an EMA filter, ZF, FFT, de-windowing, and/or band edge removal and replacement.

The CRS CHEST Core Logic may receive one or more inputs. The one or more inputs may include Ofdmp_CRS, L1fdbk_chest, Ofdmp_crs_valid, doppler estimate, delay spread, and/or ZF mask. The Ofdmp_CRS may be used in the 2D mid-point calculation. The L1fdbk_chest may be used in EMA filtering. A CRS port index may be determined based on the Ofdmp_crs_valid. The doppler estimate may be used in the band edge filtering, and/or EMA-FFT filtering. The doppler estimate may be received from a doppler estimator. The delay spread may indicate a root mean square (RMS) delay spread of a channel. The delay spread may be used in RMS delay spread of a channel. The delay spread may be received from a delay spread estimator. EMA-FFT filtering may be based on the ZF mask. A number of filtered taps may be used in Band Edge Filtering and EMA-FFT filtering. The number of filtered taps may source from the ZF mask generation. The ZF mask may be received from a ZF mask generator. The ZF mask may be received for each Tx-Rx link. The ZF mask may be updated once per radio frame (e.g., 10 ms).

The CRS CHEST Core Logic may include one or more parameters. The one or more parameters may include system bandwidth, NR, N_{CP}, Vshift, and/or CRS antenna ports. Table 4 illustrates examples of Parameters of CHEST Core Logic

TABLE 4
Example Parameters of CHEST Core Logic

| | | Type (Design, SW |
|---|---|---|
| Parameter | Supported Values | Compile Time, Run Time) |
| System bandwidth | System Bandwidth the UE is configured | Run Time (changes less |
| | for. | than once per frame, but |
| | | can change at any |
| | | subframe boundary; value |
| | | known more than a frame |
| | | in advance) |
| NR = number of receive antennas | 1 or 2 | SW Compile Time |
| N_{CP} | Normal CP indicator, 1 for normal CP | Run Time (changes less |
| | and 0 for extended CP, for time factor in | than once per frame, but |
| | mid-point calculation | can change at any |
| | | subframe boundary; value |
| | | known more than a frame |
| | | in advance) |
| Vshift | Values of 0 to 5. This is a cell-specific | Run Time (changes less |
| | frequency shift that will determine the | than once per frame, but |
| | starting location of the reference signals | can change at any |
| | at the first OFDM symbol in each sub- | subframe boundary; value |
| | frame. Top level control will alternate | known more than a frame |
| | between Vshift and Vshift + 3 mod 6 | in advance) |
| | based on the symbol count. | |
| C-RS antenna ports | Number of CRS ports for Cell Specific | Run Time (changes less |
| | Reference signal. Possible values 1, 2 | than once per frame, but |
| | or 4. Can be less than or equal to the | can change at any |
| | number of physical transmit antenna on | subframe boundary; value |
| | the eNode B | known more than a frame |
| | | in advance) |

The CRS CHEST Core Logic may determine a crs_chest_out output. The crs_chest_out may include one or more channel estimates for CRS. The crs_chest_out may include one or more channel estimates for mid-point sub-carriers. The crs_chest_out may indicate four (4) channel estimates per PRB (e.g., for the entire bandwidth).

The CRS CHEST Core Logic may determine an ifft_out output. The ifft_out may be output from the EMA-FFT filtering. The ifft_out may be sent to noise estimation.

A mid-point RE may be determined. The mid-point RE may be determined by interpolating in time and frequency separately and combined using a weighted average. For example, a time-domain (TD) mid-point may be determined using a linear average of the 2 adjacent CRS symbols. A frequency-domain (FD) mid-point may be determined using a multiple tap (e.g., 4 tap) sinc interpolation filter.

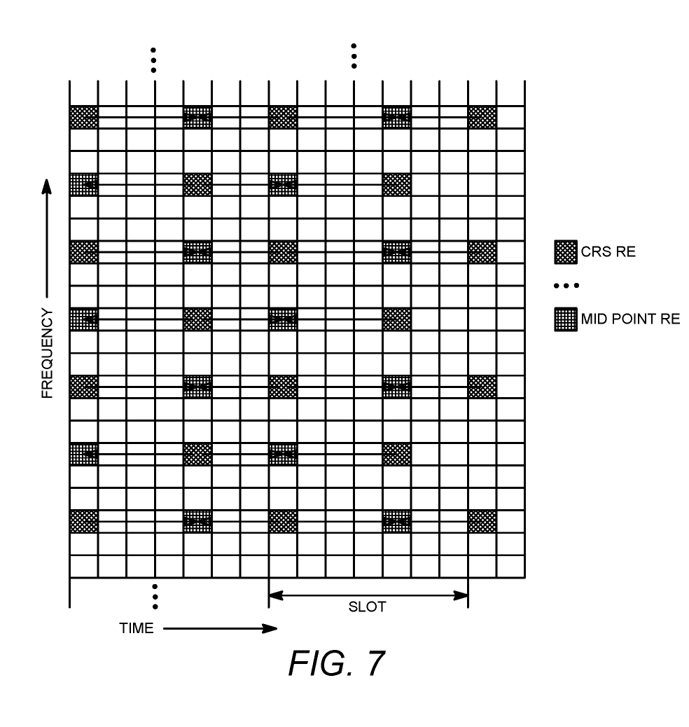

FIG. 7 is a chart depicting an example TD mid-point for port 0/1 with normal CP. The TD mid-point may be determined based on the leading and lagging CRS symbol. The TD mid-point calculation may introduce a 4 symbol delay in the processing for normal CP (e.g., for port 0/1). The TD mid-point calculation may introduce a 3 symbol delay for extended CP (e.g., for port 0/1). For port 2/3 the delay may be 6 symbols for extended CP and 7 symbols for normal CP. The TD mid-point calculation may maintain a 2 symbol first-in first-out (FIFO) buffer. The TD mid-point may be determined for the CRS symbols (N_{CRS}) in the entire BW. Example input sizes may be determined as illustrated in Table 5.

TABLE 5
Example Input Sizes for Mid-Point

| Bandwidth (MHz) | N_{CRS} |
|---|---|
| 1.4 | 12 |
| 3.0 | 30 |
| 5.0 | 50 |
| 10.0 | 100 |
| 15.0 | 150 |
| 20.0 | 200 |

The TD mid-point may be determined as follows:

crs_td_mdpt(n−1)=f₁*crs(n)+(1−f₁)*crs(n−2)

Where crs(n) and crs(n−2) may represent the CRS from the current symbol and 2 symbols prior, respectively. crs_td_mdpt(n−1) may represent the TD mid-point for the previous RS symbol. f₁ may represent the interpolation weight based on the relative distance from the RS to mid-point REs. The interpolation weight may be set to ½ (e.g., for control and hardware simplicity). The symbol in slot may correspond to the symbol for which the TD mid-point is determined. The TD mid-point per symbol may be represented by a vector of N_{RS} REs.

Special handling of the TD mid-point may be required at startup, after reset and/or during MBSFN sub-frames. For example, when either of the adjacent RS symbols is missing, the TD mid-point may be determined to be the symbol that exists.

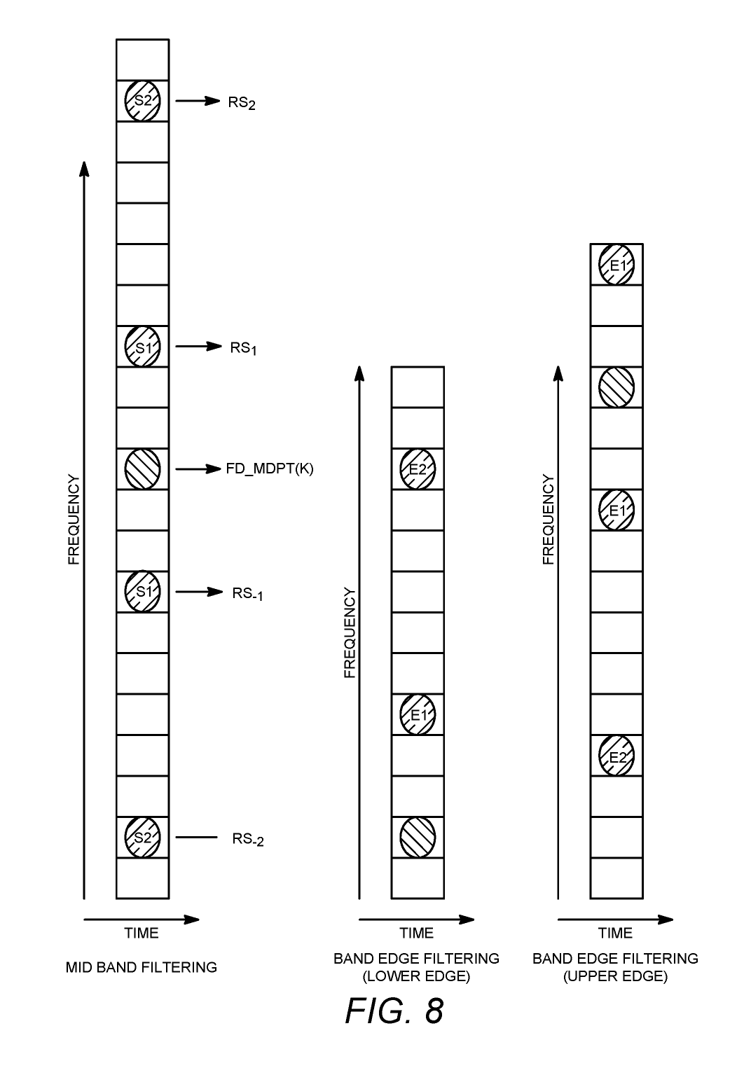

FIG. 8 is a plot depicting an example FD mid-point of a mid-band and band edges. The FD mid-point may be determined using a 4 tap sinc interpolation Finite Impulse Response (FIR) filter, for example. The FD mid-point may be determined based on the previous RS symbol (e.g., to align with the TD mid-point output). A mid-band FD mid-point may be determined using 4 RSs (e.g., 2 on either side of the mid-point). A band edge FD mid-point may be determined using 2 RSs. Special handling may be required at band edges (e.g., because 2 RS might not be available on either side for filtering). One or more filter tap coefficients may be determined (e.g., pre-computed) and stored. The one or more filter tap coefficients may be symmetric (e.g., so only 2 coefficients need to be stored for the mid-band). One or more, or a plurality (e.g., 2 sets) of coefficients for the band edges may be determined and stored.

A FD mid-point for each sub-carrier k may be determined for mid-band as follows,

$$crs\_fd \_mdpt ( k ) = {\sum }_{i = 1}^{2} {S}_{i} * ( {RS}_{i} + {RS}_{- i} )$$

For the band-edges, a missing RS may be represented as zero in the 4 tap filter. The filter tap coefficients may be determined and may account for the missing RSs.

Example filter tap coefficients may be represented in Table 6.

TABLE 6
Example FD Mid-point Interpolation Coefficients

| Filter | Coefficients | Coefficient usage in FIR Filter |
|---|---|---|
| Mid-band | [−0.0939923 0.5939923] | [S2, S1, S1, S2] |
| S2, S1 | | |
| Band Edge1 | [1.1879846 −0.1879846] | Lower Band Edge |
| E11, E12 | | [0, 0, E11, E12] |
| | | Upper Band Edge |
| | | [E12, E11, 0, 0] |
| Band Edge2 | [0.54295839 −0.08591678] | Lower Band Edge |
| E21, E22 | | [, 0, E21, E21, E22] |
| | | Upper Band Edge |
| | | [E22, E21, E21, 0] |

A band edge (e.g., only one of the band edges) may use FIR Filter BandEdge1 (e.g., based on the V-shift and/or the symbol being processed). The FD mid-point per symbol may be represented by a vector of N_{RS} REs.

The example filter tap coefficients may be generated using the following Matlab code,

l=2; r=2; alpha = 0.5;
h = intfilt(r,l,alpha);
inpFilt = h;
inpFilt(1:2:end) = h(1:2:end)./sum(h(1:2:end)); % Normalizing filter
mbFilt = inpFilt(1:2:end); % Mid-band Filter
for n = 1:l

beL{n} = inpFilt(l*r+3−n*2:r:end)./sum(inpFilt(l*r+3−n*2:r:end));
lBeFilt{n} = beL{n}(n:end); % Lower BE Filter
beU{n} = inpFilt(1:r:l*r+2*n−3)./sum(inpFilt(1:r:l*r+2*n−3));
uBeFilt{n} = beU{n}(1:l); % Upper BE Filter

end

The 2D mid-point may be determined based on the TD and FD mid-point vectors. For example, the 2D mid-point may be determined using the weighted average of the TD and FD mid-point vectors,

$${CRS}_{MDPT} = \frac{{T}_{f} * {CRS}_{TD - MDPT} + {F}_{f} * {CRS}_{FD - MDPT}}{{T}_{f} + {F}_{f}}$$

Where T_{f} and F_{f} are the time weighting factor and frequency weighting factor respectively. Examples are illustrated in Table 7.

TABLE 7
Example Weighting Factor

| | Value |
|---|---|
| T_{f} | 1.35 |
| F_{f} | 1 |

A weighting factor may be used for mid-point REs (e.g., all mid-point REs).

A first or a last FD mid-point may be determined using 2 RSs (e.g., the one that was computed using FIR filter BandEdge1). Perhaps for example when a mid-point is determined based on 4 RSs (e.g., half of the RSs), the frequency factor may be scaled to F_{f}/2 (e.g., to give less weight to the FD mid-point for that RE).

During startup, after reset or in MBSFN sub-frames when one of the adjacent symbols are missing for TD mid-point calculation, the time weighting factor may be scaled to T_{f}/2 (e.g., for one or more, or all, REs).

One or more of the following factors may be used for calculating the 2D mid-point:

CRS_{MDPT}=T_{scale}*CRS_{TD-MDPT}+F_{scale}*CRS_{FD-MDPT}

Examples of the scale factors for different scenarios are summarized in Table 8.

TABLE 8
Example Time/Frequency Scale factors

| | T_{f} | F_{f} | T_{scale} | F_{scale} |
|---|---|---|---|---|
| Normal SF, Mid-band | 1.35 | 1 | 0.574468 | 0.425532 |
| Normal SF, Band-Edge | 1.4 | 0.5 | 0.72973 | 0.27027 |
| Normal SF (sym 0) with Previous SF | 0.675 | 1 | 0.402985 | 0.597015 |
| MBSFN, Mid-band | | | | |
| Normal SF (sym 0) with Previous SF | 0.675 | 0.5 | 0.574468 | 0.425532 |
| MBSFN, Band-Edge | | | | |
| MBSFN SF (sym 0) with Previous SF | 0 | 1 | 0 | 1 |
| MBSFN, Mid-band Band-Edge | | | | |

DC compensation may be enabled or disabled. DC compensation may be performed in CRS channel estimation. A DC sub-carrier may be ignored in FD Mid-point interpolation. The RS and Mid-point SCs around the DC sub-carrier may include un-equal sub-carrier spacing (e.g., due to the FD mid-point interpolation). DC compensation may correct the un-equal sub-carrier spacing. For example, the DC may be restored by interpolating with non-uniform sample rate around the DC sub-carrier. The interpolation by non-uniform sample rate around DC may be achieved using 2 8-tap poly-phase FIR filters. The filtered output may be normalized (e.g., to compensate for non-uniform sample spacing around DC). Prior to the EMA-FFT filtering, the interpolated SCs may be down sampled to RS and Mid-point SC spacing. The RS and Mid-point SCs may be restored after DC compensation such that there is uniform sub-carrier spacing through the entire BW. The RS and mid-point SCs may provide better quality of channel estimates around DC sub-carrier after EMA-FFT filtering.

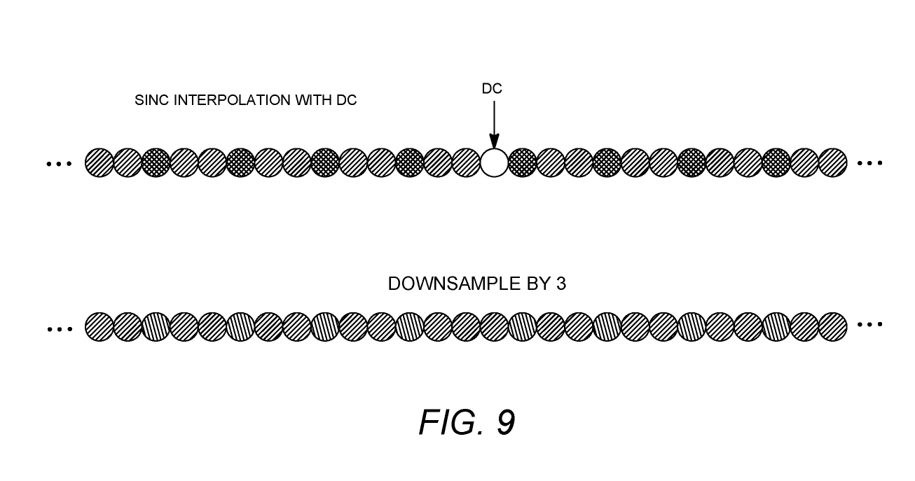

FIG. 9 is a chart depicting an example non-uniform SC interpolation for DC compensation.

EMA-FFT may be performed in CRS channel estimation. EMA-FFT filtering may include FD FFT filtering and/or TD EMA filtering on the input CRS and Mid-point sub-carriers. EMA-FFT filtering may include Band-Edge Extension and Windowing, IFFT, FFT Filtering, FFT and Band Edge Extension Discard, Band Edge SC Replacement, De-window, and/or EMA Filtering.

Band Edge Extension and Windowing may be performed prior to taking the IFFT of the per RS symbol on the CRS and Mid-point SCs. Band Edge Extension and Windowing may include extending the CRS and Mid-point vector (e.g., symmetrically to the IFFT length). A first and a last SC of the CRS and Mid-point vector may be repeated in either direction (e.g., to extend the input to the IFFT size). The number of repetitions may be based on the system BW as illustrated in the example of Table 9.

TABLE 9
Example Band Edge Extension Size

| System BW | CRS + MdPt | IFFT Size | |
|---|---|---|---|
| (MHz) | 2 * NRS | (nfft) | Nₑₓₜ |
| 1.4 | 24 | 32 | 4 |
| 3 | 60 | 64 | 2 |
| 5 | 100 | 128 | 14 |
| 10 | 200 | 256 | 28 |
| 15 | 300 | 512 | 106 |
| 20 | 400 | 512 | 56 |

For example, Nₑₓₜ may represent the number of repetitions for the first and the last SC of the input CRS and Mid-point vector.

A window may be applied (e.g., after symmetric band edge extension). The window may reduce the ripples in the Channel Impulse Response (CIR) after IFFT. The window may reduce ripples in the transform domain by smoothing out the boundary transitions. The window may include a Kaiser window (e.g., with β=6). The window length may equal the IFFT length. The window may be symmetric (e.g., only half the coefficients need to be stored). These coefficients may include a 1/sqrt(2) scaling perhaps for example to compensate for scale factor from de-rotation of CRS in OFDM processor.

Example Matlab Code for generating window coefficients:

window=kaiser(nfft,6)/sqrt(2);

Table 10 illustrates example window coefficients.

TABLE 10
Example Window Coefficients

| | IFFT | |
|---|---|---|
| System | Size | |
| BW (MHz) | (nfft) | 1^{st} half window coefficients |
| 1.4 | 32 | [0.0105 0.0261 0.0492 0.0808 0.1212 0.1704 0.2275 0.2910 |
| | | 0.3587 0.4280 0.4958 0.5589 0.6140 0.6582 0.6892 0.7051] |
| 3 | 64 | [0.0105 0.0173 0.0258 0.0361 0.0484 0.0627 0.0791 0.0977 |
| | | 0.1184 0.1413 0.1662 0.1931 0.2217 0.2520 0.2837 0.3164 |
| | | 0.3499 0.3840 0.4181 0.4520 0.4853 0.5175 0.5484 0.5774 |
| | | 0.6043 0.6286 0.6501 0.6685 0.6835 0.6950 0.7027 0.7066] |
| 5 | 128 | [0.0105 0.0137 0.0173 0.0212 0.0257 0.0305 0.0358 0.0416 |
| | | 0.0479 0.0547 0.0621 0.0699 0.0783 0.0872 0.0966 0.1065 |
| | | 0.1170 0.1280 0.1396 0.1516 0.1642 0.1772 0.1907 0.2046 |
| | | 0.2190 0.2337 0.2488 0.2643 0.2801 0.2962 0.3125 0.3290 |
| | | 0.3457 0.3625 0.3794 0.3963 0.4133 0.4302 0.4470 0.4636 |
| | | 0.4801 0.4963 0.5123 0.5279 0.5431 0.5579 0.5723 0.5861 |
| | | 0.5994 0.6120 0.6240 0.6354 0.6460 0.6558 0.6649 0.6731 |
| | | 0.6805 0.6871 0.6927 0.6974 0.7012 0.7041 0.7060 0.7070] |
| 10 | 256 | [0.0105 0.0120 0.0137 0.0154 0.0172 0.0192 0.0212 0.0233 |
| | | 0.0256 0.0279 0.0304 0.0330 0.0357 0.0385 0.0415 0.0445 |
| | | 0.0477 0.0511 0.0545 0.0581 0.0618 0.0656 0.0695 0.0736 |
| | | 0.0779 0.0822 0.0867 0.0913 0.0960 0.1009 0.1059 0.1111 |
| | | 0.1164 0.1218 0.1273 0.1330 0.1387 0.1447 0.1507 0.1569 |
| | | 0.1632 0.1696 0.1761 0.1827 0.1895 0.1964 0.2033 0.2104 |
| | | 0.2176 0.2249 0.2322 0.2397 0.2473 0.2549 0.2627 0.2705 |
| | | 0.2784 0.2863 0.2943 0.3024 0.3106 0.3187 0.3270 0.3353 |
| | | 0.3436 0.3519 0.3603 0.3687 0.3771 0.3856 0.3940 0.4025 |
| | | 0.4109 0.4193 0.4277 0.4361 0.4445 0.4528 0.4611 0.4693 |
| | | 0.4775 0.4857 0.4937 0.5017 0.5097 0.5175 0.5253 0.5330 |
| | | 0.5405 0.5480 0.5554 0.5626 0.5697 0.5767 0.5836 0.5903 |
| | | 0.5969 0.6033 0.6096 0.6158 0.6217 0.6275 0.6331 0.6386 |
| | | 0.6439 0.6489 0.6538 0.6585 0.6630 0.6673 0.6714 0.6753 |
| | | 0.6790 0.6824 0.6857 0.6887 0.6915 0.6941 0.6964 0.6985 |
| | | 0.7004 0.7021 0.7035 0.7047 0.7056 0.7064 0.7068 0.7071] |
| 15, 20 | 512 | [0.0105 0.0113 0.0120 0.0128 0.0137 0.0145 0.0154 0.0163 |
| | | 0.0172 0.0182 0.0191 0.0201 0.0212 0.0222 0.0233 0.0244 |
| | | 0.0255 0.0267 0.0279 0.0291 0.0304 0.0316 0.0329 0.0343 |
| | | 0.0356 0.0370 0.0385 0.0399 0.0414 0.0429 0.0445 0.0460 |
| | | 0.0476 0.0493 0.0509 0.0526 0.0544 0.0561 0.0579 0.0598 |
| | | 0.0616 0.0635 0.0654 0.0674 0.0694 0.0714 0.0734 0.0755 |
| | | 0.0777 0.0798 0.0820 0.0842 0.0865 0.0887 0.0911 0.0934 |
| | | 0.0958 0.0982 0.1006 0.1031 0.1056 0.1082 0.1108 0.1134 |
| | | 0.1160 0.1187 0.1214 0.1241 0.1269 0.1297 0.1326 0.1354 |
| | | 0.1383 0.1413 0.1442 0.1472 0.1503 0.1533 0.1564 0.1595 |
| | | 0.1627 0.1658 0.1690 0.1723 0.1756 0.1788 0.1822 0.1855 |
| | | 0.1889 0.1923 0.1957 0.1992 0.2027 0.2062 0.2098 0.2133 |
| | | 0.2169 0.2205 0.2242 0.2278 0.2315 0.2352 0.2390 0.2427 |
| | | 0.2465 0.2503 0.2541 0.2580 0.2618 0.2657 0.2696 0.2735 |
| | | 0.2775 0.2814 0.2854 0.2894 0.2934 0.2974 0.3015 0.3055 |
| | | 0.3096 0.3137 0.3178 0.3219 0.3260 0.3301 0.3342 0.3384 |
| | | 0.3425 0.3467 0.3509 0.3551 0.3592 0.3634 0.3676 0.3718 |
| | | 0.3760 0.3802 0.3844 0.3887 0.3929 0.3971 0.4013 0.4055 |
| | | 0.4097 0.4139 0.4181 0.4223 0.4265 0.4307 0.4349 0.4391 |
| | | 0.4432 0.4474 0.4516 0.4557 0.4598 0.4640 0.4681 0.4722 |
| | | 0.4763 0.4803 0.4844 0.4884 0.4925 0.4965 0.5005 0.5044 |
| | | 0.5084 0.5123 0.5162 0.5201 0.5240 0.5278 0.5317 0.5355 |
| | | 0.5392 0.5430 0.5467 0.5504 0.5541 0.5577 0.5613 0.5649 |
| | | 0.5685 0.5720 0.5755 0.5789 0.5823 0.5857 0.5891 0.5924 |
| | | 0.5957 0.5989 0.6021 0.6053 0.6084 0.6115 0.6146 0.6176 |
| | | 0.6206 0.6235 0.6264 0.6292 0.6320 0.6348 0.6375 0.6402 |
| | | 0.6428 0.6454 0.6479 0.6504 0.6528 0.6552 0.6576 0.6599 |
| | | 0.6621 0.6643 0.6664 0.6685 0.6706 0.6725 0.6745 0.6764 |
| | | 0.6782 0.6800 0.6817 0.6834 0.6850 0.6865 0.6880 0.6895 |
| | | 0.6909 0.6922 0.6935 0.6947 0.6959 0.6970 0.6981 0.6991 |
| | | 0.7000 0.7009 0.7017 0.7025 0.7032 0.7038 0.7044 0.7050 |
| | | 0.7054 0.7059 0.7062 0.7065 0.7067 0.7069 0.7070 0.7071] |

An inverse of the window coefficients may be stored (e.g., for de-windowing).

An IFFT of the CRS+Mid-point after band extension and windowing may be determined. A Channel Impulse Response (CIR) may be determined based on the IFFT. The CIR may be used for EMA-FFT filtering and/or CRS Noise Estimation. When used for CRS Noise Estimation, the IFFT of CRS+Mid-Point may be scaled before output to the CRS Noise Estimation (e.g., because has the window is applied). Examples of the IFFT scaling factor for NEST may be represented in Table 11.

TABLE 11
Example IFFT Scale factor for NEST

| System | IFFT | |
|---|---|---|
| BW | Size | Scale |
| (MHz) | (nfft) | Factor |
| 1.4 | 32 | 1.6777 |
| 3 | 64 | 1.6643 |
| 5 | 128 | 1.6578 |
| 10 | 256 | 1.6545 |
| 15 | 512 | 1.6529 |
| 20 | 512 | 1.6529 |

FFT filtering may include the frequency filtering stage of the CRS CHEST Core Logic. Noise suppression may be achieved by zeroing out the non-signal region of the CIR. A ZF mask may be applied to the CIR (e.g., to further suppress the noise). Application of the ZF mask may include a point-wise multiplication of the CIR with the ZF Mask.

The FFT of the filtered CIR may be performed per SC channel estimate. The FFT may transform the filtered CIR back to the frequency domain. The FFT size may be based on the system BW per the examples of Table 12.

TABLE 12
Example FFT Size

| System | FFT |
|---|---|
| BW | Size |
| (MHz) | (nfft) |
| 1.4 | 32 |
| 3 | 64 |
| 5 | 128 |
| 10 | 256 |
| 15 | 512 |
| 20 | 512 |

Band Edge Extension Discard may be performed. In the band edge removal stage, the extra SCs added on the band-edges to extend to IFFT length are discarded.

Band Edge Replacement may be performed. The BE-SCs may suffer from some distortion due to FFT filtering, for example. To minimize the loss in performance, perhaps for example prior to taking the IFFT, among other scenarios, the BE-SCs may be extracted (for example 1 SC at one or more, or each, band edge). The BE-SCs may be filtered separately by EMA filtering (for example, in time domain and/or only such filtering) perhaps to minimize the distortion at band-edge, for example. The BE SCs may be replaced based on the SNR. When the input SNR is above 0 dB, for example, one SC on either end (for example the last and the first) may be replaced with the (e.g., filtered) 2D Mid-point BE SCs. In some techniques, perhaps otherwise no BE SCs might be replaced.

De-Windowing may be performed. Techniques may be performed to remove the effect of the window on the final Channel Estimates. The inverse of the window coefficients may be computed and/or stored per system BW and/or may be applied to the channel estimates, perhaps for example after Band-Edge replacement. The BE-SC may be extracted, perhaps for example prior to the windowing stage where the scale factor to compensate for CRS de-rotation may be applied. The de-window coefficients for the BE-SCs may be fixed to 1/sqrt(2) to compensate for de-rotation scaling. Perhaps for example depending on the SNR, either one or more, or no, BE SC may be at the band edges.

The coefficients may becomputed in SW and programmed to HW. The de-windowing may be done on the RS+Mid-point SCs (perhaps for example only on such SCs). In some techniques, perhaps some, for example half, of the coefficients may be stored for de-windowing (e.g., due to the symmetric character). Example De-Window Coefficients are illustrated in Table 13.

Example Matlab Code for generating de-window coefficients may be:

window = kaiser(nfft,6);
de_window = 1/window(nExt+1:2*nCrs+nExt);
if snr > 0

de_window([1, end]) = 1/sqrt(2);

end

TABLE 13
Example De-Window Coefficients

| System | | |
|---|---|---|
| BW | | |
| (MHz) | 2*N_{CRS} | 1^{st} half de-window coefficients |
| 1.4 | 24 | [5.8328 4.1497 3.1085 2.4303 1.9713 1.6521 1.4261 |
| | | 1.2652 1.1516 1.0743 1.0260 1.0029] |
| 3 | 60 | [27.4083 19.5841 14.6214 11.2844 8.9415 7.2406 |
| | | 5.9723 5.0055 4.2547 3.6625 3.1889 2.8059 2.4929 |
| | | 2.2349 2.0206 1.8416 1.6912 1.5643 1.4571 1.3663 |
| | | 1.2895 1.2247 1.1702 1.1249 1.0877 1.0577 1.0345 |
| | | 1.0174 1.0062 1.0007] |
| 5 | 100 | [7.3216 6.6371 6.0422 5.5224 5.0660 4.6637 4.3074 |
| | | 3.9909 3.7086 3.4560 3.2294 3.0255 2.8416 2.6752 |
| | | 2.5245 2.3875 2.2629 2.1493 2.0455 1.9506 1.8637 |
| | | 1.7841 1.7109 1.6437 1.5820 1.5251 1.4728 1.4247 |
| | | 1.3803 1.3395 1.3019 1.2673 1.2356 1.2065 1.1798 |
| | | 1.1554 1.1331 1.1129 1.0947 1.0782 1.0635 1.0505 |
| | | 1.0390 1.0292 1.0208 1.0139 1.0084 1.0043 1.0015 |
| | | 1.0002] |
| 10 | 200 | [7.3621 7.0062 6.6748 6.3657 6.0772 5.8074 5.5549 |
| | | 5.3183 5.0964 4.8879 4.6920 4.5076 4.3339 4.1701 |
| | | 4.0156 3.8696 3.7317 3.6012 3.4777 3.3607 3.2497 |
| | | 3.1445 3.0446 2.9497 2.8595 2.7737 2.6921 2.6143 |
| | | 2.5403 2.4697 2.4024 2.3382 2.2769 2.2184 2.1625 |
| | | 2.1091 2.0580 2.0092 1.9624 1.9177 1.8749 1.8339 |
| | | 1.7946 1.7570 1.7209 1.6863 1.6531 1.6213 1.5908 |
| | | 1.5616 1.5335 1.5066 1.4807 1.4559 1.4321 1.4093 |
| | | 1.3874 1.3663 1.3461 1.3267 1.3082 1.2903 1.2732 |
| | | 1.2568 1.2411 1.2261 1.2116 1.1978 1.1846 1.1720 |
| | | 1.1599 1.1484 1.1373 1.1268 1.1168 1.1073 1.0982 |
| | | 1.0896 1.0815 1.0738 1.0665 1.0596 1.0531 1.0471 |
| | | 1.0414 1.0361 1.0312 1.0267 1.0226 1.0188 1.0153 |
| | | 1.0123 1.0095 1.0071 1.0051 1.0034 1.0021 1.0011 |
| | | 1.0004 1.0000] |
| 15 | 300 | [2.7824 2.7410 2.7005 2.6610 2.6225 2.5849 2.5482 |
| | | 2.5124 2.4774 2.4433 2.4099 2.3773 2.3455 2.3144 |
| | | 2.2840 2.2543 2.2253 2.1969 2.1692 2.1421 2.1156 |
| | | 2.0896 2.0643 2.0395 2.0153 1.9916 1.9684 1.9457 |
| | | 1.9235 1.9017 1.8805 1.8597 1.8393 1.8194 1.7999 |
| | | 1.7808 1.7621 1.7438 1.7259 1.7083 1.6912 1.6743 |
| | | 1.6579 1.6417 1.6259 1.6105 1.5953 1.5805 1.5659 |
| | | 1.5517 1.5377 1.5241 1.5107 1.4976 1.4847 1.4721 |
| | | 1.4598 1.4477 1.4359 1.4243 1.4129 1.4018 1.3909 |
| | | 1.3802 1.3698 1.3595 1.3495 1.3396 1.3300 1.3206 |
| | | 1.3113 1.3023 1.2934 1.2847 1.2762 1.2679 1.2597 |
| | | 1.2517 1.2439 1.2363 1.2288 1.2214 1.2143 1.2072 |
| | | 1.2004 1.1936 1.1871 1.1806 1.1743 1.1682 1.1622 |
| | | 1.1563 1.1505 1.1449 1.1395 1.1341 1.1289 1.1238 |
| | | 1.1188 1.1139 1.1092 1.1045 1.1000 1.0956 1.0914 |
| | | 1.0872 1.0831 1.0792 1.0753 1.0716 1.0680 1.0645 |
| | | 1.0610 1.0577 1.0545 1.0514 1.0484 1.0455 1.0426 |
| | | 1.0399 1.0373 1.0347 1.0323 1.0300 1.0277 1.0255 |
| | | 1.0235 1.0215 1.0196 1.0178 1.0161 1.0145 1.0129 |
| | | 1.0115 1.0101 1.0089 1.0077 1.0066 1.0056 1.0046 |
| | | 1.0038 1.0030 1.0024 1.0018 1.0013 1.0008 1.0005 |
| | | 1.0003 1.0001 1.0000] |
| 20 | 400 | [7.3823 7.2008 7.0257 6.8567 6.6936 6.5360 6.3839 |
| | | 6.2368 6.0947 5.9572 5.8243 5.6957 5.5712 5.4507 |
| | | 5.3341 5.2211 5.1116 5.0055 4.9026 4.8029 4.7061 |
| | | 4.6123 4.5212 4.4329 4.3471 4.2638 4.1829 4.1043 |
| | | 4.0279 3.9537 3.8816 3.8115 3.7433 3.6769 3.6124 |
| | | 3.5496 3.4885 3.4291 3.3712 3.3148 3.2599 3.2064 |
| | | 3.1544 3.1036 3.0541 3.0059 2.9590 2.9131 2.8685 |
| | | 2.8249 2.7824 2.7410 2.7005 2.6610 2.6225 2.5849 |
| | | 2.5482 2.5124 2.4774 2.4433 2.4099 2.3773 2.3455 |
| | | 2.3144 2.2840 2.2543 2.2253 2.1969 2.1692 2.1421 |
| | | 2.1156 2.0896 2.0643 2.0395 2.0153 1.9916 1.9684 |
| | | 1.9457 1.9235 1.9017 1.8805 1.8597 1.8393 1.8194 |
| | | 1.7999 1.7808 1.7621 1.7438 1.7259 1.7083 1.6912 |
| | | 1.6743 1.6579 1.6417 1.6259 1.6105 1.5953 1.5805 |
| | | 1.5659 1.5517 1.5377 1.5241 1.5107 1.4976 1.4847 |
| | | 1.4721 1.4598 1.4477 1.4359 1.4243 1.4129 1.4018 |
| | | 1.3909 1.3802 1.3698 1.3595 1.3495 1.3396 1.3300 |
| | | 1.3206 1.3113 1.3023 1.2934 1.2847 1.2762 1.2679 |
| | | 1.2597 1.2517 1.2439 1.2363 1.2288 1.2214 1.2143 |
| | | 1.2072 1.2004 1.1936 1.1871 1.1806 1.1743 1.1682 |
| | | 1.1622 1.1563 1.1505 1.1449 1.1395 1.1341 1.1289 |
| | | 1.1238 1.1188 1.1139 1.1092 1.1045 1.1000 1.0956 |
| | | 1.0914 1.0872 1.0831 1.0792 1.0753 1.0716 1.0680 |
| | | 1.0645 1.0610 1.0577 1.0545 1.0514 1.0484 1.0455 |
| | | 1.0426 1.0399 1.0373 1.0347 1.0323 1.0300 1.0277 |
| | | 1.0255 1.0235 1.0215 1.0196 1.0178 1.0161 1.0145 |
| | | 1.0129 1.0115 1.0101 1.0089 1.0077 1.0066 1.0056 |
| | | 1.0046 1.0038 1.0030 1.0024 1.0018 1.0013 1.0008 |
| | | 1.0005 1.0003 1.0001 1.0000] |

EMA Filtering may be performed. The CRS+MidPoint SCs obtained after FFT filtering may be further filtered using EMA filter. This may be the time filtering in the CHEST core logic. The Mid-band and/or Band-Edge may be filtered, perhaps for example using separate filter coefficients.

Example filtering expressions are:

MB_SC_Filt(n)=α_{MB,p}*(de_win_out_MB(n)−MB_SC_Filt(n−1))+MB_SC_Filt(n−1)

BE_SC_Filt(n)=α_{BE,p}*(de_win_out_BE(n)−BE_SC_Filt(n−1))+BE_SC_Filt(n−1)

The total number of EMA filters may depend on the System BW and/or may be the number of RS+Mid-point SCs. The number of BE and/or MB EMA filters may depend on the SNR.

Table 14 illustrates example EMA filter lengths.

TABLE 14
Example EMA Filter Length

| | | |
|---|---|---|
| EMA | SNR >0 dB | SNR <0 dB |

| System | Filter | MB | BE | MB |
|---|---|---|---|---|
| BW | Bank | EMA | EMA | EMA |
| 1.4 | 24 | 22 | 2 | 24 |
| 3 | 60 | 58 | 2 | 60 |
| 5 | 100 | 98 | 2 | 100 |
| 10 | 200 | 198 | 2 | 200 |
| 15 | 300 | 298 | 2 | 300 |
| 20 | 400 | 398 | 2 | 400 |

The filter coefficients α_{MB,p} α_{BE,p} may be calculated in SW perhaps for example based on the channel Doppler and/or an effective SNR. The effective SNR may be the SNR at the input to EMA filter, perhaps taking into account the noise suppression from the FFT filtering stage using the number of zero forced taps. The coefficients are different for port 0/1 and port 2/3 due to different time spacing between RS symbols.

Example Matlab code for computing the filter coefficients:

```
snr = min(max(snr,−10),25);
fdmin = 5;
fdmax = 300;
doppLog = log10(min(max(doppler, fdmin),fdmax));
alphaCIR = zeros(nRxAnt,consts.MAX_NTX_ANT_PORTS);
alphaBE = zeros(1,consts.MAX_NTX_ANT_PORTS);
%% Alpha Calculation based on nzMaskLen and effective SNR
zfGain = dftLen./nzMaskLen;
effSnr = snr + 10*log10(zfGain);
coefVec01 = [0.689953986914109,0.653625142045389,−
0.480446376073762,0.0791666553858436,0.00206356385289387,0.000350321440379102,0
.00199146038544317,−0.00820492025251348,−
0.00136677462059088,0.000628404967870171];
coefVec23 = [0.818466815473215,0.351243557439792,−
0.304102771103115,0.0510572900350194,0.0119437567541956,−0.000205557882372509,−
0.0176583005347447,−0.00227973631966539,−
0.000413428440395080,0.000366713034905396];
doppLog_sq = doppLog\hat{ }2;
doppLog_cu = doppLog\hat{ }3;
effSnr_sq = effSnr.\hat{ }2;
snr_sq = snr\hat{ }2;
coefMb01 = zeros(nRxAnt,1);
coefMb23 = zeros(nRxAnt,1);
coefBe01 = 0;
coefBe23 = 0;
for rxIdx = 1:nRxAnt
  % Mapping vector using Effective SNR
  varVec = [1; doppLog; doppLog_sq; doppLog_cu; effSnr(rxIdx); ...
  effSnr_sq(rxIdx); doppLog*effSnr(rxIdx); ...
```

doppLog_sq*effSnr(rxIdx); doppLog*effSnr_sq(rxIdx); ...

doppLog_sq* effSnr_sq(rxIdx)];

varVecBe = [1; doppLog; doppLog_sq; doppLog_cu; snr; snr_sq;...

doppLog*snr; doppLog_sq*snr; doppLog*snr_sq; doppLog_sq*snr_sq];

coefMb01(rxIdx) = min(max(coefVec01*varVec, 0),0.96);
coefMb23(rxIdx) = min(max(coefVec23*varVec, 0),0.96);
coefBe01 = min(max(coefVec01*varVecBe, 0),0.98);
coefBe23 = min(max(coefVec23*varVecBe, 0),0.98);

end
alphaMB(:,1:2) = repmat(1−coefMb01,1,2);
alphaMB(:,3:4) = repmat(1−coefMb23,1,2);
alphaBE(1:2) = 1−coefBe01;
alphaBE(3:4) = 1−coefBe23;

The coefficients for EMA filtering may be calculated when there may be change to input SNR, channel Doppler, and/or a number of non-zero taps (for example, perhaps no more than once per frame (10 ms)).

Special handling may be useful for operating in MBSFN sub-frames. In MBSFN sub-frames, CRS may be present in (e.g., only) symbol 0 or 1 of the first slot in the sub-frame. EMA filtering may be skipped for the symbols in/on which CRS might not be present. The filter coefficients may be scaled by a factor, perhaps for example if the previous filtered symbol may be from an MBSFN sub-frame, among other scenarios. The scale factor may be based on the CRS port being processed. Table 15 illustrates example EMA Coefficient Scale Factors for MBSFN.

TABLE 15
Example EMA Coefficient Scale Factors for MBSFN

| | Scale |
|---|---|
| Port | Factor |
| 0/1 | 0.25 |
| 2/3 | 0.5 |

CIR Post Processing may be performed. The CRS CHEST Core Logic may output the unfiltered CIR (Channel Impulse Response) which may be post-processed and/or used for the Zero-Forcing mask, Delay Spread Estimation, and/or Timing Estimation within the CHEST, and/or output to the AFC. Table 16 illustrates example Inputs to CIR Post Processing. Table 17 illustrates example Parameters of CIR Post Processing. Table 18 illustrates example Outputs of CIR Post Processing.

TABLE 16
Example Inputs to CIR Post Processing

| | | | Data | |
|---|---|---|---|---|
| | | | Format | |
| Input Name | Description | Source(s) | <T, I, S> | Comment |
| Ifft_out | Unfiltered | CRS | — | Input at RS |
| | Channel | CHEST | | symbol rate |
| | Impulse | Core | | per Tx Rx |
| | response | Logic | | Link |
| ZFMask_no_RO | Binary valued | ZF Mask | <1, 1, u> | Input per Rx |
| | ZF Mask | Gen | | antenna |
| | without Roll- | | | every Radio |
| | off and index | Frame | | |
| | extension | | | |

TABLE 17
Example Parameters of CIR Post Processing

| | | Type (Design, SW |
|---|---|---|
| | | Compile Time, Run |
| Parameter | Supported Values | Time) |
| System | System Bandwidth the UE is | Run Time (changes |
| bandwidth | configured for. | less than once per |
| | | frame, but can change |
| | | at any subframe |
| | | boundary; value |
| | | known more than a |
| | | frame in advance) |
| NR = | 1 or 2 | SW Compile Time |
| number | | |
| of receive | | |
| antennas | | |
| C-RS | Number of CRS ports for Cell | Run Time (changes |
| antenna | Specific Reference signal. Possible | less than once per |
| ports | values 1, 2 or 4. Can be less than | frame, but can change |
| | or equal to the number of physical | at any subframe |
| | transmit antenna on the eNode B | boundary; value |
| | | known more than a |
| | | frame in advance) |

TABLE 18
Example Outputs of CIR Post Processing

| Output Name | Description | Comment |
|---|---|---|
| CIR_accum | Post processed CIR | Once per Radio |
| | | frame |
| | | To ZF Mask |
| | | Gen |
| CIR_accum_DSFSP | CIR for Delay spread | Once per Radio |
| | estimation and FSP | frame |
| | tracking | To DS, FSP |
| | | Estimation |
| CIR_AFC | CIR to AFC component | Once per RS |
| | | Symbol |
| | | To AFC |

The CIR post processing may be performed (e.g., only) in the signal region of the CIR. Some portion of the region of the CIR that may be used to compute noise estimate might not be used by downstream components. The signal region may be the first and last quarter of the CIR.

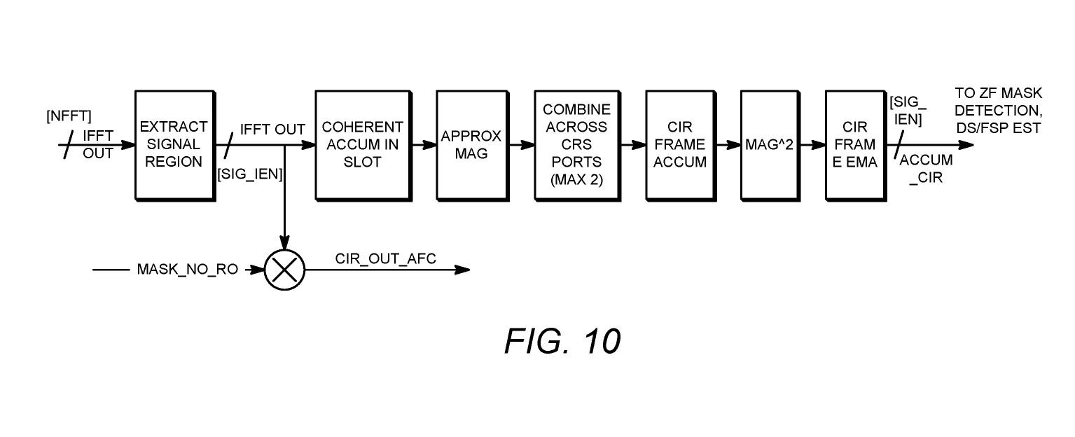

A example block diagram of CIR Post-processing logic is shown in FIG. 10.

TABLE 19
Example Parameters for signal extraction

| System BW | IFFT Size | Sig Len | Signal region Indices |
|---|---|---|---|
| 1.4 | 32 | 16 | [0, 7], [24, 31] |
| 3 | 64 | 32 | [0, 15], [48, 63] |
| 5 | 128 | 64 | [0, 31], [96, 127] |
| 10 | 256 | 128 | [0, 63], [192, 255] |
| 15 | 512 | 256 | [0, 127], [384, 511] |
| 20 | 512 | 256 | [0, 127], [384, 511] |

The CIR post-processing may be done per Rx antenna and/or for up to 2 CRS ports. The signal region may be extracted from the CIR. For the AFC output, the CIR may be multiplied with the ZF Mask so as to zero out the samples that are below the noise floor, for example. Techniques may include coherently accumulating the CIR for one or more symbols, for example two symbols, within a slot to suppress the noise. An approximate magnitude operation may be performed on the CIR, perhaps instead of magnitude square, for example to reduce the implementation complexity.

cir_mag=α*max(real(CIR),imag(CIR))+β*min(real(CIR),imag(CIR))

where CIR may be the output after coherent accumulation. Example values for a and b are given in Table 20.

TABLE 20
Example Parameters for approximate magnitude

| α | β |
|---|---|
| 0.947543636291 | 0.392485425092 |

Techniques may include combining across CRS ports. The CIR magnitude from up to 2 or more ports may be combined and/or accumulated over 1 frame (e.g., 20 slots). The frame accumulated CIR magnitude squared may be filtered further using an EMA filter with filter coefficient α_{CIR}_{_}_{frame} of 0.2.

accum_cir(n)=α_{CIR}_{_}_{frame}*(cir_maĝ2−accum_cir(n−1))+accum_cir(n−1)

The accumulated and/or filtered CIR may be generated one or more frames, or every frame, per Rx antenna and/or may be used for ZF mask generation, delay spread, and/or timing estimation.

A ZF mask may be used in FFT filtering of the CRS CHEST Core Logic. The ZF mask may suppress the noise in the CIR estimate after EMA filtering. The ZF mask may be generated per Tx-Rx link. The ZF mask may be applied to the EMA filtered CIR. The ZF Mask may be generated based on the accumulated CIR and/or a noise scaled threshold. For example, the accumulated CIR may be compared against the noise scaled threshold. An M out of N detection logic may be applied. Application of the M out of N detection logic may reduce the occurrence of false alarms in detection. The ZF mask may include a roll off at transitions. The roll off may reduce band edge effects (e.g., caused by sudden transitions in the ZF mask).

A ZF Mask for FFT filtering of CSI-RS CHEST may be determined based on the CRS ZF Mask (e.g., with some adjustments to account for lower sampling in the frequency domain for CSI-RS).

ZF Mask Generation may receive one or more inputs. The one or more ZF Mask Generation inputs may include cir_accum. The cir_accum may include an Accum CIR from CIR post processing. The cir_accum may be received from the CIR post processing. The cir_accum may be received at RS symbol rate per Rx antenna.

The one or more ZF Mask Generation inputs may include Noise_est. The Noise_est may include a noise estimate from the NEST. The Noise_est may be received per RS symbol and per Rx antenna.

The one or more ZF Mask Generation inputs may include Ofdmp_csirs_valid. The Ofdmp_csirs_valid may indicate which CSI-RS ports the CSIRS input is associated with. The Ofdmp_cisirs_valid may have four example values. A value of −1 may indicate output not valid. A value of 0 may indicate CSI-RS ports 15/16. A value of 1 may indicate CSI-RS ports 15/16 and 17/18. A value of 2 may indicate CSI-RS ports 15/16, 17/18, 19/20 and 21/22. The Ofdmp_csirs_valid may be received from the OFDM processor. The Ofdmp_csirs_valid may be received at the symbol rate.

ZF Mask Generation may include one or more parameters. The one or more ZF Mask Generation parameters may include system bandwidth, NR, and CRS antenna ports.

ZF Mask Generation may include one or more outputs. The one or more ZF Mask Generation outputs may include ZF Mask. ZF Mask may include the ZF Mask for FFT filtering. ZF Mask may be determined once per radio frame. The one or more ZF Mask Generation outputs may include ZF Mask CSI-RS. ZF Mask CSI-RS may include the ZF Mask for FFT filtering for CSI-RS. ZF Mask CSI-RS may be valid (e.g., only valid) perhaps for example when CSI-RS is enabled.

One or more parameters may be used for roll off and/or zero-fill. Examples of the one or more parameters for signal extraction and/or zero-fill may include any of the elements of Table 21.

TABLE 21
Example of Parameters for Roll-off and Zero-fill

| | | | | Zero fill | Zero fill |
|---|---|---|---|---|---|
| System BW | IFFT Size | Sig Len | Roll off | start Index | Length |
| 1.4 | 32 | 16 | 6 | 13 | 6 |
| 3 | 64 | 32 | 8 | 23 | 18 |
| 5 | 128 | 64 | 12 | 43 | 42 |
| 10 | 256 | 128 | 20 | 83 | 90 |
| 15 | 512 | 256 | 20 | 147 | 218 |
| 20 | 512 | 256 | 20 | 147 | 218 |

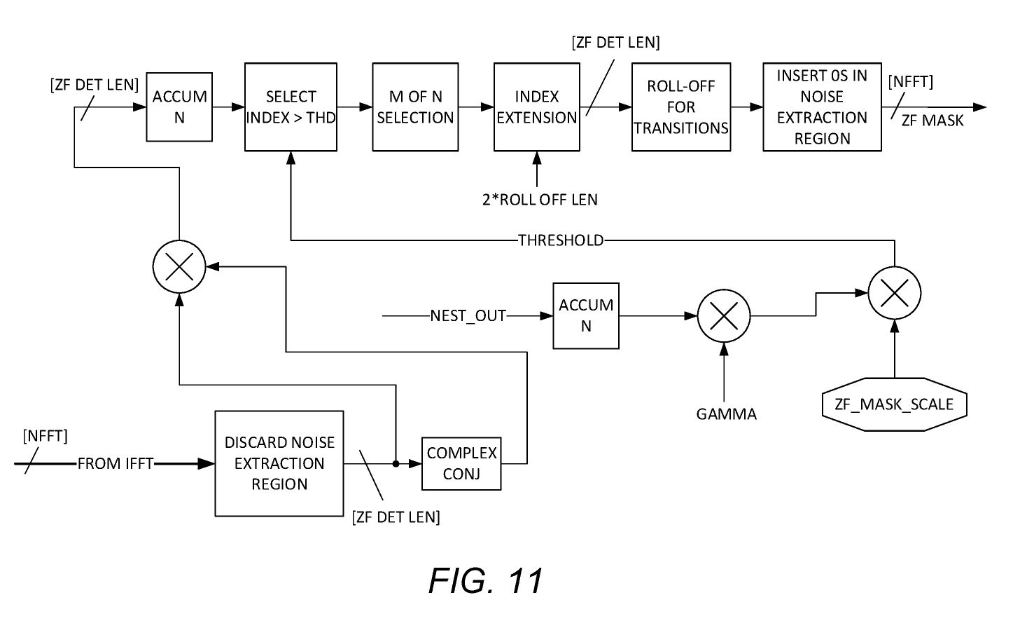

FIG. 11 is a block diagram of an example ZF Mask Generation. The ZF Mask may be defined and/or generated (e.g., only) in the signal region of the CIR. The non-signal region discarded in the CIR post processing stage may be inserted back with zeros, perhaps for example before output for correct indexing in subsequent sub-components, among other reasons.

ZF Mask may include a Threshold, M out of N Logic, Index Extension, and/or Roll-off.

The post processed CIR with the noise region discarded may be compared against a threshold (Thd). The Thd may be scaled by the accumulated noise. Examples of the values for Nacc and/or Thd may include the values specified in Table 22.

TABLE 22
Example ZF Detection Related Parameters

| Parameter | Value |
|---|---|
| N_{acc} | 20 |
| Thd | 2 |
| M | 2 |
| N | 3 |

The value of Thd may be determined (e.g., empirically) using an Energy weighted Missed Detection (EMD) and/or an Energy Weighted False Alarm (EFA). Location indices may be determined for the vector where the value is greater than the noise scaled threshold. The location indices may be stored in a FIFO buffer for N consecutive computations.

M out of N Logic may be performed in the ZF Mask Generation. One or more location indices that meet a threshold criteria may be stored in a FIFO buffer for N consecutive computations (e.g., to reduce false alarms in detection of signal energy). When a location index is detected M out of N times, the location index may be enabled in the final ZF mask. A mask of length equal to the IFFT size may be created based on the location indices after M out of N detection. The value of the mask at the indices may be set to 1 and the other locations may be set to 0.

Index Extension may be performed in the ZF Mask Generation. A signal energy region may be estimated based on the location indices that pass the M out of N Logic. A roll-off may be included at a transition region. The roll-off may reduce band edge effects (e.g., caused by sudden transitions from 1 to 0 or 0 to 1 in the mask). A roll-off may be added (e.g., only added) if no signal energy is detected for at least twice the roll-off length. Index Extension may extend the location indices in between short regions of the mask (e.g., where signal energy is not detected). When the length of a region between 2 signal regions is less than twice the roll-off length, the region may be included in the location indices. The CIR may include some wrap around. Signal energy may be detected at an end of a region. The Index Extension may consider wrap around and/or signal energy at the end of a region (e.g., while extending the mask).

Index Extension may be determined using the following example Matlab Code,

% idxSelMofN is binary vector of size IFFT Len indicating location
indices
% after M of N Detection
% dftLen is IFFT Length depending on System BW
nonZero = find(idxSelMofN > 0);
first1 = nonZero(1);
if first1 > 1 && (nonZero(end) == dftLen)

idxSelMofN(1:first1−1) = 1;

end
diffIdx = diff([idxSelMofN(1) idxSelMofN′ 1]);
strIdx0 = find(diffIdx < 0);
endIdx0 = find(diffIdx > 0);
if idxSelMofN(1)

len0 = endIdx0 − strIdx0;
fillSet = find(len0 < 2*roLen);
if ~(isempty(fillSet))

for l = 1: length(fillSet)

idxSelMofN(strIdx0(fillSet(l)):endIdx0(fillSet(l))−1) = 1;

end

end

else

len0 = endIdx0(2:end) − strIdx0;
fillSet = find(len0 < 2*roLen);
if ~(isempty(fillSet))

for l = 1: length(fillSet)

idxSelMofN(strIdx0(fillSet(l)):endIdx0(fillSet(l)+1)−1) = 1;

end

end

end
nonZero = find(idxSelMofN > 0);
first1 = nonZero(1);
if first1 > 1 && (nonZero(end) == dftLen )

idxSelMofN(1:first1−1) = 1;

end

Roll-off may be performed in ZF Mask Generation. After index extension, the mask may be binary valued. A roll-off may be added at transitions. The roll-off may reduce band-edge effects in the frequency domain. The roll-off length may be determined based on the system BW. A Blackman window of twice the roll-off length may be used for the roll-off. A first half of the window may be used for transition from 0 to 1 in the mask. A second half of the window may be used for transition from 1 to 0. The first half (e.g., only the first half) of the window coefficients may be stored (e.g., because the window is symmetric). Coefficients for the transition from 1 to 0 may use the stored coefficients (e.g., in the reverse order). Examples of the first half of the window coefficients used in ZF Mask Generation may be represented in Table 23.

TABLE 23
Example Roll-off Window Coefficients

| | Roll | |
|---|---|---|
| System | off | |
| BW | Length | Roll-Off Coefficients from 1^{st} half of Window |
| 1.4 | 6 | [0 0.0326 0.1599 0.4144 0.7360 0.9670] |
| 3 | 8 | [0 0.0168 0.0771 0.2008 0.3940 0.6300 0.8492 |
| | | 0.9822] |
| 5 | 12 | [0 0.0069 0.0296 0.0733 0.1438 0.2449 |
| | | 0.3749 0.5254 0.6815 0.8241 0.9332 0.9924] |
| 10, 15, | 20 | [0 0.0024 0.0097 0.0227 0.0425 0.0704 0.1076 0.1551 |
| 20 | | 0.2133 0.2821 0.3604 0.4464 0.5374 0.6300 0.7202 |
| | | 0.8039 0.8769 0.9354 0.9763 0.9973] |

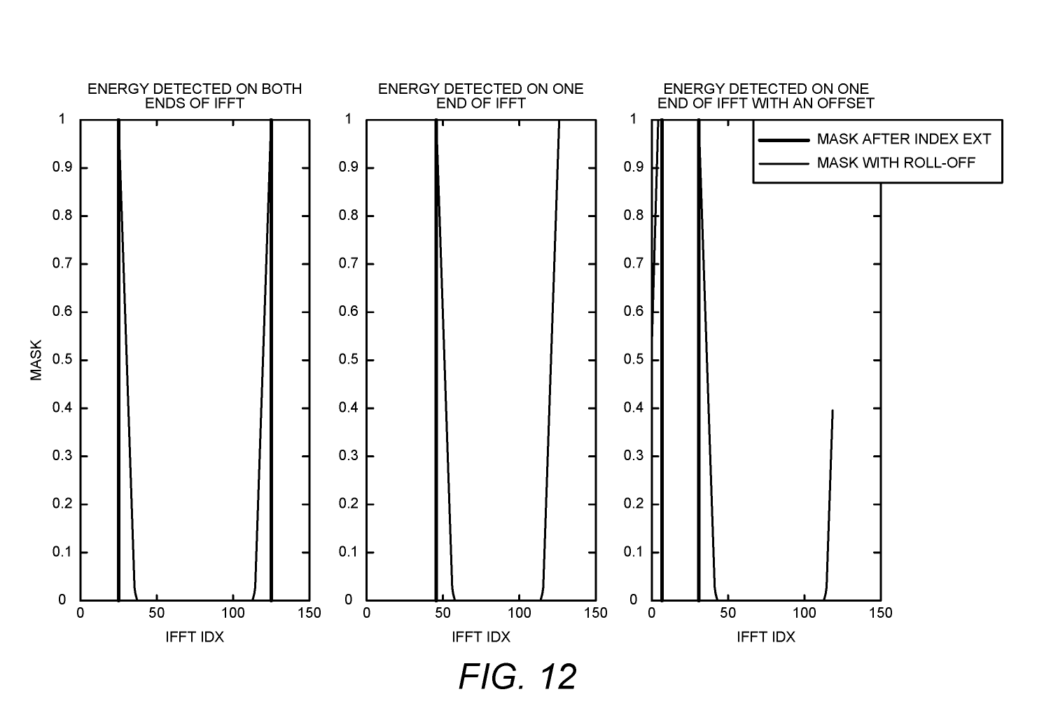

The roll-off may account for a wrap around in the CIR. The roll-off may wrap around (e.g., to make the CIR continuous in a circular sense). FIG. 12 depicts plots of example masks with Roll-off and wrap-around.

ZF Mask Generation may be provided for CSI-RS. The ZF mask for CSI-RS may be determined based on the CRS accumulated CIR (e.g., since CSI-RS is not transmitted in every slot like CRS). CSI-RS may include a periodicity of up to 80 ms. CIR accumulation based ZF mask detection may be impractical. The indices from CRS mask detections after thresholding and M out of N selection may be used to generate a mask for CSI-RS. The index extension stage may be the same as CRS and/or may take into account the roll-off window sizes for CSI-RS given in Table 24.

For a given BW, the CIR length for CSI-RS is half that of CRS (e.g., due to half the number of sub-carriers in frequency for CSI-RS compared to CRS). The signal part of the CIR may occupy the same number of samples between CRS and CSI-RS based CIR (e.g., because CRS and CSI-RS may have the same sample size). When there is a wrap-around of the CIR on the tail end, the number of samples with energy on the tail end may be the same. The ZF mask based on CRS may be used for CSI-RS per Rx antenna port. The ZF Mask may be computed in SW.

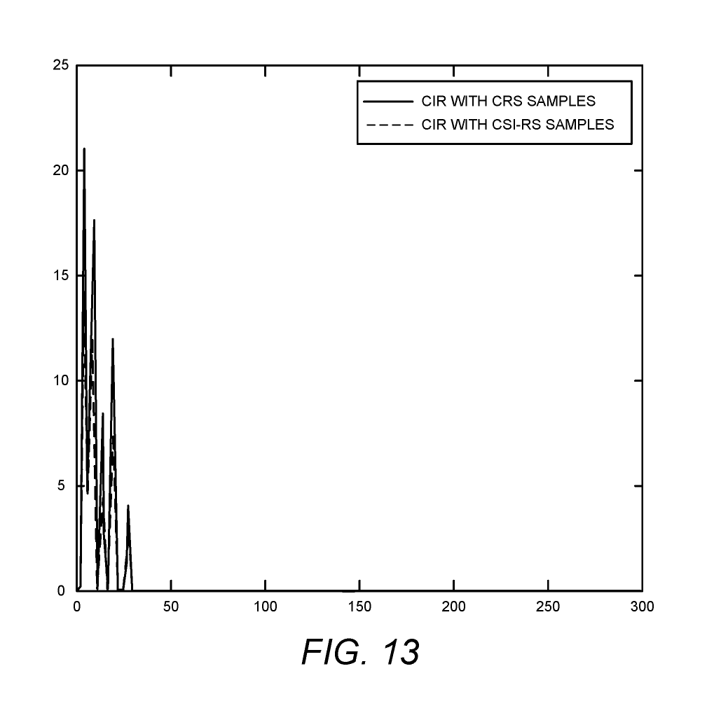

FIG. 13 is a chart depicting an example CIR with CRS and CSI-RS channel estimates.

A CSI-RS mask may be generated based on CRS using the following Matlab code:

for rxIdx = 1:params.nRxAnt

nonZero = find(idxSelMofN > 0);
if ~isempty(nonZero)

% Extend mask where 0's are < 2*RO len
first1 = nonZero(1);
if first1 > 1 && (nonZero(end) == 2*dftLen ) % Roll-off for CSI needs to be updated

for this to work. Roll-off for CRS has been updated

idxSelMofN(1:first1−1) = 1;

end
diffIdx = diff([idxSelMofN(1) idxSelMofN′ 1]);
strIdx0 = find(diffIdx < 0);
endIdx0 = find(diffIdx > 0);
if idxSelMofN(1)

len0 = endIdx0 − strIdx0;
fillSet = find(len0 < 2*roLen);
if ~(isempty(fillSet))

for l = 1: length(fillSet)

idxSelMofN(strIdx0(fillSet(l)):endIdx0(fillSet(l))−1) = 1;

end

end

else

len0 = endIdx0(2:end) − strIdx0;
fillSet = find(len0 < 2*roLen);
if ~(isempty(fillSet))

for l = 1: length(fillSet)

idxSelMofN(strIdx0(fillSet(l)):endIdx0(fillSet(l)+1)−1) = 1;

end

end

end
nonZero = find(idxSelMofN > 0);
first1 = nonZero(1);
if first1 > 1 && (nonZero(end) == 2*dftLen )

idxSelMofN(1:first1−1) = 1;

end
idxSelCsi = zeros(dftLen,1);
diffIdx = diff([0 idxSelMofN′ 0]);
strIdx1 = find(diffIdx > 0);
endIdx1 = find(diffIdx < 0);
for n = 1:length(strIdx1)

if strIdx1(n) < dftLen && endIdx1(n) <= dftLen

idxSelCsi(strIdx1(n):endIdx1(n)−1) = 1;

elseif strIdx1(n) < dftLen && endIdx1(n) > dftLen

idxSelCsi(strIdx1(n):end) = 1;

elseif strIdx1(n) >= dftLen

lenWA = length(strIdx1(n):endIdx1(n)−1);
idxSelCsi(dftLen−lenWA+1:dftLen) = 1;

end

end

end
% Add roll-off at transitions
maskIdx = idxSelCsi;
diffIdx = diff([idxSelCsi(1) idxSelCsi′ 1]);
trans0to1 = find(diffIdx > 0);
trans1to0 = find(diffIdx < 0);
for l = 1:length(trans1to0)

maskIdx(trans1to0(l):trans1to0(l)+roLen−1) = maskWin(roLen+2:end−1);

end
for l = 1:length(trans0to1)

if trans0to1(l) <= roLen

maskIdx(1: trans0to1(l)−1) = maskWin(roLen+1−(trans0to1(l)−1)+1:roLen+1);
maskIdx(dftLen − (roLen+1) + (trans0to1(l)−1) +1 :dftLen) = maskWin(1:roLen+1−

(trans0to1(l)−1));

elseif trans0to1(l) > dftLen && maskIdx(1)==1

maskIdx(dftLen−roLen+1: dftLen) = maskWin(2:roLen+1);

elseif trans0to1(l) <= dftLen

maskIdx(trans0to1(l)−roLen: trans0to1(l)−1) = maskWin(2:roLen+1);

end

end
maskReal(:,rxIdx) = maskIdx;

end

Example roll-off window coefficients for CSI-RS may be represented in Table 24.

TABLE 24
Example Roll-off Window Coefficients

| | Roll | |
|---|---|---|
| System | off | |
| BW | Length | Roll-Off Coefficients from 1^{st} half of Window |
| 1.4 | 3 | [0 0.2008 0.8492] |
| 3 | 6 | [0 0.0326 0.1599 0.4144 0.7360 0.9670] |
| 5 | 8 | [0 0.0168 0.0771 0.2008 0.3940 0.6300 0.8492 |
| | | 0.9822] |
| 10 | 12 | [0 0.0069 0.0296 0.0733 0.1438 0.2449 0.3749 0.5254 |
| | | 0.6815 0.8241 0.9332 0.9924] |
| 15, 20 | 20 | [0 0.0024 0.0097 0.0227 0.0425 0.0704 0.1076 0.1551 |
| | | 0.2133 0.2821 0.3604 0.4464 0.5374 0.6300 0.7202 |
| | | 0.8039 0.8769 0.9354 0.9763 0.9973] |

Downlink Time Tracking/Delay Spread Estimation may be performed. The delay spread estimator block may estimate the Root Mean Square (RMS) delay spread of the channel impulse response. This block may provide delay spread estimate to the equalizer for UE RS CHEST. The downlink timing estimation block may estimate the First Significant Path (FSP) and/or the Most Significant Path (MSP). The FSP may serve as an input for the synchronization block. The MSP may serve as input to the Doppler estimator. The DS, FSP and/or MSP may be derived from a filtered and/or accumulated time domain Channel Impulse Response, perhaps for example from the CIR post processing block. This input may have samples of the size of FFT for NR receive antennas. Time Tracking and/or Delay Spread Estimation may be performed in SW.

Table 25 illustrates examples of Inputs to Time Tracking/Delay Spread Estimator. Table 26 illustrates examples of Parameters of Time Tracking/Delay Spread Estimator. Table 27 illustrates examples of Outputs of Time Tracking/Delay Spread Estimator.

TABLE 25
Examples of Inputs to Time Tracking/Delay Spread Estimator

| Input Name | Description | Source(s) | Comment |
|---|---|---|---|
| CIR_accum_DSFSP | Accumulated CIR | CIR post | Output at RS |
| | from CIR | processing | symbol rate |
| | post-processing | | per Rx ant |
| nest | Noise Estimate | NEST | Input per RS |
| | | | symbol, per |
| | | | Rx antenna |

TABLE 26
Examples of Parameters of Time Tracking/Delay Spread Estimator

| | | Type (Design, |
|---|---|---|
| | | SW Compile Time, |
| Parameter | Supported Values | Run Time) |
| fspThreshold | 5 (it can support any value, | Optimization/ |
| | but simulation indicate that 5 | Runtime |
| | seem to give good results in | |
| | different channels) | |
| pdpThreshold | 8 (it can support any value, | Optimization/ |
| | but simulation indicate that 8 | Runtime |
| | seem to give good results, in | |
| | different channels | |
| nTxAntPorts | Number of TX Antenna ports | Design |
| nRxAntPorts | Number of RX Antenna ports | Design |

TABLE 27
Examples of Outputs of Time Tracking/Delay Spread Estimator

| Output Name | Description | Comment |
|---|---|---|
| FSP | First significant Path | For each rx |
| | | antenna |
| MSP | Most Significant Path | For all rx |
| | | antenna |
| DS | Delay Spread | For each rx |
| | | antenna |

Path Index Wrap may be performed. Perhaps for example due to the circular nature of the time-domain CIR, among other reasons, for one or more, or each, input CIR, the last ¼ symbols followed by first ¼ symbols may be extracted. This may ensure that any negative shift of the first significant path (FSP) is captured correctly. The output may have nfft/2 I/Q channel for one or more, or each, of NR receive antennas. As used herein, nfft may be the same as IFFT Length in EMA-FFT Filtering. NR may be a number of receive antenna as defined in CRS CHEST Core logic. The first and/or last quarter of CIR may be considered in DS/FSP estimation for at least the reason that it is the signal region of the CIR. In some techniques, the noise region might not be considered.

An example Matlab code snippet explaining the symbols being considered for path index wrap:

pathWrapindex=[3*fftSize/4+1:fftSize,1:fftSize/4];

This index may be used for one or more following blocks. DS/FSP may be estimated for one or more, or each, receive antenna independently. MSP may be the most significant path over one or more, or all, the antennas.

Time Tracking may be performed. Time Tracking may include finding the first significant path. The estimator may find the index of the first significant path of the power delay profile. This may be the first path that is higher than a noise scaled threshold. This value of threshold may be found empirically using simulations. Perhaps for example if there are NR>1, it may find the smallest of the indices among the NR antennas. For example, nfft/4 may be subtracted from the index to compensate for the path index wrap described herein. Perhaps for example if no path is higher than the threshold, among other scenarios, the FSP may be considered to be 1.

Example Matlab code for finding index of FSP:

pathPower = accTapPower(pathWrapIndex,rxIdx); % Select AccTapPower
for each Rx Antenna

fspLoc = find(pathPower(pathWrapIndex) >

params.fspThreshold*nest(rxIdx));

% Find the FSP location

if isempty(fspLoc)

fsp(rxIdx) = 1;

| % If FSP is not found set it to 1. This could be replaced by | |
|---|---|
| some control | signal indicating that FSP was not found |

else

fsp(rxIdx) = fspLoc(1) − fftSize/4 + 1;
% undo the wrap around and return the fsp index

end

An MSP estimator may find an index of the most significant path. This may be the largest path in the accumulated CIR. This MSP index may be passed to the Doppler estimator. Perhaps for example if there are multiple antennas, among other scenarios, it may find the index of the largest path among one or more, or all, the antennas. For example, nfft/4 may be subtracted from the index to compensate for the path index wrap described herein.

Example Matlab code for finding index of MSP:

[msp_val, msp_tmp (rxIdx)] =

max(accTapPower(pathWrapIndex,rxIdx));

if msp_val > msp_max

msp_out = msp_tmp(rxIdx) − fftSize/4 + 1;

msp_max = msp_val;

end

Delay Spread Estimator may compute RMS delay-spread of the channel impulse response. It may remove one or more, or all, the paths below a desired noise scaled threshold for delay-spread. This value of threshold may be found empirically using simulations. The RMS delay spread may be computed from the remaining CIR taps using one or more of the following equations. RMS DS may be computed for one or more, or each, receive antenna (e.g., independently). The output may have NR samples, for example one for each receive antenna.

$$meanPath = \frac{\sum pathLoc ( i ) * pathPower ( i )}{\sum pathPower ( i )}$$

$$delaySpread = \sqrt{\frac{\sum {( pathLoc ( i ) - meanPath )}^{2} * pathPower ( i )}{\sum pathPower ( i )}}$$

Example Matlab code for computing DelaySpread:

% consts.SC_SPACING = 45000; % consts.SC_SPACING =
C.fddR8.frameT1.SUBCARR_SPACING*3
tapSpacing = 1/(fftSize * consts.SC_SPACING); % Compute tap spacing
based on FFT size
% Compute DelaySpread
pathPower = accTapPower(pathWrapIndex,rxIdx);
pathLoc = find(pathPower > params.pdpThreshold*nest(rxIdx));
if isempty(pathLoc)

delaySpread(rxIdx) = 0;

else

pathPowLoc = pathPower(pathLoc);
sumPathPowLoc = sum(pathPowLoc);
pdp = (pathLoc −fftSize/4) * tapSpacing; % PDP in nSeconds
meanPath = sum(pdp.*pathPowLoc)/sumPathPowLoc;
delaySpread(rxIdx)=sqrt(sum((pdp − meanPath).\hat{ }2.*(pathPowLoc)) /

sumPathPowLoc);
end

Noise Estimation may be performed using Cell Specific Reference Signals as described herein. The noise estimation based on CRS may be used by the Equalizer. The CRS based noise estimate (NEST) may include a wideband estimate of noise from up to 2 CRS ports (e.g., port 0/1). The NEST may be determined based on a CIR estimate from the CHEST. As described herein, the CHEST may output the CIR estimate after 2-D mid-point and/or IFFT prior to EMA-FFT filtering for each CRS port-Rx antenna pair. The CIR estimate for a Tx-Rx pair for up to 2 CRS ports may be used to determine a NEST. The NEST may be determined per receive antenna. The NEST may output one or more RS symbols associated with port 0/1.

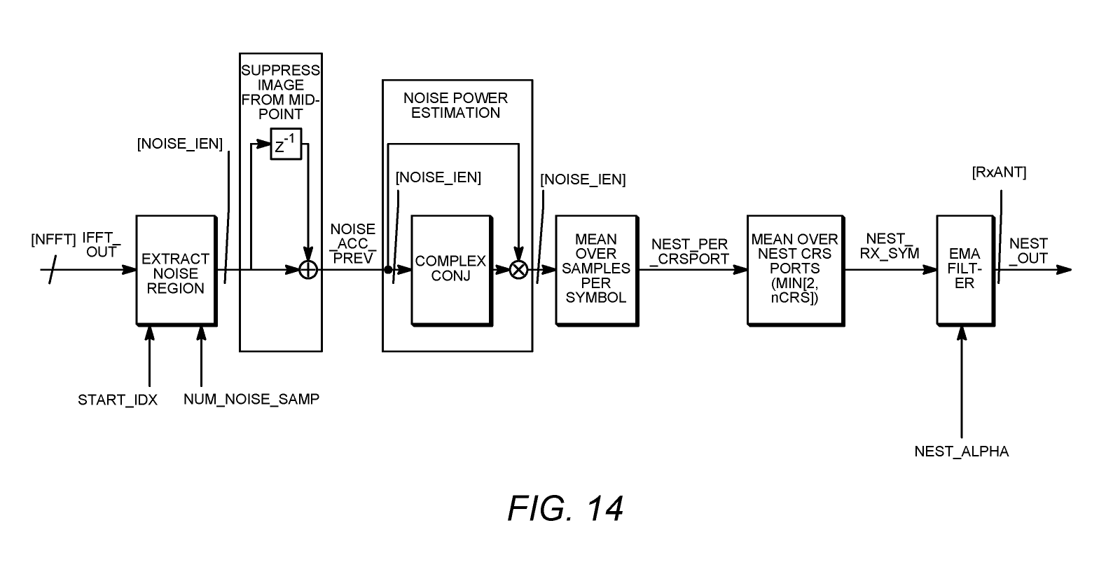

FIG. 14 is a block diagram of an example CRS based Noise Estimation. The CRS based Noise Estimation may include Noise region extraction, Noise power estimation, and/or EMA filtering in time. Noise region extraction may be performed in CRS based Noise Estimation. A region of the CIR beyond the CP length may represent a noise region. The noise region may not include a region at the tail end of the CIR or IFFT (e.g., to avoid wrap-around of the impulse response).

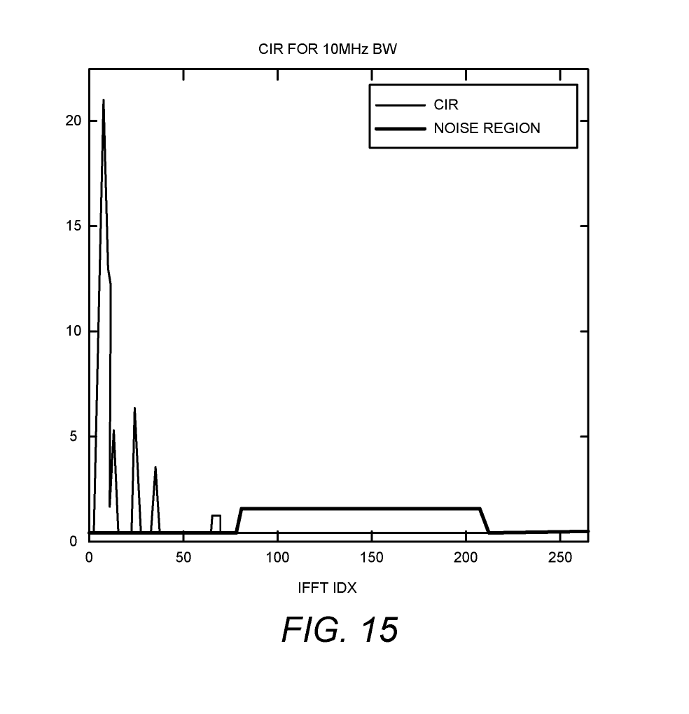

FIG. 15 is a chart depicting an example Noise Extraction Region.

The noise region in the CIR may be defined based on the system BW per the examples of Table 28.

TABLE 28
Example Noise Extraction Region

| | | | Num. Samples |
|---|---|---|---|
| System BW | IFFT Size | Start Idx | for Noise Est |
| 1.4 | 32 | 8 | 16 |
| 3 | 64 | 16 | 32 |
| 5 | 128 | 32 | 64 |
| 10 | 256 | 64 | 128 |
| 15 | 512 | 128 | 256 |
| 20 | 512 | 128 | 256 |

Mid-point interpolation in the CHEST may create an image of the CIR. The image of the CIR may result from aliasing in the noise region. One or more images of the CIR may be suppressed when combined coherently (e.g., due to the alternating pattern of CRS and mid-point REs in consecutive symbols). After the noise samples are extracted, the resulting vector may be combined (e.g., coherently) with the noise samples from a previous CRS symbol.

In MBSFN sub-frames, special handling may be necessary. Coherent combining may be performed (e.g., only performed) when the previous RS symbol received has a CRS+Mid-point pattern offset compared to the current symbol. In MBSFN sub-frames, CRS for port 0/1 may be transmitted on symbol 0 of a sub-frame. When the previous symbol processed was a RS from symbol 0 in the previous sub-frame, the symbols may not be coherently combined.

Noise Estimation and Filtering may be performed. The noise estimate may include a mean of the power of samples of CIR in a noise region. A per sample noise power estimate may be determined. For example, a vector of noise samples may be multiplied by its complex conjugate to determine the per sample noise power estimate. The mean of the samples may reduce variance in the NEST. The per sample noise power estimate may be determined per CRS port and per Rx antenna pair. The NEST may be averaged across CRS ports (e.g., up to 2 CRS ports). The per Rx antenna NEST may be filtered over time by an EMA filter. The EMA filter may include a coefficient of α_{NEST}.

nestOut(n)=α_{NEST}*(nest_rx_sym(n)−nestOut(n−1))+nestOut(n−1)

Where nest_rx_sym is the noise estimate obtained after averaging across the noise elements and/or CRS ports.

In MBSFN sub-frames, CRS symbols may be transmitted on (e.g., only on) symbol 0 of the sub-frame. Special handling may be performed in the NEST filtering. A scale factor (bias_offset_mbsfn) may be applied perhas prior to EMA filtering, for example to reduce the bias in the estimate caused by the image, among other reasons. The scale factor may be empirically computed perhaps for example based on the bias observed in the Noise estimate in AWGN channel. One or more CRS symbols may be absent due to MBSFN. The EMA filtering may not be performed on the one or more absent CRS symbols. A filter coefficient of α_{NEST}_{_}_{MBSFN} may be used perhaps for example if the previous RS symbol is symbol 0 of a MBSFN sub-frame.

nestOut(n)=α_{NEST}_{_}_{MBSFN}*(bias_offset_mbsfn*nest_rx_sym(n)−nestOut(n−1))+nestOut(n−1)

TABLE 29
Example NEST Parameters

| Parameter | Value | <T, I, S> |
|---|---|---|
| bias_offset_mbsfn | 3.247580126 | <8, 0, u> |
| α_{NEST} | 0.2 | <8, 0, u> |
| α_{NEST}_{_{—}}_{MBSFN} | 0.8 | <8, 0, u> |

The filtered noise estimate per Rx antenna may be output in one or more, or every, symbol port 0/1 in which CRS may be present.

Channel Estimation may be performed using CSI-RS. CSI-RS based Channel estimation may provide channel estimates for CSI-RS port and Rx links.

CSI-RS may be transmitted on 1, 2 4 or 8 antenna ports. CSI-RS may be transmitted using p=15, p=15, 16, p=15, . . . 18 and p=15, . . . 22, respectively. CSI-RS may be transmitted with a periodicity of 5, 10, 20, 40 or 80 sub-frames. The CSI-RS location in a PRB may be determined by the config and CP type.

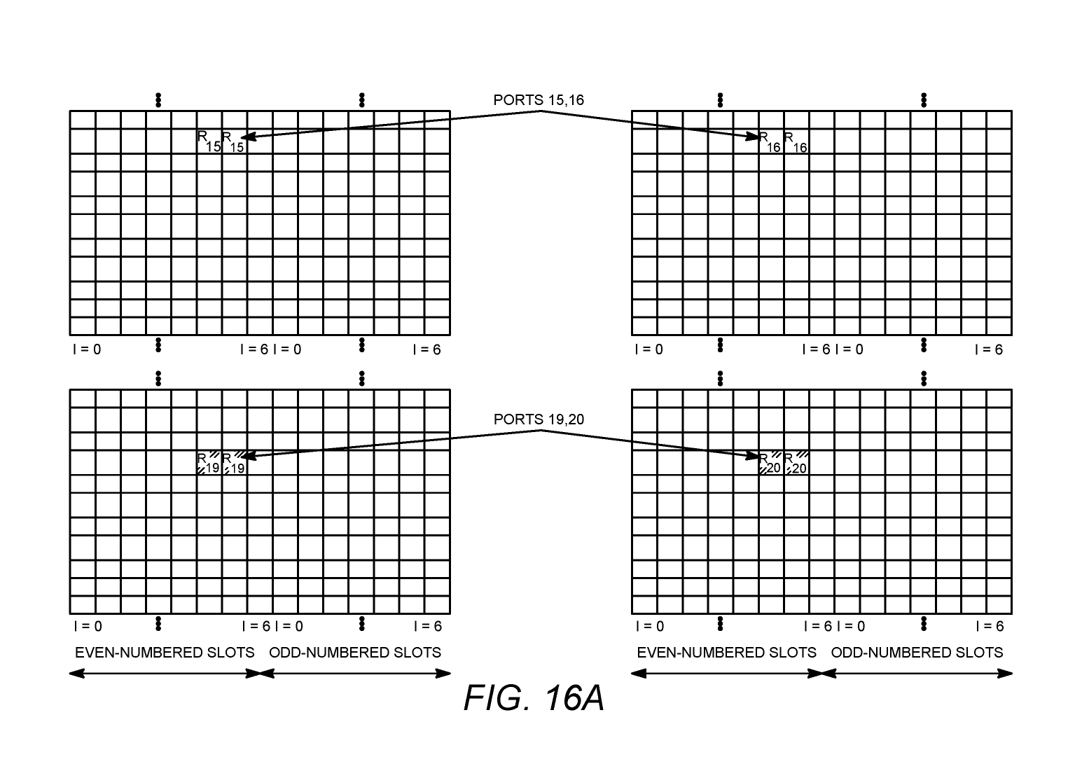

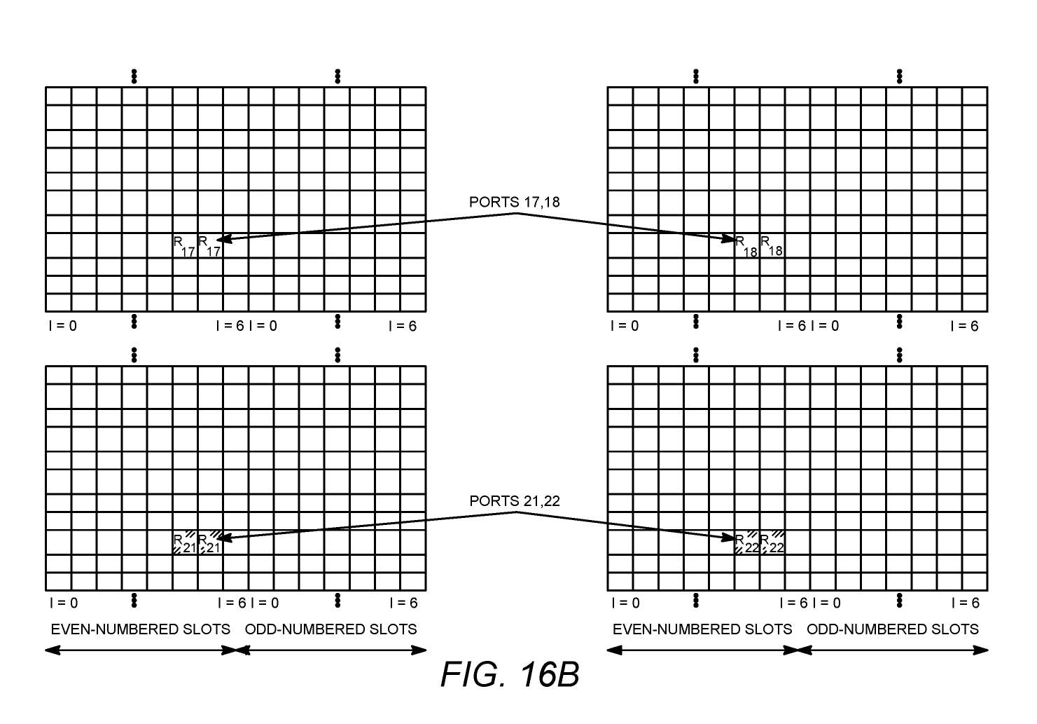

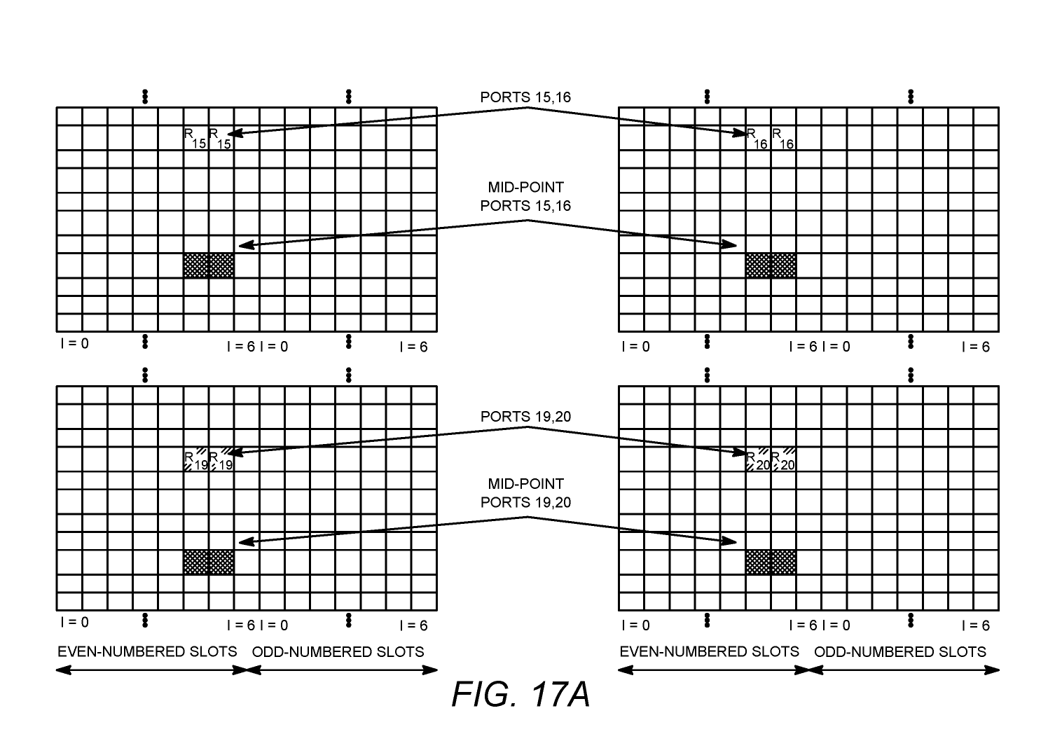

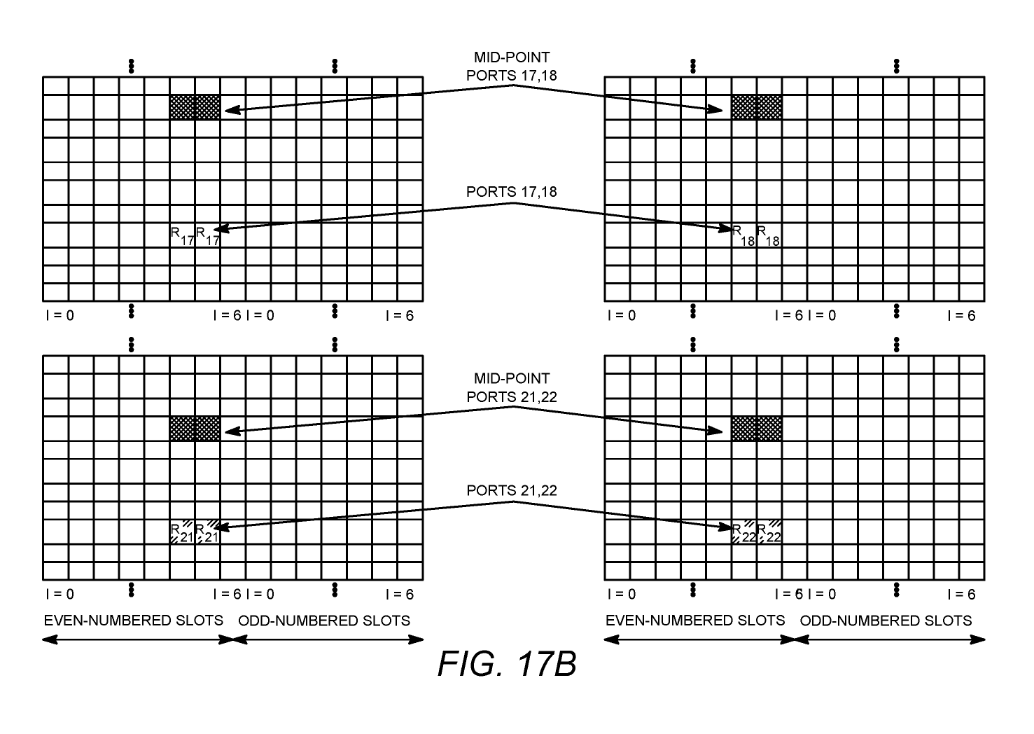

FIGS. 16A and 16B are diagrams depicting an example CSI-RS structure for Config 0 and normal CP. CSI-RS for each port may be transmitted on 2 symbols per sub-frame separated by 12 sub-carriers. For CSI-RS, the mid-point RE may be located in between 2 CSI-RS REs of the same port. FIGS. 17A and 17B are diagrams depicting an example CSI-RS structure with Mid-point REs for Config 0 and normal CP.

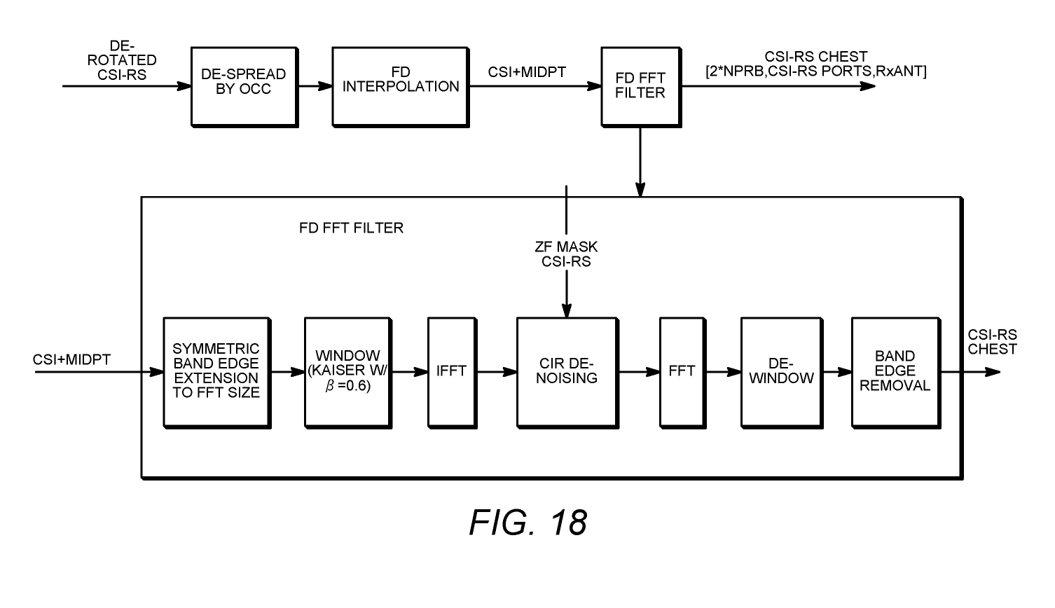

FIG. 18 is a block diagram depicting an example CSI-RS CHEST processing chain. A CSI-RS CHEST may receive one or more de-rotated CSI-RS symbols from an OFDM processor. The CSI-RS CHEST may include De-spread by OCC, FD Mid-point interpolation, and/or FFT Filtering. The output of the CSI-RS CHEST may be filtered Channel Estimates. The filtered channel estimates may represent 2 SCs, CSI-RS and/or Mid-point per PRB in a sub-frame that CSI-RS is present.

The CSI-RS CHEST may receive one or more inputs. The one or more CSI-RS CHEST inputs may include Ofdmp_csirs. The Ofdmp_csirs may include one or more de-rotated CSI-RS symbols from a OFDM processor. The Ofdmp_csirs may be received per RS symbol and/or per Tx-Rx pair. The one or more CSI-RS CHEST inputs may include Ofdmp_csirs_valid. The Ofdmp_csirs_valid may indicate which CSI-RS ports that the CSI-RS input is associated with. The Ofdmp_csirs_valid may include 4 example values. A value of −1 may indicate that the output is not valid. A value of 0 may indicate CSI-RS ports 15/16. A value of 1 may indicate CSI-RS ports 15/16 and 17/18. A value of 2 may indicate CSI-RS ports 15/16, 17/18, 19/20 and 21/22. The Ofdmp_csirs_valid input may be received from the OFDM processor at symbol rate. The one or more CSI-RS CHEST inputs may include ZF Mask for CSI-RS. The ZF Mask for CSI-RS may include a ZF Mask for FFT Filtering. The ZF Mask for CSI-RS may be received from a ZF Mask per RS symbol. The ZF Mask for CSI-RS may be updated once per radio frame (e.g., 10 ms).

The CSI_RS CHEST may include one or more parameters. The one or more CSI_RS CHEST parameters may include system bandwidth, NR, and/or N_{CP}.

The CSI RS CHEST may output csirs_chest_out. The csirs_chest_out may include channel estimates for CSI-RS and mid-point SCs. Two csirs_chest_out may be provided per PRB for the entire system BW. The csirs_chest_out may be output on symbol 2 in CSI-RS enabled sub-frames.

De-spreading may be performed in CSI-RS CHEST. When more than 1 CSI-RS port is transmitted, a pair of ports may be transmitted on the same REs using orthogonal covering codes (OCC). The pair of ports may be de-spread and may be separated. The OCC may be applied on the 2 RSs in a PRB on adjacent symbols. The OCC for CSI-RS ports may be based on the ports per the examples of Table 30.

TABLE 30
Example OCC for CSI-RS

| Port Index | OCC |
|---|---|
| 15, 17, 19, 21 | [1, 1] |
| 16, 18, 20, 22 | [1, −1] |

The de-spreading may be based on the port index. For example, the de-spreading may be performed by adding or subtracting the adjacent de-rotated CSI-RS symbols. The de-spreading may separate overlapping ports. De-spreading may result in one channel estimate per PRB per CSI-RS port-Rx pair (e.g., in every SF CSI-RS is present). The number of channel estimates in frequency may be based on the System BW. The number of channel estimates may be represented by N_{CSI-RS} and equal to the number of PRBs in the entire BW as per the example of Table 31.

TABLE 31
Example N_{CSI-RS}

| System BW | |
|---|---|
| (MHz) | N_{CSI-RS} |
| 1.4 | 6 |
| 3 | 15 |
| 5 | 25 |
| 10 | 50 |
| 15 | 75 |
| 20 | 100 |

Frequency Domain Mid-point Interpolation may be performed in CSI-RS CHEST. After de-spreading, channel estimates may be determined for all ports at the SCs they are transmitted on. When there are 4 or more CSI-RS ports, the estimates for different ports may not be co-located. FD mid-point interpolation may enable channel estimates from co-located REs (e.g., for all ports). The FD mid-point interpolation for CSI-RS CHEST may be similar to and/or the same as that for CRS as described herein. The FD Mid-point for CSI-RS may be determined using a 4 tap sinc interpolation filter.

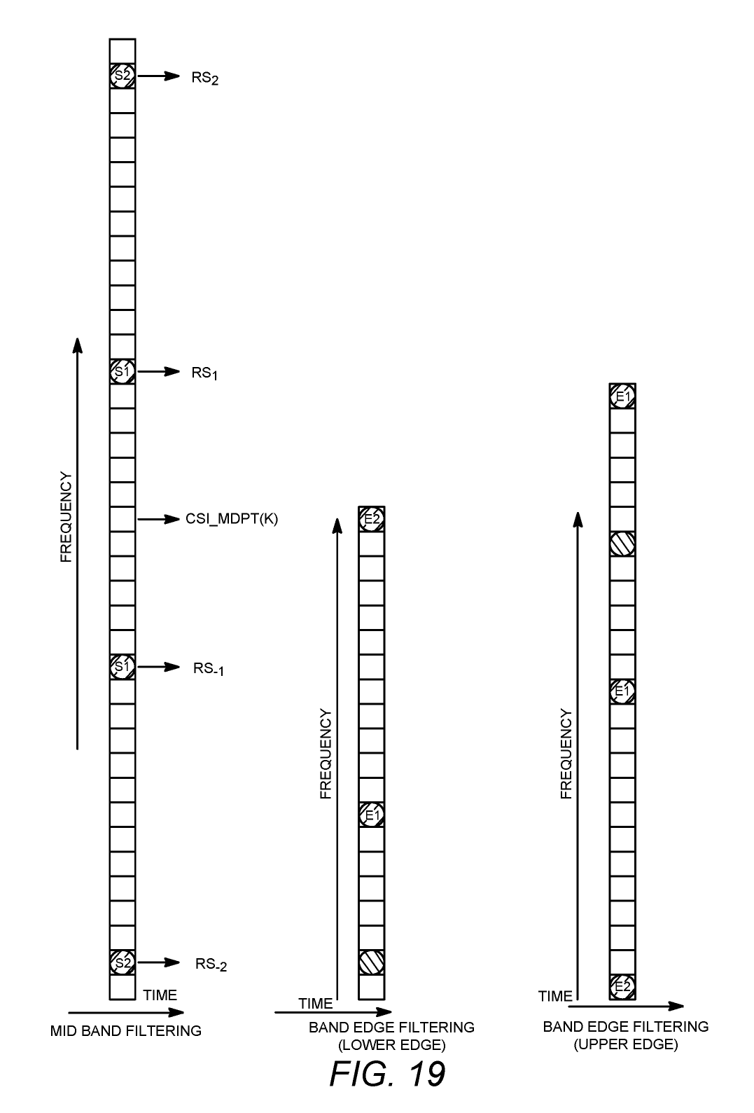

FIG. 19 is a diagram depicting an example CSI-RS FD Mid-point Calculation. The FD mid-point may be determined using 4 RSs (e.g., 2 on either side of the mid-point). Special handling may be useful at band edges. At band edges, 2 RS might not be available on either side for filtering. The filter tap coefficients may be pre-computed and stored. The taps for the filter may be symmetric. Three (3) coefficients may be stored for the mid-band. Three (3) sets of coefficients for the band edges may be pre-computed and stored.

The FD mid-point for each sub-carrier k may be calculated for the mid-band as follows,

$$csirs\_mdpt ( k ) = {\sum }_{i = 1}^{2} {S}_{i} * ( {RS}_{i} + {RS}_{- i} )$$

For the band-edges, the missing RSs into the 6 tap filter may be input as zero. The coefficients may be determined to account for the missing RSs. The filter coefficients may be represented per the examples of Table 6.

Perhaps for example depending on the CSI-RS config and/or port processing, one (e.g., only one) of the band edges may use FIR Filter BandEdge1. The FD mid-point per symbol may be represented by a vector of N_{CSI}_{_}_{RS} REs. The mid-point estimates may be interleaved with the channels estimated at CSI-RS REs to output a vector of 2*N_{CSI}_{_}_{RS} REs per symbol.

FFT Filtering may be performed in CSI-RS CHEST. The CSI-RS and Mid-point Channel estimates may be filtered in the time domain (e.g., to achieve further noise suppression). FFT Filtering in CSI-RS CHEST may include Band-Edge Extension and Windowing, IFFT, FFT Filtering, FFT, Band Edge Removal and De-Windowing.

Band Edge Extension and Windowing may be performed in CSI-RS CHEST. Prior to taking the IFFT of the per RS symbol on the CSIRS+Mid-point SCs, the CSIRS+Mid-point vector may be extended (e.g., symmetrically) to the IFFT length. A first and a last SC of the CSIRS+Mid-point vector may be repeated in either direction (e.g., to extend the input to the IFFT size). The number of repetitions may be based on the system BW per the example of Table 32.

TABLE 32
Example Band Edge Extension size for CSI-RS

| System BW | CSIRS + MdPt | IFFT Size | |
|---|---|---|---|
| (MHz) | 2*N_{CSI-RS} | (nfft) | Nₑₓₜ |
| 1.4 | 12 | 16 | 2 |
| 3 | 24 | 32 | 4 |
| 5 | 60 | 64 | 2 |
| 10 | 100 | 128 | 14 |
| 15 | 200 | 256 | 28 |
| 20 | 200 | 256 | 28 |

Next may represent a number of repetitions for the first and last SC of the input CRS+Mid-point vector. A window may be applied after symmetric band edge extension. The window may reduce the ripples in the CIR after IFFT. The window may reduce ripples in the transform domain by smoothing out the boundary transitions. The window may include a Kaiser window with β=6. The window length may equal an IFFT length. The window may be symmetric. Half of the window coefficients may be stored (e.g., because the window is symmetric). The coefficients may be pre-computed and/or stored in SW and/or programmed to HW perhaps for example based on the system BW. These coefficients may include a 1/sqrt(2) scaling, perhaps for example to compensate for scale factor from de-rotation of CRS in the OFDM processor. Table 33 illustrates examples of Window Coefficients for CSI-RS.

Example Matlab Code for generating window coefficients:

window=kaiser(nfft,6)/sqrt(2);

TABLE 33
Examples of Window Coefficients for CSI-RS

| | IFFT | |
|---|---|---|
| System | Size | |
| BW (MHz) | (nfft) | 1^{st} half window coefficients |
| 1.4 | 16 | [0.0149 0.0722 0.1800 0.3390 0.5334 0.7319 0.8954 0.9879] |
| 3 | 32 | [0.0149 0.0369 0.0696 0.1142 0.1714 0.2410 0.3217 0.4115 |
| | | 0.5073 0.6053 0.7012 0.7904 0.8683 0.9309 0.9746 0.9972] |
| 5 | 64 | [0.0149 0.0245 0.0365 0.0511 0.0684 0.0886 0.1118 0.1381 |
| | | 0.1674 0.1998 0.2350 0.2730 0.3136 0.3564 0.4011 0.4475 |
| | | 0.4949 0.5430 0.5913 0.6393 0.6863 0.7319 0.7755 0.8165 |
| | | 0.8545 0.8890 0.9194 0.9454 0.9667 0.9829 0.9938 0.9993] |
| 10 | 128 | [0.0149 0.0194 0.0244 0.0300 0.0363 0.0432 0.0507 0.0589 |
| | | 0.0678 0.0774 0.0878 0.0988 0.1107 0.1233 0.1366 0.1507 |
| | | 0.1655 0.1811 0.1974 0.2144 0.2322 0.2506 0.2696 0.2893 |
| | | 0.3097 0.3305 0.3519 0.3738 0.3961 0.4188 0.4419 0.4653 |
| | | 0.4889 0.5127 0.5366 0.5605 0.5845 0.6084 0.6321 0.6557 |
| | | 0.6790 0.7019 0.7245 0.7466 0.7681 0.7891 0.8093 0.8289 |
| | | 0.8476 0.8655 0.8825 0.8985 0.9135 0.9275 0.9403 0.9520 |
| | | 0.9624 0.9717 0.9796 0.9863 0.9917 0.9958 0.9985 0.9998] |
| 15, 20 | 256 | [0.0149 0.0170 0.0193 0.0218 0.0244 0.0271 0.0300 0.0330 |
| | | 0.0362 0.0395 0.0430 0.0467 0.0505 0.0545 0.0587 0.0630 |
| | | 0.0675 0.0722 0.0771 0.0821 0.0873 0.0928 0.0984 0.1041 |
| | | 0.1101 0.1163 0.1226 0.1291 0.1358 0.1427 0.1498 0.1571 |
| | | 0.1646 0.1722 0.1800 0.1880 0.1962 0.2046 0.2131 0.2218 |
| | | 0.2307 0.2398 0.2490 0.2584 0.2680 0.2777 0.2875 0.2976 |
| | | 0.3077 0.3180 0.3285 0.3390 0.3497 0.3605 0.3715 0.3825 |
| | | 0.3937 0.4049 0.4162 0.4277 0.4392 0.4508 0.4624 0.4741 |
| | | 0.4859 0.4977 0.5096 0.5215 0.5334 0.5453 0.5572 0.5692 |
| | | 0.5811 0.5930 0.6049 0.6168 0.6286 0.6404 0.6521 0.6638 |
| | | 0.6753 0.6868 0.6983 0.7096 0.7208 0.7319 0.7429 0.7537 |
| | | 0.7644 0.7750 0.7854 0.7956 0.8057 0.8156 0.8253 0.8348 |
| | | 0.8442 0.8533 0.8621 0.8708 0.8792 0.8874 0.8954 0.9031 |
| | | 0.9106 0.9177 0.9247 0.9313 0.9377 0.9437 0.9495 0.9550 |
| | | 0.9602 0.9651 0.9697 0.9740 0.9779 0.9816 0.9849 0.9879 |
| | | 0.9906 0.9929 0.9949 0.9966 0.9979 0.9989 0.9996 1.0000] |

An inverse of the CSI-RS window coefficients may be stored. The inverse of the CSI-RS window coefficients may be used in de-windowing.

Inverse FFT may be performed in CSI-RS CHEST. The CIR may be determined based on the IFFT of the CSIRS+Mid-point after band extension and/or windowing.

FFT Filtering may be performed in CSI-RS CHEST. FFT filtering may include noise suppression. Noise suppression may be achieved by zeroing out the non-signal region of the CIR. The ZF Mask for CSI-RS may be applied on the CIR based on CSI-RS samples. The ZF Mask for CSI-RS may be applied to suppress the noise. The ZF mask application may include a point-wise multiplication of the CIR with the ZF Mask.

The FFT of the filtered CIR may be performed (e.g., to bring it back to the frequency domain for per SC Channel estimate).

Band Edge Removal and De-Windowing may be performed in CSI-RS CHEST. The reverse of the windowing and/or band edge extension processing may be performed. The de-windowing and/or band edge removal in CSI-RS CHEST may remove the effect of the window on the final Channel Estimates and/or may bring it back to the CSIRS+Mid-pt SC. Band edge removal may include discarding one or more SCs from the band-edges (for example, the extra SCs added on the band-edges to extend to IFFT length). The inverse of the window coefficients may be computed and/or stored per system BW and/or applied, perhaps for example after band-edge removal. Similar to the window, some (e.g., only half) of the CSI-RS window coefficients may be stored for de-windowing (e.g., since the window is symmetric).

In wireless communication designs, the Layer 1 Feedback (L1FB) component generates and/or formats L1 feedback (including Channel Quality Indicator (CQI), Precoding Matrix Indicator (PMI) and/or Rank Indicator (RI)) which Tx TTI may transmit back to the network within a specified time. The L1FB may facilitate adaptive modulation and/or coding (AMC) and/or rank adaptation, perhaps for example so that data rate may be maximized. Of the three variables, RI, PMI and/or CQI, one or more of which may be jointly determined to achieve the maximum throughput by (for example, exhaustively) examining one or more, or all, possible hypotheses. This may require examining a large number of hypotheses. This may require a large number of divide operations.

Design requirements for a Layer 1 (L1) Feedback component for a LTE communication device (e.g., a LTE modem) are described. The interfaces defined may be intended to define information flow.

Some of the definitions and abbreviations of 3GPP terms used herein can be found in TR 21.905, Vocabulary for 3GPP Specifications. Other abbreviations referred to herein:
AGC Automatic Gain Control
CDD Cyclic Delay Diversity
CQI Channel Quality Indicator
CP Cyclic Prefix
DMA Direct Memory Access
EESINR Exponential Effective Signal to Noise and Interference Ratio
HARQ Hybrid Automatic Repeat Request
OFDM Orthogonal Frequency Division Multiplexing
PCFICH Physical Control Format Indicator Channel
PDCCH Physical Downlink Control Channel
PDSCH Physical Downlink Shared Channel
PMI Precoding Matrix Indicator
PUCCH Physical Uplink Control Channel
PUSCH Physical Uplink Shared Channel
RAM Random Access Memory
RI Rank Indicator

The Layer 1 Feedback (L1FB) component may generate and/or format L1 feedback (including CQI, PMI and/or RI) in which Tx TTI may transmit back to eNodeB within a specified time. This may facilitate adaptive modulation and/or coding (AMC) and/or rank adaptation, perhaps for example so that data rate may be maximized.

The L1FB component may perform one or more of the following functions: Signal to Noise and Interference Ratio (SINR) calculation, PMI and/or RI generation, sub-band selection for WTRU selected CQI feedback mode, and/or CQI generation.

Perhaps for example for a low-cost (LC) Machine-Type Communications (MTC) modem (WTRU cat. 0), one or more layers, or only one layer, may be supported. In one or more techniques. RI and/or Large-Delay CDD might not be supported.

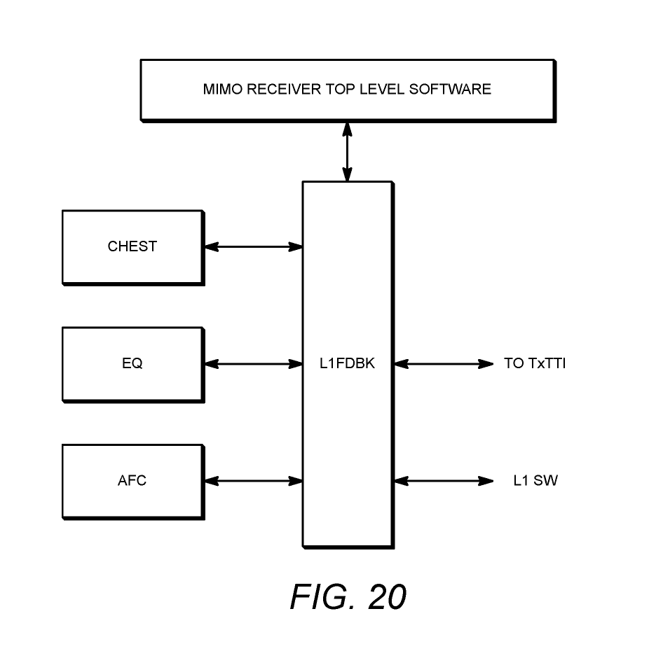

The L1FB component may be part of the MIMO Receiver component. It may interface with the Chanel Estimation (CHEST), Equalizer (EQ), Automatic Frequency Control (AFC), and/or Slicers (for example, part of EQ, an operational block which may be used to determine which symbol is received), Tx TTI, and/or L1SW. An example depiction of L1FB in the overall architecture is shown in FIG. 20.

One or more modes of operation are contemplated. Techniques and/or components may support one or more, or all, transmission modes and/or CQI reporting modes specified by 3GPP TS 36.213, for example, among others. Example transmission modes and feedback modes are listed in Table 34 and Table 35.

TABLE 34
Example Transmission Modes

| Transmission Mode | Comments |
|---|---|
| Mode 1: Single antenna port | Port 0 |
| Mode 2: Transmit diversity | SFBC, rank-1, can be dynamically |
| | switched to open-loop spatial |
| | multiplexing. |
| Mode 3: Open-loop spatial | Large delay CDD, only rank = |
| multiplexing * | {2, 3, 4} is supported. |
| Mode 4: Closed-loop spatial | Rank-1 and 2 are supported. Rank |
| multiplexing * | can be dynamically adapted. |
| Mode 5: Multi-User MIMO * | Details not included. |
| Mode 6: Closed-loop rank-1 | Details not included. |
| precoding * | |
| Mode 7: Single antenna port | If PBCH #ant_port = 1 uses port 0, |
| (DM-RS) | otherwise *; |
| | Or port 5; |
| Mode 8: Dual layer | If PBCH #ant_port = 1 uses port 0, |
| transmission (DM-RS) Rel. | otherwise *; |
| 9+ | Or Single/dual port 7-8 ; |
| Mode 9: Up to 8 layer | If PBCH #port = 1, port 0 otherwise * |
| transmission (DM-RS) Rel. | (non-MBSFN); |
| 10+ | Port 7 (for MBSFN); |
| | Or Single port7 or 8/up to 8 layer |
| | ports 7-14; |
| Mode 10: Up to 8 layer | If PBCH #port=1, port 0 otherwise * |
| transmission (DM-RS) | (non-MBSFN); |
| | Port 7 (for MBSFN); |
| | Or Single port7 or 8/up to 8 layer |
| | ports 7-14; |

* May be dynamically switched to transmit diversity

PUCCH based feedback may be transmitted periodically. PUSCH based feedback may be transmitted aperiodically. The feedback mode X-Y may be defined (for example, jointly) by CQI feedback type X and/or PMI feedback type Y, where X=1, 2, 3 denote wideband CQI, WTRU selected subband CQI and/or higher layer configured subband CQI, respectively. Y=0, 1, 2 may represent no PMI (open loop), single PMI, and/or multiple PMI, respectively. Mode 2-0 feedback may be transmitted on PUSCH and/or PUCCH.

For power saving, for example, among other reasons, this component may also be aware of DRX mode. RRC signaling may be used to define the type of reporting to use at the WTRU.

Possible combinations of Tx modes and CSI Feedback modes are listed in Table 35. In some techniques, wideband-only CQI and/or WTRU-selected Sub-bands CQI reports may be supported for PUCCH.

TABLE 35
Summary of example PDSCH Transmission
modes and Feedback modes

| | CSI type (PUSCH/aperiodic) | | |
|---|---|---|---|
| | Wideband | UE-selected | eNB-configured |
| Tx Mode | only CQI | Sub-bands CQI | Sub-bands CQI |
| Mode 1 | | 2-0 | 3-0 |
| Mode 2 | | 2-0 | 3-0 |
| Mode 3 | | 2-0 | 3-0 |
| Mode 4 | 1-2 | 2-2 | 3-1 |
| (PMI/RI) | | | 3-2 |
| Mode 5 | | | 3-1 |
| Mode 6 | 1-2 | 2-2 | 3-1 |
| (PMI) | | | 3-2 |
| Mode 7 | | 2-0 | 3-0 |
| Mode 8a | 1-2 | 2-2 | 3-1 |
| | | | 3-2 |
| Mode 8b | | 2-0 | 3-0 |
| Mode 9a | 1-2 | 2-2 | 3-1 |
| (PMI/RI) | | | 3-2 |
| Mode 9b | | 2-0 | 3-0 |
| Mode 10a | 1-2 | 2-2 | 3-1 |
| (PMI/RI) | | | 3-2 |
| Mode 10b | | 2-0 | 3-0 |

CSI type (PUCCH/periodic)

| | Wideband | UE-selected |
|---|---|---|
| Tx Mode | only CQI | Sub-bands CQI |
| Mode 1 | 1-0 | 2-0 |
| Mode 2 | 1-0 | 2-0 |
| Mode 3 | 1-0 | 2-0 |
| Mode 4 | 1-1 | 2-1 |
| (PMI/RI) | | |
| Mode 5 | 1-1 | 2-1 |
| Mode 6 | 1-1 | 2-1 |
| (PMI) | | |
| Mode 7 | 1-0 | 2-0 |
| Mode 8a | 1-1 | 2-1 |
| Mode 8b | 1-0 | 2-0 |

| | CSI type (PUSCH/aperiodic) | |
|---|---|---|
| Mode 9a | 1-1 | 2-1 |
| (PMI/RI) | | |
| Mode 9b | 1-0 | 2-0 |
| Mode 10a | 1-1 | 2-1 |
| (PMI/RI) | | |
| Mode 10b | 1-0 | 2-0 |

a: CL-SM,
b: no CL-SM;
Tx Mode X option

For aperiodic reporting, the Wideband (WB) feedback may occur for example when the WTRU reports at least one WB CQI for the whole system BW (NRB) per Code Word. The eNB-configured Sub-band (SB) feedback may occur for example when the WTRU reports at least one WB CQI for the whole system BW (NRB) per Code Word. The WTRU may report a CQI value for one or more, or each, Sub-band, perhaps differentially encoded versus the WB CQI using 2 bits, such as:

SB diff CQI=SB CQI index−WB CQI index

and/or may map to the following example differential CQI values in Table 36.

TABLE 36
Example Mapping differential CQI value to offset level

| Diff CQI value | Offset level |
|---|---|
| 0 | 0 |
| 1 | 2 |
| 2 | >=+2 |
| 3 | >=−1 |

Table 37 lists example sub-band sizes.

TABLE 37
Example Sub-band size (k RBs),
function of the System BW (FDD)

| System BW | Sub-band | |
|---|---|---|
| NRB | size | Specific BW and |
| (RBs) | (k RBs) | corresponds # SB |
| 6-7 | WB only | 1.4 MHz (6 RBs) -> WB only |
| 8-10 | 4 | NA |
| 11-26 | 4 | 3 MHz (15 RBs) -> 4 SBs |
| 27-63 | 6 | 5 MHz (25 RBs) -> 5 SBs |
| | | 10 MHz (50 RBs) -> 9 SBs |
| 64-110 | 8 | 15 MHz (75 RBs) -> 10 SBs |
| | | 20 MHz (100 RBs) -> 13 SBs |

For aperiodic reporting, WTRU-selected Sub-bands may occur for example when the WTRU reports at least one WB CQI for the whole system BW (NRB) per Code Word. The UE may report at least one CQI value that may reflect the average quality of the M selected sub-bands. This value may be differentially encoded versus the WB CQI using 2 bits, such:

diff CQI offset level=Averaged of M preferred selected SB CQI index−WB CQI index

and/or may map to the following differential CQI values in Table 38.

TABLE 38
Example mapping differential CQI value to offset level

| Diff CQI value | Offset level |
|---|---|
| 0 | <=1 |
| 1 | 2 |
| 2 | 3 |
| 3 | >=4 |

The WTRU may select a set of M sub-bands of size k defined below in Table 39.

TABLE 39
Example M preferred Sub-bands and sizes
(k RBs), function of the System BW (FDD)

| | | Number of | |
|---|---|---|---|
| System BW | Sub-band | preferred | Specific BW and |
| NRB | size | sub-bands | corresponding # |
| (RBs) | (k RBs) | (M) | SB (N) |
| 6-7 | WB only | WB only | 1.4 MHz (6 RBs) -> WB only |
| 8-10 | 2 | 1 | NA |
| 11-26 | 2 | 3 | 3 MHz (15 RBs) -> selecting |
| | | | 3 out of 8 SBs |
| 27-63 | 3 | 5 | 5 MHz (25 RBs) -> selecting |
| | | | 5 out of 9 SBs |
| | | | 10 MHz (50 RBs) -> selecting |
| | | | 5 out of 17 SBs |
| 64-110 | 4 | 6 | 15 MHz (75 RBs) -> selecting |
| | | | 6 out of 19 SBs |
| | | | 20 MHz (100 RBs) -> selecting |
| | | | 6 out of 25 SBs |

The selected M sub-bands may be indicated along with the CQI reports using a combinatorial index r defined as:

$$r = {\sum }_{i = 0}^{M - 1} 〈 \begin{matrix}N - {s}_{i} \\ M - i\end{matrix} 〉$$

where the set {sᵢ}Mᵢ₌₀^{M-1}, 1≦sᵢ≦N, sᵢ<sᵢ₊₁ contains the M sorted sub-band indices among N sub-bands,

$$N = ⌈ {N}_{RB} / k ⌉$$

$$and$$

$$〈 \begin{matrix}n \\ k\end{matrix} 〉 = \{ \begin{matrix}( \begin{matrix}x \\ y\end{matrix} ) & if x \geq y \\ 0 & if x < y\end{matrix}$$

is the extended binomial coefficient, resulting in a unique label

$$r ∈ \{ 0 , … , ( \begin{matrix}N \\ M\end{matrix} ) - 1 \}$$

For periodic reporting, perhaps for example if the eNodeB desires to receive periodic reporting of the CQI, among other scenarios, the WTRU may transmit reports using PUCCH. Perhaps for example, if PUSCH transmission resources are scheduled for the WTRU in one of the periodic subframes, the periodic CQI report may be sent on PUSCH instead.

For periodic reporting, Wideband (WB) feedback may occur when the WTRU reports at least one WB CQI for the whole system BW (NRB) per Code Word perhaps using one or more of the following period: {2, 5, 10, 16, 20, 32, 40, 64, 80, 128, 160} ms, or Off. WTRU-selected Sub-bands may occur when the WTRU reports at least one CQI value for a (for example, single) selected sub-band (size k RBs, N SBs total) from one or more, or each, bandwidth part (J parts total), along with the corresponding L-bit subband index:

L=┌log₂┌N_{RB}/k/J┘┘

Sub-band size (k RBs) and/or number of bandwidth parts (J) may be a function of the System BW as listed in Table 40.

TABLE 40
Example Sub-band size (k RBs) for each J
parts, function of the System BW (FDD)

| | | Number | |
|---|---|---|---|
| System BW | Sub-band | of BW | Number of SB (N) per Part |
| N_{RB} | size | parts | (j), for different system |
| (RBs) | (k RBs) | (J) | BW: ceiling (N_{RB}/k/J) |
| 6-7 | WB only | 1 | 1.4 MHz (6 RBs), WB only |
| 8-10 | 4 | NA | NA |
| 11-26 | 4 | 2 | for 3 MHz (15 RBs): |

N = 2 for all parts

| | | | |
|---|---|---|---|
| 27-63 | 6 | 3 | for 5 MHz (25 RBs): |

N = 2 for parts {0, 1}, N = 1

for part 2 for 10 MHz (50 RBS):

N = 3 for all parts

| | | | |
|---|---|---|---|
| 64-110 | 8 | 4 | for 15 MHz (75 RBs): |

N = 3 for parts {0, 1, 2}, N = 1

for part 3 for 20 MHz (100 RBS):

N = 4 for parts {0, 1, 2}, N = 1

for part 3

Perhaps for example for CQI reporting with Spatial Multiplexing (that might not be applicable to Cat 0 WTRU), in PDSCH transmission modes 3, 4, 8, and/or 9, spatial multiplexing may be used to transmit two codewords (for example, simultaneously) to a WTRU with independently selected modulation and coding schemes (MCSs). To support this, the following example behavior is described for the WTRU's CQI reports. Perhaps for example if there is no RI feedback, and/or if reported RI=1, and/or in any case in Tx mode 3 (Large delay CDD), the WTRU may feedback one CQI report (for example perhaps only one CQI report) corresponding to a codeword (for example a single codeword). Perhaps for example if RI feedback is configured and/or the reported RI>1 in Tx modes 4 or 8: for PUSCH aperiodic CQI reports, one or more, or each, CQI report (for example, wideband and/or sub-band) may comprise one or more, or two, independent CQI reports for the two codewords; and/or for PUCCH periodic CQI reports, one or more CQI report may be fed back for the first codeword, and/or a second three-bit differential CQI report may be fed back for the second codeword (for example wideband and/or sub-band reporting), such as:

CW 1 offset level=CQI index for CW 0−CQI index for CW 1

and/or may map to the following example differential CQI values in Table 41.

TABLE 41
Example Mapping differential CQI value to offset level

| Diff CQI value | Offset level |
|---|---|
| 0 | 0 |
| 1 | 1 |
| 2 | 2 |
| 3 | >=3 |
| 4 | <=−4 |
| 5 | −3 |
| 6 | −2 |
| 7 | −1 |

Techniques contemplate one or more PMI and/or RI reports.

For one or more, or each, CQI reporting modes 1-Y, 2-Y and 3-Y, Y may take values 0, 1 and/or 2 which may indicate no PMI, WB PMI and/or SB PMI, respectively. Cat. 0 WTRU may support (for example may only report) rank=1 (for example, one layer). In such scenarios, among others, no RI reports may be used, and/or layer 1 precoder codebooks (for example, only layer 1 codebooks) may be used for nTx Ports=2, 4 and/or 8. One codeword (CW, for example only one CW) may be used for CQI reports defined herein. Rank >1 and/or associated PMI processing may be provided accordingly.

There may be one or more, for example three, feedback modes (e.g., see Table 35). For example, for Wideband PMI, the WTRU may report a PMI (for example, a single PMI) corresponding to the chosen and/or useful precoder, perhaps for example assuming transmission over the whole system bandwidth. The Wideband PMI mode may be for periodic and/or aperiodic (for example, in conjuncture with WTRU-selected sub-band CQI) reports. For example, for sub-band PMI the WTRU may report one or more PMI for one or more, or each SB across the whole system bandwidth, perhaps for example where the sub-band size, k may be defined in Table 37. The Sub-band PMI mode may be for aperiodically reports in conjunction with a WB CQI and/or eNB-configured Sub-bands CQI reports. The precoder used by the eNodeB may change from sub-band to sub-band. For, WTRU-selected sub-band PMI, the WTRU may select a set of M preferred sub-bands, one or more, or each, of size k RBs, (where M and k may be the same as for WTRU-selected sub-band CQI feedback, see Table 37). The WTRU may report a PMI (for example, a single PMI) corresponding to the chosen and/or useful precoder, perhaps assuming transmission over one or more, or all, of the M selected sub-bands. The WTRU-selected sub-band PMI mode may be for aperiodic report perhaps for example in conjunction with WTRU-selected sub-band CQI reports.

In LTE, CDD may be applied (for example, may only be applied) for Rank >1 for PDSCH transmission. Spatial Multiplexing scheme with Rank=1 using a fix precoding codebook may allow for beamforming, perhaps for example based (for example, may only be based) on cell specific reference signals (CS-RS) (for example, single-user multiple input multiple output (SU-MIMO)). Selection of the best (for example, useful) codeword to use at eNB may be based on feedback using PMI. Higher rank beamforming may feedback a RI and/or may require demodulation reference signals (DM-RS) for improved multi-user multiple input multiple output (MU-MIMO) performance which may remove the constraint on the eNB to use the feedback codebook (for example, perhaps only the feedback codebook).

One or more example Interfaces—Inputs are illustrated in Table 42.

TABLE 42
Example Inputs

| | | Typical | |
|---|---|---|---|
| Input Name | Description | Source | Comment |
| h_rs | H: Channel State | CHEST | TTI rate |
| | Information (CSI) | through | CHEST inputs is used |
| | matrix of OFDM | Equalizer | for PMI generation |
| | reference symbols | | (and antenna gain |
| | of the reference | | estimation) |
| | TTI. | | CHEST information |
| | | | can be CS-RS or CSI- |
| | | | RS based. |
| | | | RS port symbols and |
| | | | corresponding mid- |
| | | | points |
| | | | For PMI estimation |
| eq_rs | Derotated CS-RS | Equalizer | Symbols and mid- |
| | Or | | points |
| | Despread CSI-RS | | CS-RS |
| | | | (ports 0, 1, 2 and 3) |
| | | | OR |
| | | | CSI-RS |
| | | | (ports 15, 16, 17, 18, |
| | | | 19, 20, 21 and 22) |
| l1s_drx | DRX mode | | updated as UE is going |
| | indication | | in and out of DRX. |
| | | | If any portion of the |
| | | | TTI is in DRX, L1 |
| | | | Feedback should not |
| | | | compute any feedback |
| | | | information. |
| l1s_tx_mode | Transmission | L1S | updated semi-statically |
| | mode of operation | | Values: 1 to 10 |
| | | | See Table 34 |
| l1s_fb_mode | L1 Feedback | L1S | updated semi-statically |
| | mode | | Values sets |
| | | | aperiodic/periodic and |
| | | | an X-Y mode. |
| | | | note: X indicates WB, |
| | | | UE-selected |
| | | | Sub-bands or eNb- |
| | | | configured Sub-bands |
| | | | CQI mode |
| l1s_nFrame | System Frame | L1S | Frame rate. |
| | Number | | Used to generate |
| | | | reports |
| l1s_J_M | L1FB UE | L1S | l1s_fb_modes 2-Y |
| | selected sub-band | | for periodic, this is J |
| | parameter, only | | parts; |
| | | | for aperiodic, this is M |
| | | | preferred sub-bands |
| l1s_G_L_Q_O | L1FB report | | for periodic reports |
| | parameters | | |
| l1s_k | L1FB reported | L1S | in RB's, |
| | sub-bands size | | for aperiodic: |
| | (full allocation) | | Table 37 |
| | | | for periodic: |
| | | | Table 39 |
| l1s_Nrb | System | L1S | Updated at call |
| | Bandwidth DL | | initiation |
| | (NRB) | | |
| l1s_nTx | number of | L1S | nTx is either 1, 2, 4 |
| | eNodeB antenna | | or 8 |
| | ports | | |

One or more Interfaces—Outputs are illustrated in Table 43.

TABLE 43
Example Outputs

| Output Name | Description | Comment |
|---|---|---|
| l1fb_cqi | CQI values | Values are 1, 2, . . . 15. |
| | provided to | Dimensions are function of |
| | Tx TTI | l1s_fb_modes: |
| | | 1-Y is [#CW, 1(WB) + N(SB)] |
| | | 2-Y aperiodic is: |
| | | [#CW, 1(WB) + 1(diffMavg)] |
| | | 2-Y periodic is: |
| | | [#CW, 1(WB) + 1(diffMavg)] |
| | | 3-Y [#CW, 1(WB) + N(diffSB)] |
| l1fb_cqi_sb_idx | SB CQI index | For UE selected SB, 2-Y modes: |
| | | for aperiodic this is the r index |
| | | for periodic this is the L-bit index |
| l1fb_pmi | PMI value | Values are: |
| | provided to | for 2 antenna ports: |
| | Tx TTI | {0, 1, 2, 3} (rank-1); |
| | | {1, 2} (rank = 2). |
| | | for 4 antenna ports: |
| | | {0 to 15} |
| | | or |
| | | {0 to 15, 0 to 15} (dual index) with |
| | | alternativeCodeBookEnabledFor4TX- |
| | | r12 = TRUE |
| | | for 8 ports: |
| | | {0 to 15, 0 to 15} (dual index) |
| | | Formats are based on PMI mode: |
| | | [single PMI], WB only; |
| | | [N SBPMI], SB PMI; |
| | | [single UE-selected sub-band |
| | | PMI], UE-selected sub-band |
| | | PMI for M best SBs. |
| l1fb_ri | RI value | Values are 1, 2; |
| | provided | not available for Cat. 0 |
| | to Tx TTI | |
| l1fb_sync | Radio Link | Indicate IN-SYNC and OOS states |
| | state | |
| l1fb_ph_comp | Phase | To be applied to PDSCH symbols |
| | compensation | out of Equalizer |
| l1fb_sinr | SINR value | This is a WB SINR value |
| | available to | |
| | AFC/CHEST | |

One or more example parameters are illustrated Table 44.

TABLE 44
Example Parameters

| | Description/ | |
|---|---|---|
| | Supported | |
| Parameter | Values | Comments |
| l1s_nRx | Number of | nRx is 1, 2 or 4 Rx |
| | receive | antennas. |
| | antennas | For cat. 0, nRx is |
| | | 1. |
| codebookSubsetRestriction | The bitmap | Bit value of zero |
| | forms the bit | indicates that the |
| | sequence | PMI and RI |
| | | reporting is not |
| | | allowed to |
| | | correspond to |
| | | precoder(s) |
| | | associated with |
| | | the bit |
| alternativeCodeBookEnabledFor4TX- | Impact | TRUE or FALSE |
| r12 | 4/8 ports | |
| | codebooks | |
| | for PMI | |
| | selection | |

In one or more techniques, there may be an assumption that the received interference and/or noise are spatially white.

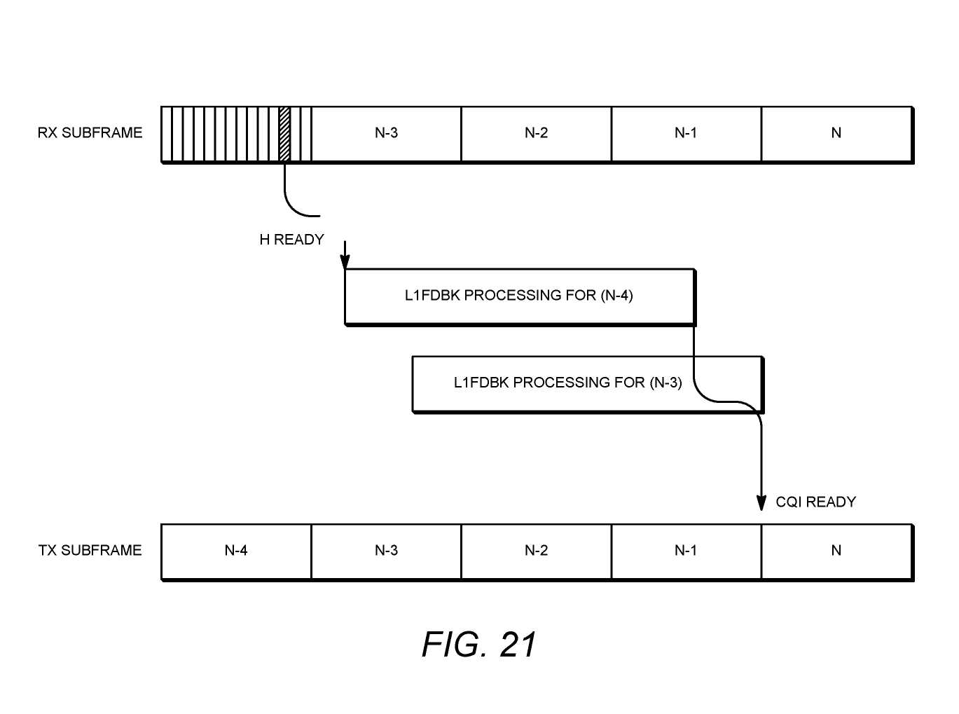

FIG. 21 shows a timeline of the L1 Feedback component in an aperiodic reporting mode for a normal Cyclic Prefix (CP) case. For a CQI that is reported in the n-th Tx sub-frame, the (n−4)-th Rx sub-frame may be used as a reference. Once a downlink scheduling assignment is detected on PDCCH of the (n−4)-th sub-frame t, the L1 Feedback component may take the CHEST output corresponding to OFDM symbols 0 and/or 4 and/or their mid-points for PMI generation and/or the de-rotated CS-RS symbols and/or the de-spread CSI-RS symbols (for corresponding ports {0, 1, 2, 3} and/or {15, 16, 17, 18, 19, 20, 21, 22}) for sub-frames with normal and/or extended CP, respectively.

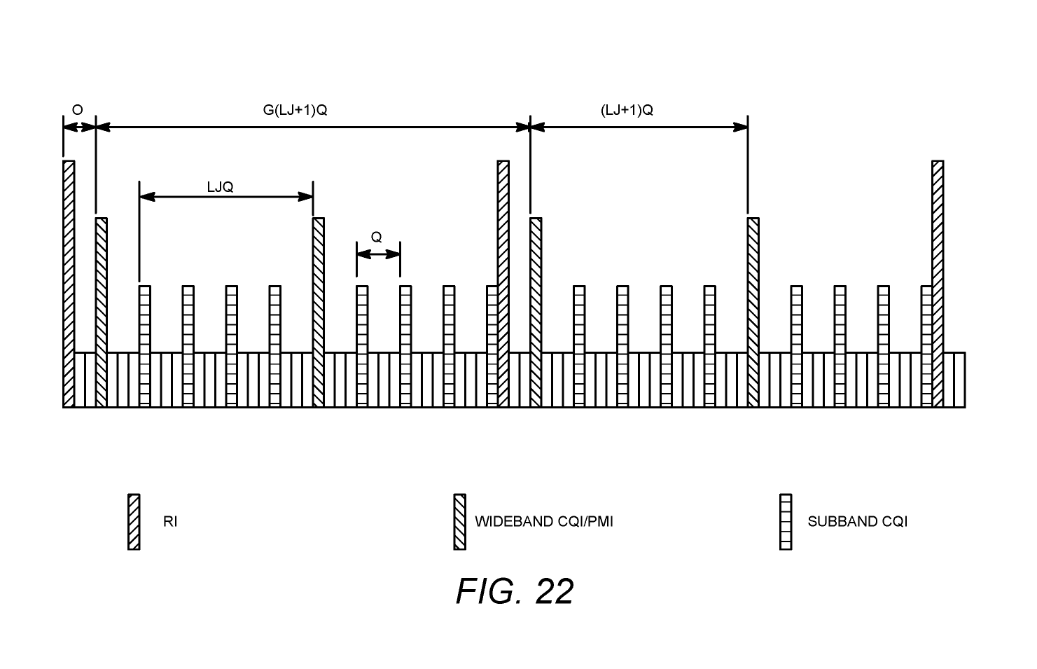

In periodic reporting mode, one or more, for example three, different types of reports may be sent with different periods. Perhaps for example with an assumption that the basic reporting period be Q, the wideband CQI/PMI reporting period may be FQ, where F=J×L+1. Between two wideband CQI/PMI reports, the WTRU may (for example, sequentially) report subband CQI for one or more, or all, bandwidth parts (for example, total J bandwidth parts) L times. The period of RI reporting may be G times that of wideband CQI/PMI reporting. There may be an offset O between RI and wideband CQI/PMI reporting. Parameters G, O, K, Q may be configured by higher layers (e.g., in an RRC message), in a semi-static manner. The parameter J may be determined by the system bandwidth as shown in Table 40. FIG. 22 is an illustration of example periodic CQI reporting. Perhaps when there is a collision between RI and CQI/PMI reporting, the WTRU may report RI, and/or may drop CQI/PMI.

The variable names may be different from those in TS 36.213. For clarity, example variable mapping is summarized below in Table 45.

TABLE 45
Example Variable Mapping

| | | | | | |
|---|---|---|---|---|---|
| Variable name in | G | L | J | Q | O |
| this document | | | | | |
| Variable name in | M_{RI} | K | J | Nₚ | N_{offset}_{_{—}}_{RI} |
| TS 36.213 | | | | | |

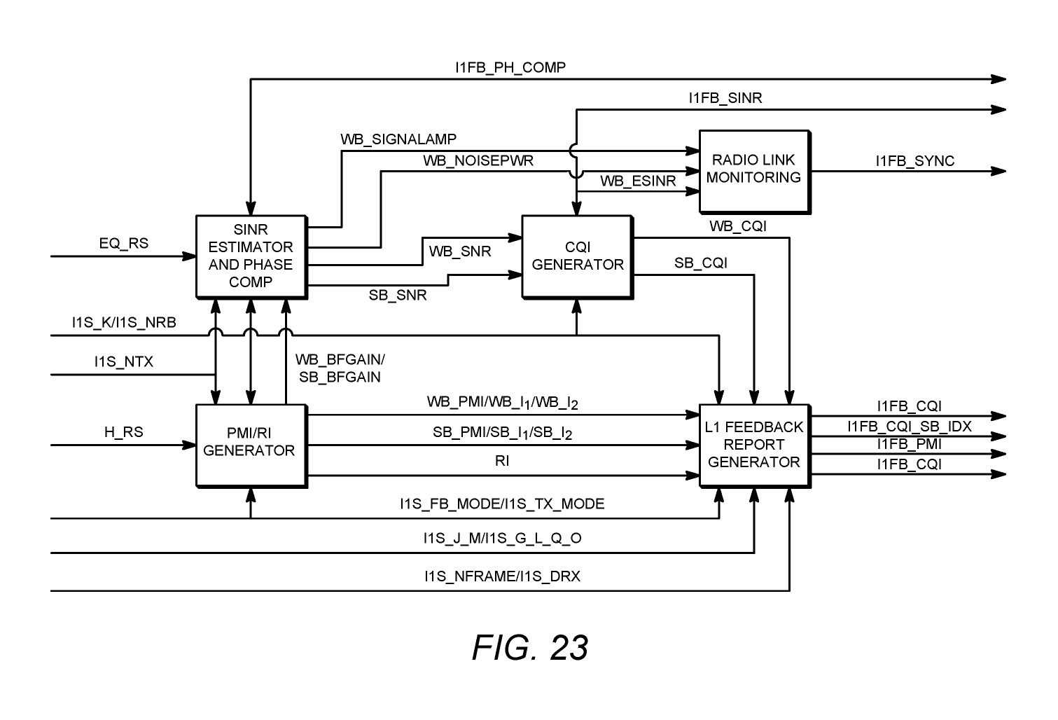

An example top level L1 Feedback algorithm block diagram is depicted in FIG. 23. The algorithm may include one or more of the following functional blocks:

SINR estimator and Phase Comp.: may compute the wideband and/or sub-band SINR's from input reference symbols and/or may provide the phase compensation to be applied to PDSCH by the Slicer.

CQI generator: may map sub-band SINR's to CQI value using EESM.

PMI/RI generator: for Cat.0 UE, PMI may be computed from the beam-forming antenna gains, see the SINR estimator. RI might not be reported as Rank=1 perhaps due to single Rx antenna.

Feedback Reports generator: may select information to report perhaps for example based on Tx Modes and L1FB Mode.

Radio Link Monitor: may report radio link quality.

The SINR estimator may use de-rotated CS-RS symbols and/or de-spread CSI-RS symbols from the Equalizer. One or more of these symbols may be used to estimate a Signal Amplitude estimator and/or a Noise Power estimation. The SINR estimator may output sub-bands SINR estimates to the CQI generator and/or wideband linear signal-to-interference ratio (SIR) measurements for IOS detection and/or channel SIR estimation (for example, outside L1FB).

The number of sub-bands may be computed as:

N_{RB}/k

Signal Amplitude estimation may be computed as:

signal_{amplitude}=EMA(mean(Real(ref_{symbols})),alpha)

The EMA filter may be called (for example, maybe once) per slot per reference symbol. CS-RS symbols 0 and 4 may be used. The EMA filter may be called twice slot-rate. The EMA alpha value may be:

alpha=1/6

And/or the EMA filter may be defined as:

EMA(x,alpha)=alpha*x+(1−alpha)*EMA(x₋₁,alpha)

where alpha=1 for initialization.

The Noise power estimator may be based on the differential between 2 reference symbols within a slot. Avoiding running the EMA filtering over slot boundaries may mitigate introducing noise due to slot varying conditions (e.g., AGC). Perhaps using CS-RS symbols 0 and 4, the Noise power estimator may be defined as:

noise_{power}=EMA(mean(magnitude(ref_{symbol}−ref_{symbol})²)/2,2*alpha)

The EMA filter's alpha may be multiplied by two. This filter may be called once a slot (perhaps for example only once a slot).

SINRs may be reported at slot rate and/or may be defined as:

$$SIN R = \frac{{signal}_{amplitude}^{2}}{{noise}_{power }}$$

Wideband measurements may be made using:

k=1

Perhaps for example to support closed loop spatial multiplexing (CL-SM), among other scenarios, the SINRs may be scaled by the Beamforming (BF) gains computed by the PMI/RI generator described herein such that:

SINR_{wb}=SINRₖ₌₁*wb_bfGain

and

SINR_{sb}_{_{i=SINR}}ₖ₌ᵢ*Sb_{bfGain(i)}

where i=1 to k, for k>1.

Phase compensation may be used for one or more PDSCH symbols that are output from the Equalizer. There may be some phase offset between the channel estimates and/or the input to the Equalizer perhaps for example due to time varying group delay through the filtering in the CHEST. Estimation on the phase compensation to be applied by the Slicer to the PDSCH symbols and/or output it as L1FB_PH_COMP may be computed as described herein.

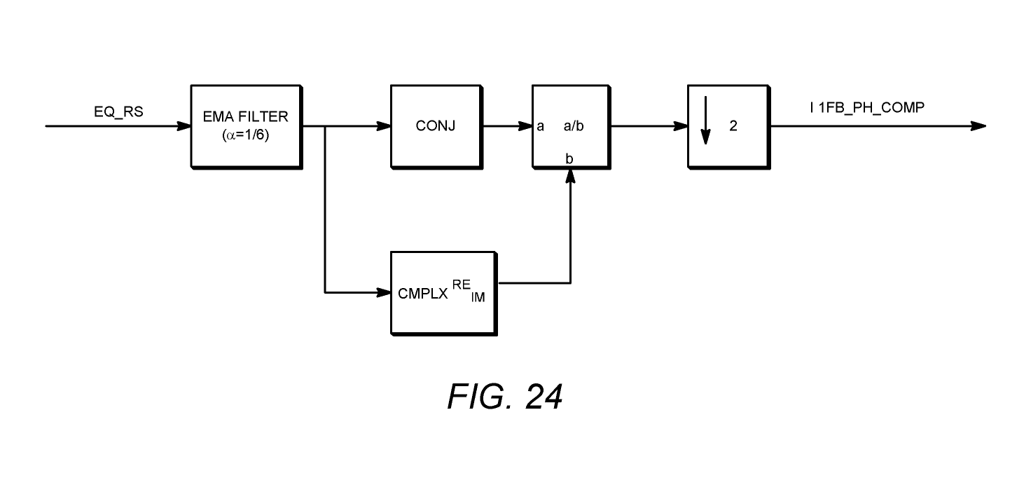

The phase compensation may be computed by using the Reference Symbols from the Equalizer (CS-RS and/or CSI-RS). The Reference Symbols may be averaged with a 1-pole infinite impulse response (IIR) filter (EMA filter). The phase correction may be computed as follows and as illustrated in FIG. 24:

$$l1fb\_ph \_comp = \frac{conj ( filtered\_rf \_symb )}{mag ( filtered\_rf \_symb )} ≅ \frac{conj ( filtered\_rf \_symb )}{real ( filtered\_rf \_symb )}$$

The alpha value may be aligned to the SINR computation perhaps for example assuming reference symbols and/or mid-points input rate and/or the phase compensation is outputted one or more, or every, subframe (TTI rate), for example.

The CQI generator may use the wide-band and/or sub-bands SINR outputs to map CQI values. The CQI may be fed-back to the eNodeB perhaps as an indicator of the channel quality and/or to enable AMC.

A vector of post-detection SINRs for one or more, or each, codeword (CW) in wideband CQI mode. Multiple such vectors for sub-band CQI modes may be generated. N_{SB} is the number of sub-bands. Wideband SINR for one CW is SINR_{WB} and the corresponding sub-band SINRs are the vector SINR_{SB}. The SINR sequence may be mapped into a scalar value (CQI). This mapping approach may be called effective SINR mapping (EESM).

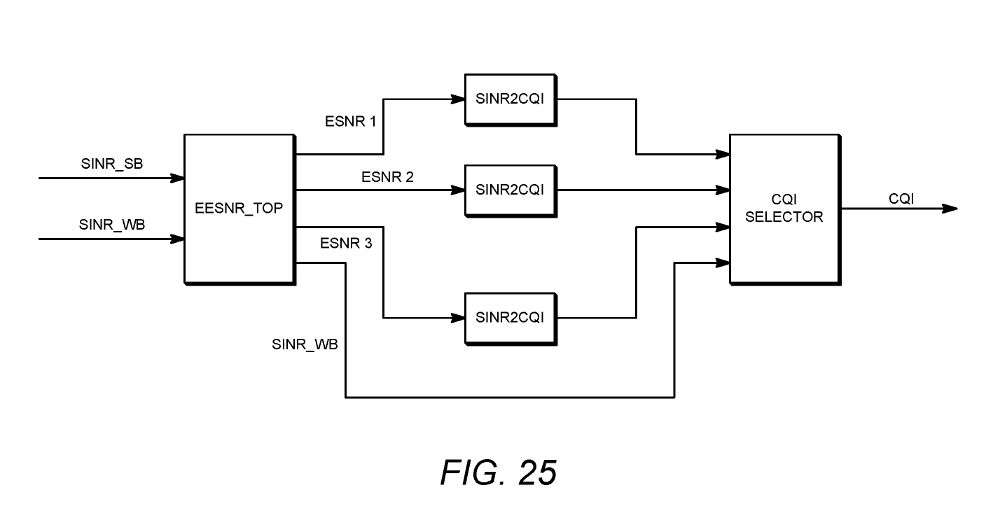

An example top level block diagram of the SINR to CQI mapper is depicted in FIG. 25. At least three interim effective SINR (ESINR) values may be calculated using three different β values, one or more, or each, corresponding to a different MCS level {cqiᵢₙᵢₜ₋₂, cqiᵢₙᵢₜ₋₁, cqiᵢₙᵢₜ}. The at least three ESINR's may be mapped by SINR2CQI block to three interim CQI indices perhaps for example based on a linear SINR to CQI mapping, out of which the final CQI may be selected. The β values used to calculate interim ESINR values may be determined by the SINR_{WB} as described herein.

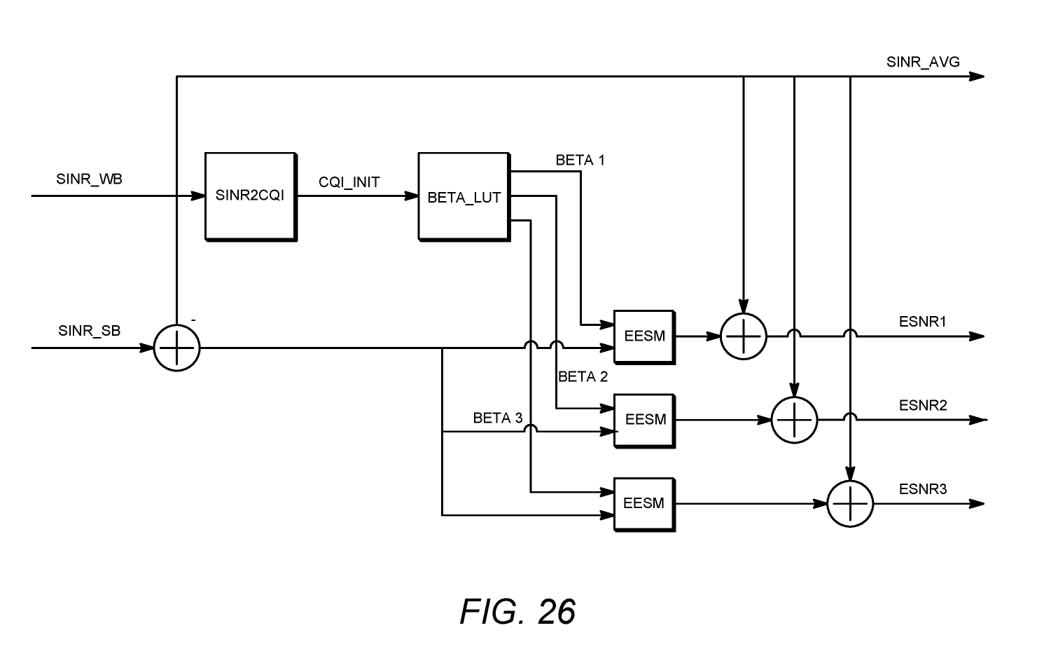

An example top level diagram of exponential effective SINR mapping (EESM) is shown in FIG. 26. The linear average of the SINR sequence may be calculated for one or more, or each layer, and/or across the appropriate bandwidth (SINR_{WB} and SINR_{SB}, per CW). An initial CQI index (CQIᵢₙᵢₜ) may be determined by the linear average (SINR_{WB}) with following SINR2CQI mapping:

$$CQI = \{ \begin{matrix}1 \\ 1 < floor ( 0.5 * 10 {log}_{10} SIN R + 4.7 ) < 15 \\ 15\end{matrix}$$

CQIᵢₙᵢₜ₋₁ and CQIᵢₙᵢₜₗ₋₂ are also defined as CQIᵢₙᵢₜ−1 and CQIᵢₙᵢₜ−2, respectively.

For one or more, or each, code word (CW), the three (3) ESNR's may be computed as:

$${ESNR}_{i} = {SINR}_{WB} - {β}_{i} log ( \frac{{Σ}_{j = 1}^{{N}_{SB}} {e}^{( {SNR}_{{Diff}_{j}} / {β}_{i} )}}{{N}_{SB}} )$$

$$where$$

$${SNR}_{{Diff}_{j}} = {SINR}_{{SB}_{j}} - {SINR}_{WB}$$

and βᵢ for one or more, or each {cqiᵢₙᵢₜ, cqiᵢₙᵢₜ₋₁, cqiᵢₙᵢₜ₋₂} element is defined in Table 46. One or more, or each {cqiᵢₙᵢₜ, cqiᵢₙᵢₜ₋₁, cqiᵢₙᵢₜ₋₂} element may correspond to {ESNR₁, ESNR₂, ESNR₃}, respectively.

TABLE 46
Example CQI/β Reference Table

| CQIᵢ | βᵢ |
|---|---|
| 1 | 1.00 |
| 2 | 1.42 |
| 3 | 1.38 |
| 4 | 1.36 |
| 5 | 1.41 |
| 6 | 1.44 |
| 7 | 1.52 |
| 8 | 2.58 |
| 9 | 3.43 |
| 10 | 4.37 |
| 11 | 5.07 |
| 12 | 9.21 |
| 13 | 12.91 |
| 14 | 16.68 |
| 15 | 20.17 |

The final CQI may be selected from one or more, or for example, three indices {cqiᵢₙᵢₜ, cqiᵢₙᵢₜ₋₁, cqiᵢₙᵢₜ₋₂}. The exponential effective SINR may (for example, may always) be less than or equal to the linear average. During CQI evaluation, CQI indices (for example, only CQI indices) that are less than or equal to cqiᵢₙᵢₜ may be considered as candidates. Simulation results indicate that at least two additional indices may perform well. FIG. 26 shows the whole ESNR mapping process described herein.

For one or more, or all, transmission modes perhaps except for a large delay CDD (tx_mode=3), the ESINR may be calculated for one or more, or each, CW. For large delay CDD mode, one or more, or each, CW may go through one or more, or all, layers. In such scenarios, among others, the ESINR may be the average of both layers, which may be approximated as:

$${ESNR}_{cdd} \approx \frac{{ESNR}_{CW 1} + {ESNR}_{CW 2}}{2}$$

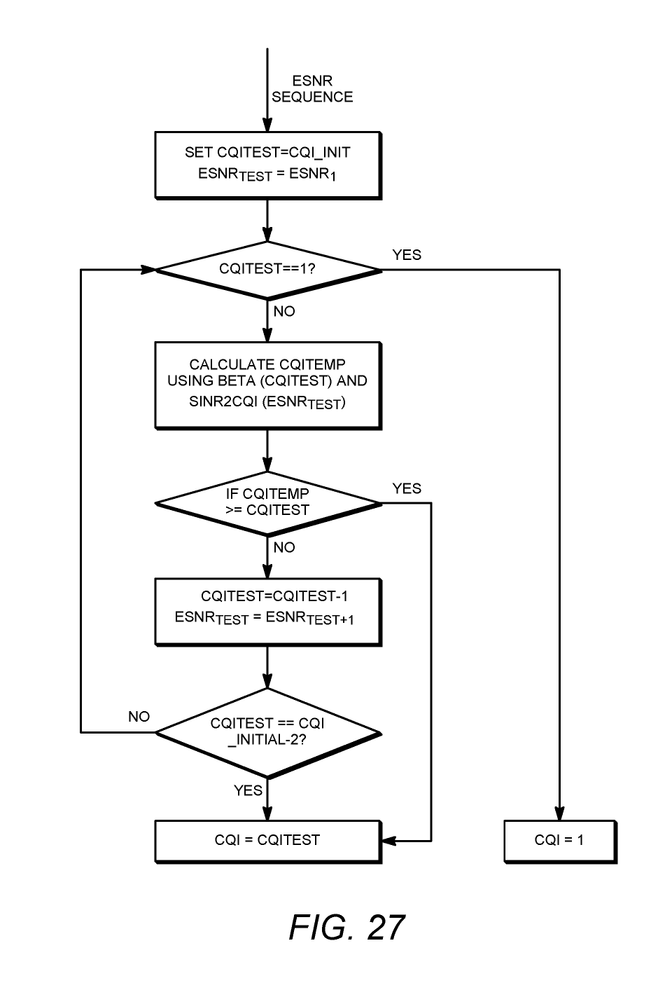

Mapping of one or more, or each, ESNRᵢ to a CQIᵢ using the SINR2CQI mapping described above and/or CQI selection may be performed as described in the example of flow chart of FIG. 27. The Wideband ESNRtest associated to the selected CQItest may be outputted as L1FB_SINR.

The PMI/RI generator may compute and/or report the optimum precoding code (PMI) from a predefined codebook to support Closed Loop Spatial Multiplexing (CL-SM) perhaps using transmission over an optimum number of layers (RI) in systems with nTx ports>1. PMI and/or RI may be fed back to the eNodeB.

For Cat. 0 WTRU, one Rx antenna (for example, perhaps only one) may be used limiting the number of layers to one. In one or more techniques, RI reports might not be supported and/or only PMI may be useful.

For single layer CL-SM, selection criteria of the optimum precoding code may correspond to the precoding code providing the highest Beamforming (BF) gain (bfGain). One or more, or all, precoding codes may be defined in codebooks determined by the number of Tx Ports used by the eNodeB (nTx).

CSI may report based on two antenna ports {0, 1} and/or {15, 16}. The precoding matrix may be selected from Table 47. For the closed-loop spatial multiplexing transmission mode, the codebook index 0 might not be used perhaps when the number of layers is 2.

TABLE 47
Example Codebook for transmission on 2 antenna ports

| Codebook | Number of layers | |
|---|---|---|
| index | 1 | 2 |
| 0 | $\frac{1}{\sqrt{2}} [ \begin{matrix}1 \\ 1\end{matrix} ]$ | $\frac{1}{\sqrt{2}} [ \begin{matrix}1 & 0 \\ 0 & 1\end{matrix} ]$ |
| 1 | $\frac{1}{\sqrt{2}} [ \begin{matrix}1 \\ - 1\end{matrix} ]$ | $\frac{1}{2} [ \begin{matrix}1 & 1 \\ 1 & - 1\end{matrix} ]$ |
| 2 | $\frac{1}{\sqrt{2}} [ \begin{matrix}1 \\ j\end{matrix} ]$ | $\frac{1}{2} [ \begin{matrix}1 & 1 \\ j & - j\end{matrix} ]$ |
| 3 | $\frac{1}{\sqrt{2}} [ \begin{matrix}1 \\ - j\end{matrix} ]$ | — |

CSI reporting may be based on four antenna ports {0, 1, 2, 3} and/or {15, 16, 17, 18}. The precoding matrix may be selected from Table 48, perhaps for example except for alternativeCodeBookEnabledFor4TX-r12=TRUE, in which case the precoding matrix W may be selected otherwise from 3GPP TS 36.213.

The quantity:

Wₙ^{{s}}

may denote the matrix defined by the columns given by the set {s} from the expression:

Wₙ=I−2uₙuₙ^{H}/uₙ^{H}uₙ

where I is the 4×4 identity matrix and/or the vector uₙ is given by Table 48.

TABLE 48
Example codebook for transmission on 4 antenna ports

| Codebook | | Number of layers | | | |
|---|---|---|---|---|---|
| index | uₙ | 1 | 2 | 3 | 4 |
| 0 | u₀ = [1 −1 −1 −1]^{T} | W₀^{{1}} | W₀^{{14}}/\sqrt{2} | W₀^{{124}}/\sqrt{3} | W₀^{{1234}}/2 |
| 1 | u₁ = [1 −j 1 j]^{T} | W₁^{{1}} | W₁^{{12}}/\sqrt{2} | W₁^{{123}}/\sqrt{3} | W₁^{{1234}}/2 |
| 2 | u₂ = [1 1 −1 1]^{T} | W₂^{{1}} | W₂^{{12}}/\sqrt{2} | W₂^{{123}}/\sqrt{3} | W₂^{{3214}}/2 |
| 3 | u₃ = [1 j 1 −j]^{T} | W₃^{{1}} | W₃^{{12}}/\sqrt{2} | W₃^{{123}}/\sqrt{3} | W₃^{{3214}}/2 |
| 4 | u₄ = [1 (−1 − j)/\sqrt{2} −j (1 − j)/\sqrt{2}]^{T} | W₄^{{1}} | W₄^{{14}}/\sqrt{2} | W₄^{{124}}/\sqrt{3} | W₄^{{1234}}/2 |
| 5 | u₅ = [1 (1 − j)/\sqrt{2} j (−1 − j)/\sqrt{2}]^{T} | W₅^{{1}} | W₅^{{14}}/\sqrt{2} | W₅^{{124}}/\sqrt{3} | W₅^{{1234}}/2 |
| 6 | u₆ = [1 (1 + j)/\sqrt{2} −j (−1 + j)/\sqrt{2}]^{T} | W₆^{{1}} | W₆^{{13}}/\sqrt{2} | W₆^{{134}}/\sqrt{3} | W₆^{{1324}}/2 |
| 7 | u₇ = [1 (−1 + j)/\sqrt{2} j (1 + j)/\sqrt{2}]^{T} | W₇^{{1}} | W₇^{{13}}/\sqrt{2} | W₇^{{134}}/\sqrt{3} | W₇^{{1324}}/2 |
| 8 | u₈ = [1 −1 1 1]^{T} | W₈^{{1}} | W₈^{{12}}/\sqrt{2} | W₈^{{124}}/\sqrt{3} | W₈^{{1234}}/2 |
| 9 | u₉ = [1 −j −1 −j]^{T} | W₉^{{1}} | W₉^{{14}}/\sqrt{2} | W₉^{{134}}/\sqrt{3} | W₉^{{1234}}/2 |
| 10 | u₁₀ = [1 1 1 −1]^{T} | W₁₀^{{1}} | W₁₀^{{13}}/\sqrt{2} | W₁₀^{{123}}/\sqrt{3} | W₁₀^{{1324}}/2 |
| 11 | u₁₁ = [1 j −1 j]^{T} | W₁₁^{{1}} | W₁₁^{{13}}/\sqrt{2} | W₁₁^{{134}}/\sqrt{3} | W₁₁^{{1324}}/2 |
| 12 | u₁₂ = [1 −1 −1 1]^{T} | W₁₂^{{1}} | W₁₂^{{12}}/\sqrt{2} | W₁₂^{{123}}/\sqrt{3} | W₁₂^{{1234}}/2 |
| 13 | u₁₃ = [1 −1 1 −1]^{T} | W₁₃^{{1}} | W₁₃^{{13}}/\sqrt{2} | W₁₃^{{123}}/\sqrt{3} | W₁₃^{{1324}}/2 |
| 14 | u₁₄ = [1 1 −1 −1]^{T} | W₁₄^{{1}} | W₁₄^{{13}}/\sqrt{2} | W₁₄^{{123}}/\sqrt{3} | W₁₄^{{3214}}/2 |
| 15 | u₁₅ = [1 1 1 1]^{T} | W₁₅^{{1}} | W₁₅^{{12}}/\sqrt{2} | W₁₅^{{123}}/\sqrt{3} | W₁₅^{{1234}}/2 |

In case alternativeCodeBookEnabledFor4TX-r12=TRUE, one or more, or each, PMI value may correspond to a pair of codebook indices given in the precoding matrix W may be selected from Table 49 (for example, only the 1-layer table is listed, see 3GPP TS 36.213 for higher ranks).

TABLE 49
Example Codebook for 1-layer CSI reporting
using antenna ports 0 to 3 or 15 to 18

| | i₂ | | | |
|---|---|---|---|---|
| i₁ | 0 | 1 | 2 | 3 |
| 0-15 | Wᵢ_{₁}_{,0}⁽¹⁾ | Wᵢ_{₁}_{,8}⁽¹⁾ | Wᵢ_{₁}_{,16}⁽¹⁾ | Wᵢ_{₁}_{,24}⁽¹⁾ |
| | i₂ | | | |
| i₁ | 4 | 5 | 6 | 7 |
| 0-15 | Wᵢ_{₁}_{+8,2}⁽¹⁾ | Wᵢ_{₁}_{+8,10}⁽¹⁾ | Wᵢ_{₁}_{+8,18}⁽¹⁾ | Wᵢ_{₁}_{+8,26}⁽¹⁾ |
| | i₂ | | | |
| i₁ | 8 | 9 | 10 | 11 |
| 0-15 | Wᵢ_{₁}_{+16,4}⁽¹⁾ | Wᵢ_{₁}_{+16,12}⁽¹⁾ | Wᵢ_{₁}_{+16,20}⁽¹⁾ | Wᵢ_{₁}_{+16,28}⁽¹⁾ |
| | i₂ | | | |
| i₁ | 12 | 13 | 14 | 15 |
| 0-15 | Wᵢ_{₁}_{+24,6}⁽¹⁾ | Wᵢ_{₁}_{+24,14}⁽¹⁾ | Wᵢ_{₁}_{+24,22}⁽¹⁾ | Wᵢ_{₁}_{+24,30}⁽¹⁾ |

$where {W}_{m , n}^{( 1 )} = \frac{1}{2} [ \begin{matrix}{v}_{m}^{′} \\ {ϕ}_{n}^{′} {v}_{m}^{′}\end{matrix} ]$

The quantities φₙ, φ′ₙ and v′ₘ in Table 49 are given by:

φₙ=e^{jπn/2}

φ′ₙ=e^{j2πn/32}

v′ₘ=[1e^{j2πn/32}]^{T}

A first PMI value of i₁ε{0, 1, . . . , 15} and/or a second PMI value of i₂ε{0, 1, . . . , 15} correspond to the codebook indices i₁ and i₂ respectively.

CSI reporting may be based on eight antenna ports, each PMI value corresponds to a pair of codebook indices given in Table 50 (for example, only the 1-layer table is listed, see 3GPP TS 36.213 for higher ranks).

TABLE 50
Example Codebook for 1-layer CSI reporting
using antenna ports 15 to 22

| | i₂ | | | |
|---|---|---|---|---|
| i₁ | 0 | 1 | 2 | 3 |
| 0-15 | W₂ᵢ_{₁}_{,0}⁽¹⁾ | W₂ᵢ_{₁}_{,1}⁽¹⁾ | W₂ᵢ_{₁}_{,2}⁽¹⁾ | W₂ᵢ_{₁}_{,3}⁽¹⁾ |
| | i₂ | | | |
| i₁ | 4 | 5 | 6 | 7 |
| 0-15 | W₂ᵢ_{₁}_{+1,0}⁽¹⁾ | W₂ᵢ_{₁}_{+1,1}⁽¹⁾ | W₂ᵢ_{₁}_{+1,2}⁽¹⁾ | W₂ᵢᵢ_{₁}_{+1,3}⁽¹⁾ |
| | i₂ | | | |
| i₁ | 8 | 9 | 10 | 11 |
| 0-15 | W₂ᵢ_{₁}_{+2,0}⁽¹⁾ | W₂ᵢ_{₁}_{+2,1}⁽¹⁾ | W₂ᵢ_{₁}_{+2,2}⁽¹⁾ | W₂ᵢ_{₁}_{+2,3}⁽¹⁾ |
| | i₂ | | | |
| i₁ | 12 | 13 | 14 | 15 |
| 0-15 | W₂ᵢ_{₁}_{+3,0}⁽¹⁾ | W₂ᵢ_{₁}_{+3,1}⁽¹⁾ | W₂ᵢ_{₁}_{+3,2}⁽¹⁾ | W₂ᵢ_{₁}_{+3,3}⁽¹⁾ |

$where {W}_{m , n}^{( 1 )} = \frac{1}{\sqrt{8}} [ \begin{matrix}{v}_{m} \\ {ϕ}_{n} {v}_{m}\end{matrix} ]$

The quantities φₙ and vₘ in Table 50 Example are given by:

φₙ=e^{jπn/2}

vₘ=[1e^{j2πn/32}e^{j4πn/32}e^{j6πn/32}]^{T}

A first PMI value of i₁ε{0, 1, . . . , 15} and/or a second PMI value of i₂ε{0, 1, . . . , 15} may correspond to the codebook indices i₁ and i₂ respectively.

The beamforming gain associated to one or more, or each, symbol may be computed as:

$${bf Gain}_{i , symb} = \frac{{w}_{i}^{H} {H}^{H} {Hw}_{i}}{\frac{1}{nTx} Trace ( {H}^{H} H )}$$

where wᵢ is the i-th precoding code of the code book and H are the CS-RS (ports 0, 1, 2 and 3) or CSI-RS (ports 15, 16, 17, 18, 19, 20, 21, 22) channel estimates for a given reference symbol over the full bandwidth.

Over time, one or more, or each symbol contribution may be filtered such that:

bfGainᵢ=EMA(bfGain_{i,symb},alpha)

where alpha is for 2-symbol contributions per slot.

The reported wb_bfGain and/or corresponding wb_pmi may be defined as:

$${wb}_{bfGain} = {max}_{i = 0 : {N}_{CW} - 1} ( {bf Gain}_{i} , i )$$

$$wb\_pmi = index ( i , wb \_ bf Gain )$$

Sub-band beamforming gains and/or corresponding sb_pmi's may be defined as:

$${sb}_{{bfGain}_{j}} = {max}_{i = 0 : {N}_{CW} - 1} ( {bf Gain}_{i , j} , i )$$

$$sb \_ {pmi}_{j} = index ( i , sb \_ {bfGain}_{j} )$$

where j=1:ceil(N_{RB}/k). H may correspond to the sub-band elements. In case of a pair of i₁ and i₂ indexes, i is the combination of them, i=(i₁, i₂), resulting in the maximum beamforming gain.

Any codeword restricted using bitmap parameter codebookSubsetRestriction configured by higher layer (for example, one per CSI process, perhaps if supported) might not be considered as a winning candidate and/or may not be reported.

The bitmap may form the bit sequence a_{A}_{_{c}}₋₁, . . . , a₃, a₂, a₁, a₀, where a₀ is the Least Significant Bit (LSB) and a_{A}_{_{c}}₋₁ is the Most Significant Bit (MSB). A bit value of zero may indicate that the PMI and/or RI reporting might not be allowed to correspond to the precoder(s) associated with the bit.

The Radio Link Monitoring function may indicate the state of the radio link. This function may be a wideband measurement which may reflect the quality of PDCCH distributed across the band. At least two thresholds (in dB) may be defined: Qᵢₙ and Qₒᵤₜ. Qᵢₙ is the minimum SINR level to get IN-SYNC while Qₒᵤₜ is the minimum level to lose synchronization (Out Of Sync (OOS)).

Hardware may provide Wideband filtered Signal and/or Noise Power estimations which may be further averaged by software overtime. One or more, or every frame, the L1FB_SINR may be computed such that:

$${SINR}_{{Q}_{in}} = \frac{{MovingAvgWindow ( {wb\_signal}_{amplitude} , 100 ms )}^{2}}{MovingAvgWindow ( {wb\_noise}_{power} , 100 ms )}$$

$$\text{and/or}$$

$${SINR}_{{Q}_{out}} = \frac{{MovingAvgWindow ( {wb\_signal}_{amplitude} , 200 ms )}^{2}}{MovingAvgWindow ( {wb\_noise}_{power} , 200 ms )}$$

Radio Lync may be declared IN-SYNC perhaps for example if:

SINR_{Q}_{ᵢₙ}>Qᵢₙ

and/or Radio may stay IN-SYNC until:

SINR_{Q}_{ₒᵤₜ}<Qₒᵤₜ

L1FB SYNC may be reflecting the Radio Link stated to L1S.

ESINR associated with the reported WB CQI may be used along with the wb_noisePwr to filter over time Signal Pwr and/or Noise Pwr.

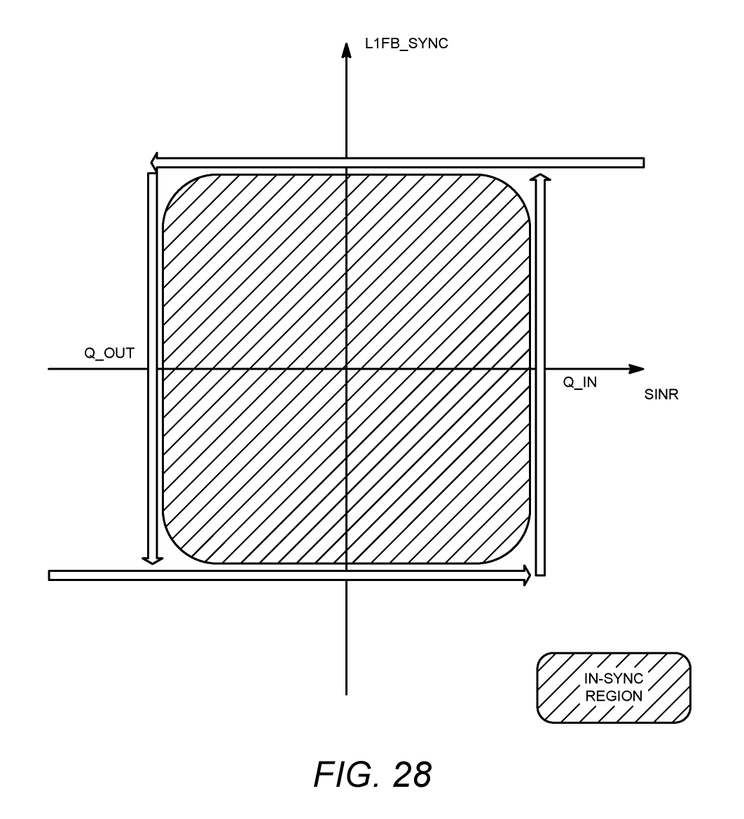

The hysteresis of FIG. 28 illustrates an example of the IN-SYNC region of operation.

The L1 Feedback Report Generator may format the computed CQI/PMI/RI and/or may report them along with the PTI accordingly to the Feedback Mode and/or Tx Mode. The L1 Feedback Reports may be ready to be reported by TxTTI over PUCCH and/or PUSCH without reformatting.

The L1FB_CQI, L1FB_CQI_SB_IDX, L1FB_PMI and/or L1FB_RI fields may be formatted to different field sizes and/or reported aperiodically and/or periodically following the Feedback Mode and/or Tx Mode.

In case of 2 codeword reports and/or sub-bands reports, differential encoding may be supported. This supported function (for example, differential encoding) may be the nature of the report (aperiodically and/or periodically), the Feedback Mode and/or the Tx Mode.

Under WTRU selected CQI feedback mode, the L1 Feedback Report Generator may select the one or more indices associated with the best M subbands.

The one or more inputs to the L1 Feedback Report Generator may come from hardware and/or may be updated at sub-frame rate. The L1 Feedback Report Generator may take a “snapshot” of one or more, or all, data for example to keep the reported fields over time related to the same sub-frame.

In one or more techniques, it may be assumed that L1S may handle the configuration of L1 Feedback Report Generator perhaps for example to derive the required configuration using: L1S_FB_MODE, L1S_TX_MODE, L1S_J_M, L1S_GL_Q_O, and/or L1S_PERIODIC_ENABLE.

The aperiodic reports may use PUSCH and/or the periodic reports may use PUCCH.

Using one or more, or several, non-linear functions in one or more of the techniques herein have been described. In one or more techniques, the approximations of these non-linear functions are described. Log₂(x) may be approximated according to the techniques described in the Rx Front End ACD. An example algorithm description is provided herein.

The integer part of the result may be calculated. In some techniques, x may be the input to the log₂ approximation function. The integer part of the result may be equal to the position of the most significant one in the binary representation of x. For example, if x is equal to 646, the integer part of the output is equal to 9 because the most significant bit position that contains a 1 in the number 646 is 9. In binary form, the integer bits are 1001.

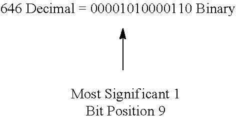

The fractional part of the result may be calculated. The fractional part may be taken to be one or more, or all, the bits to the right of the most significant “1” in x. For example, if x is 646, the most significant “1” appears in bit position 9. The fractional bits of the result may be equal to bits 8 to 0 of the binary representation of 646.

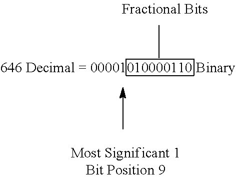

Concatenation of the integer bits and/or the fractional bits may be performed. For this example, where x is 646, the binary representation of the result is:

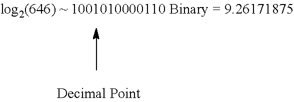

The approximation result is close to the result of the real log 2 function, log 2(646)=9.3354.

Log(x) may be approximated as:

log(x)=log(2)log₂(x)=0.6931·log₂(x)

where log₂(x) may be approximated according to method described herein.

At first, the integer and/or fractional part of x may be calculated:

x_int=round(x)

x_frac=x−x_int

The function Exp(x) is then approximated as:

exp(x)=LUT_int)·(1+x_frac+½x_frac²)

where LUT(x_int) represents a look-up table to obtain approximation of exp(x_int).

Example functional and/or performance requirements are listed in Table 51 and Table 52, respectively.

TABLE 51
Example Functional Requirements Summary

| ID L1FBF_{—} | Requirement | Comments |
|---|---|---|
| 100 | Compute CQI, PMI, RI, PTI | No RI/PTI for cat.0 UE, |
| | | Only Rank1 |
| 101 | Support various antenna configuration | nTxAnt × 1, |
| | | nTxAnt = 1, 2, 4, (cat.0 UE) |
| 102 | Support all feedback modes (Table 35) | Relevant to cat.0 UE |
| 103 | Support all transmission modes (Table | Relevant to cat.0 UE |
| | 34) | |
| 104 | Handle all Ranks (MIMO) | Only Rank1 |
| 105 | Sub-band selection for UE selected CQI | Periodic and aperiodic |
| | feedback modes | modes |
| 106 | Able to manually set PMI and RI- | Using precoder codebook |
| | | subset restriction mask |
| | | (PMI); |
| | | RI not supported for |
| | | cat.0 UE |
| 117 | Able to manually set CQI | This is irrelevant to |
| | | L1FB, but eNb need to |
| | | support |
| 108 | Support both PUCCH and PUSCH based | L1FB supports the |
| | feedback (periodic and aperiodic | periodic/aperiodic |
| | reporting) | aspect, but Tx-TTI must |
| | | handle PMI/CQI/RI/PTI |
| | | info over PUCCH and |
| | | PUSCH |
| 109 | Support various feedback periods (Q) in | |
| | PUCCH feedback modes | |
| 110 | Support various timing offsets (O) | |
| | between RI and CQI/PMI reports in | |
| | PUCCH feedback modes | |
| 111 | Support various sub-band CQI repetition | |
| | (K) in PUCCH feedback modes | |
| 112 | Support various wideband CQI repetition | |
| | between RI reports (G) in PUCCH | |
| | feedback modes | |
| 113 | Handle various system bandwidth (N^{DL}_{RB}) | |
| 114 | Handle differential CQI mapping | 2CW's and Sub-bands |
| | | for some |
| | | TxModes/FbModes |
| 115 | Latency requirement will be derived from | Exact latency |
| | timing diagram in MIMO receiver ACD. | requirements depends |
| | | on CHEST and Tx TTI |
| 116 | Sleep in DRX mode | |
| 118 | Correctly select M subbands for UE | |
| | selected feedback modes | |

TABLE 52
Example Performance Requirements Summary

| ID L1FBP_{—} | Requirement | Comments |
|---|---|---|
| 201 | In AWGN equivalent channel, (diagonal or Walsh | |
| | channel) 90% percent of reported CQI falls within | |
| | [CQImedian − 1, CQImedian + 1] | |
| 202 | In AWGN equivalent channel, (diagonal or Walsh | To be tested |
| | channel), BLER < 0.1 when MCS is set to CQImedian − | at link level |
| | 1; and BLER > 0.1 when MCS is set to CQImedian + 1 | |
| 203 | In fading channels (EPA5), BLER conditional on | To be tested |
| | CQImedian is less than 0.1 when MCS is set to | at link level |
| | CQImedian − 1; and BLER conditional on CQImedian is | |
| | greater than 0.1 when MCS is set to CQI_median + 1 | |
| 204 | Across SNR range [0, 30] dB, and at 10% BLER, the | See later |
| | throughput loss should be less than 3% compared with | section |
| | exhaustive CQI/PMI/RI search. | |
| 205 | At SNR > X dB, with stationary channel [1.0; 0.1] * W^{H}, | |
| | where W is a predetermined precoding matrix, the | |
| | probability of PMI corresponding to W is higher than | |
| | 90%. | |

Conformance tests may be defined in RAN 4. Updated design requirements for the components may be useful. The Beta table may be examined and/or optimized since it may be based on ideal CHEST. CQI adjustment according to CHEST error, NEST error, TBS, and/or Doppler may be useful. Example of SNR range for requirement 205 is illustrated in Table 52. Latency requirement to L1FB may depend on MIMO receiver design. The exact value may be set and/or computed accordingly. PTI may report for Tx Modes 8, 9 and/or 10. For aperiodic CSI reporting, CSI process might not be handled by L1FBK, and/or one CSI report (for example, only one) may be supported for current sub-frame. L1S may support CSI processes management, for example, in CoMP. SNR value used for AFC/CHEST/Radio Link monitoring may be EESM based and/or not EESM based.

In one or more techniques, for an arbitrary SINR sequence {λᵢ; i=1, 2, . . . N}, and an arbitrary positive β, it may be true that the exponential effective SINR of the SINR sequence may be upper bounded by its linear average, for example:

$$- βln ( \frac{1}{N} {\sum }_{i = 1}^{N} exp ( - \frac{{λ}_{i}}{β} ) ) \leq \frac{1}{N} {\sum }_{i = 1}^{N} {λ}_{i}$$

According to Jensen's Inequality:

$$exp ( \frac{{\sum }_{i = 1}^{N} \frac{- {λ}_{i}}{β}}{N} ) \leq \frac{1}{N} {\sum }_{i = 1}^{N} exp ( - \frac{{λ}_{i}}{β} )$$

which leads to:

$${( exp ( \frac{{\sum }_{i = 1}^{N} {λ}_{i}}{N} ) )}^{- \frac{1}{β}} \leq \frac{1}{N} {\sum }_{i = 1}^{N} exp ( - \frac{{λ}_{i}}{β} )$$

which leads to:

$${( exp ( \frac{{\sum }_{i = 1}^{N} {λ}_{i}}{N} ) )}^{- 1} \leq {( \frac{1}{N} {\sum }_{i = 1}^{N} exp ( - \frac{{λ}_{i}}{β} ) )}^{β}$$

which leads to:

$$( exp ( \frac{{\sum }_{i = 1}^{N} {λ}_{i}}{N} ) ) \geq {( \frac{1}{N} {\sum }_{i = 1}^{N} exp ( - \frac{{λ}_{i}}{β} ) )}^{- β}$$

Taking the logarithm of both side of the equation above, it finally becomes:

$$- βln ( \frac{1}{N} {\sum }_{i = 1}^{N} exp ( - \frac{{λ}_{i}}{β} ) ) \leq \frac{1}{N} {\sum }_{i = 1}^{N} {λ}_{i}$$

One or more of the variables, RI, PMI and/or CQI, may be jointly determined to achieve the maximum throughput by (for example, exhaustively) examining one or more, or all, possible hypotheses. This may involve examining a large number of hypotheses. This may involve a large number of divide operations, for example since rank-2 SINRs may be used for one or more, or all, possible rank-2 PMIs.

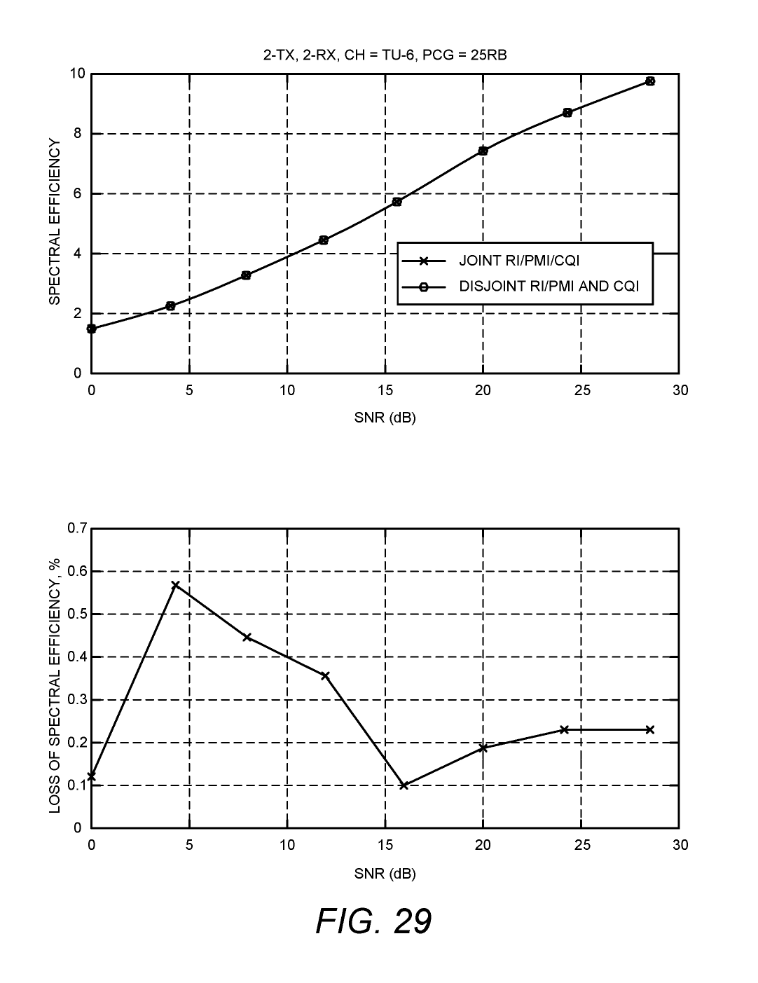

A disjoint approach is also described herein. RI/PMI may be determined jointly. CQI may be calculated for the selected RI/PMI (for example, the selected RI/PMI only). To justify the algorithm selection, for example, simulations have been run to verify the performance loss is acceptable. One example of a comparison is shown in FIG. 29. The loss caused by disjointed detection is minimal.

To determine the true CQI, techniques recognize that a conventional approach is to generate one or more, or all, 16 interim CQI indices, one or more, or each corresponding to a beta value, and select one from them. Such a conventional approach may require unnecessarily high complexity. In one or more techniques herein, the final CQI selection may be limited to [CQI_initial-2, CQI_initial], where two (for example, only two) additional CQI indices may be calculated. To justify the decision, some example numerical results are presented herein.

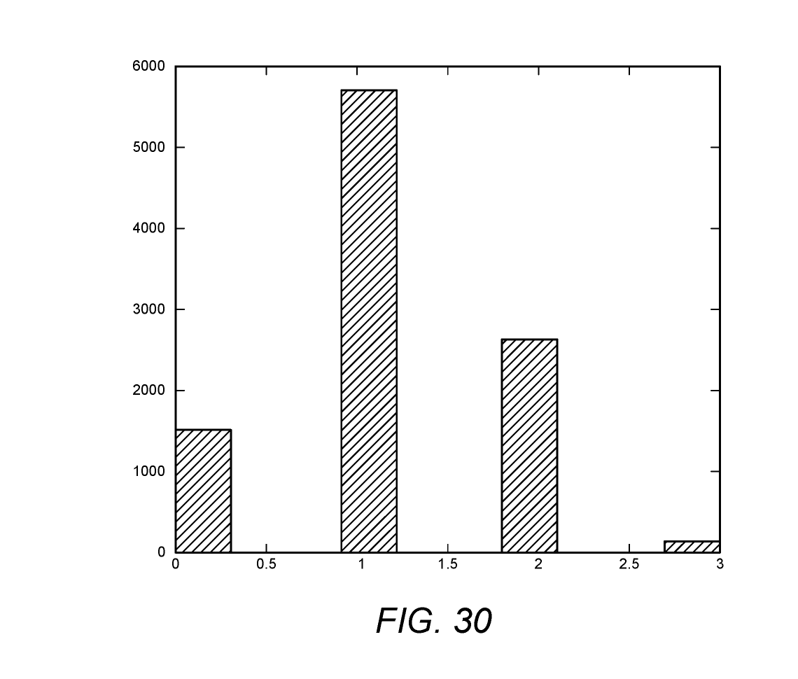

With a flat channel, for example, among scenarios, CQI may equal the initial CQI. From intuition, the gap between true CQI and initial CQI may increase with frequency selectivity. A histogram of an example of the gap between the initial CQI and true CQI is shown in FIG. 30, with TU-6 channel, and 10 MHz band allocation. One or more, or all, true CQI indices may fall within the range of [CQI_initial-3, CQI_initial]. At least from this assessment, one or more techniques described herein may be sufficient for range of [CQI_initial-2, CQI_initial].

Additional acronyms used herein may include AFC (Auto Frequency Correction), BS (Base Station), CHEST (Channel Estimation), CS (Cell Search), ICS (Initial Cell Search), PSS (Primary Sync Sequence), SSS (Second Sync Sequence), PCI (Physical Cell ID), CP (Cyclic Prefix), FFT (Fast Fourier Transform), DFT (Discrete Fourier Transform), IFFT (Inverse Fast Fourier Transform), OFDM (Orthogonal Frequency Division Multiplexing), RB (Resource Block), Rx (Receiver), TTI (Transmission Time Interval), Tx (Transmitter), UE (User Equipment) and/or WTRU (Wireless Transmit/Receive Unit).

Systems, methods, and instrumentalities are disclosed for LTE cell search and measurements component design. Cell search operating modes may comprise, for example, initial cell selection, stored information cell selection and target cell selection. An LTE cell search (CS) may be performed, for example, by acquiring a coarse estimate of a carrier frequency offset (CFO), detecting a primary synchronization signal (PSS) index, e.g., by maximum likelihood (ML) PSS detection, determining a secondary synchronization sequence (SSS), extracting from the SSS a cell identity (ID) group, a frame boundary and a cyclic prefix (CP) length or type and determining a cell ID.

The systems described herein may be implemented in a WTRU that connects to an LTE cell. The techniques may be used by relatively low-cost LTE devices, as the techniques described herein may be implemented using relatively low cost front-end hardware. For example, as compared to typical RL front end components used by many devices that implemented LTE R8, a low cost device may have more stringent requirements in terms of lowering the cost of the hardware included in the device. One way of lowering the cost of the RF front-end hardware may be to use a relatively low cost oscillator in the RF front-end. Although such a change may achieve cost savings, the low cost oscillator may be less accurate and/or may perform RF processing functions less accurately than a higher cost oscillator that may be more typically used in LTE Release 8 devices. For example, the low-cost RF front-end (e.g., oscillator) may result in a relatively large initial frequency offset error during initial cell selection stage during direct cross-correlation when performing maximum likelihood PSS detection. However, the techniques described herein may be used by the WTRU to still be able to perform cell selection accurately and within predefined time constraints even when using the lower cost, less accurate RF front-end hardware.

The methods, techniques, and instrumentalities described herein may be implemented by any LTE device configured for performing cell search functions.

Cell search (CS) may be used by a WTRU, for example, to acquire time and/or frequency synchronization with a cell and/or to detect a corresponding Cell ID and set of cell/system-specific information. Cell search operating modes may comprise, for example, initial cell selection, stored information cell selection and target cell selection.

Initial Cell Selection may be implemented, for example, without prior knowledge of which RF channels are E-UTRA carriers. A WTRU may scan one or more (e.g., all) RF channels in the E-UTRA bands according to WTRU capabilities to find a suitable cell. On a (e.g. each) carrier frequency, a WTRU need may search for the strongest cell. A WTRU may select a cell, for example, when a suitable cell is found.

Stored Information Cell Selection may be implemented, for example, using stored information of carrier frequencies and/or information on cell parameters from previously received measurement control information elements and/or from previously detected cells. A WTRU may select a suitable cell, for example, upon finding one or more suitable cells. An initial cell selection procedure may be performed, for example, when a suitable cell might not be found.

PLMN-Selection may be used to find one or more (e.g. all) PLMNs from one or more (e.g. all) detectable LTE cells one or more (e.g. or all) WTRU supported LTE carrier frequency bands determined by a NAS. A NAS may choose a higher priority PLMN for a WTRU to select or reselect (with a cell) from a returned PLMN list.

Target cell selection may be used by a WTRU to find and synchronize with a cell, e.g., for subsequent operations. A WTRU may have or be provided with a frequency and/or physical Cell ID of a cell to find and synchronize with. Cell information may be provided, for example, by a network or previous WTRU operations.

Cell Search procedures may be categorized, for example from a physical layer perspective, as Initial Cell Search (ICS) and Targeted Cell Search.

High-level CS functions may be mapped to PHY-level Cell Search processing tasks. Varying parameters and control logic may allow for HW re-use, for example, depending on how much internal processing varies. A Cell Search Controller may coordinate processing of blocks for one or more (e.g. each) CS functions. A Cell Search Controller may supply and/or store parameters to one or more processing blocks.

An LTE Cell Search component may support a scalable overall transmission bandwidth, e.g., from 1.4 to 20 MHz. Cell Search in LTE may, for example, be based on physical signals and physical channels transmitted in the downlink (DL).

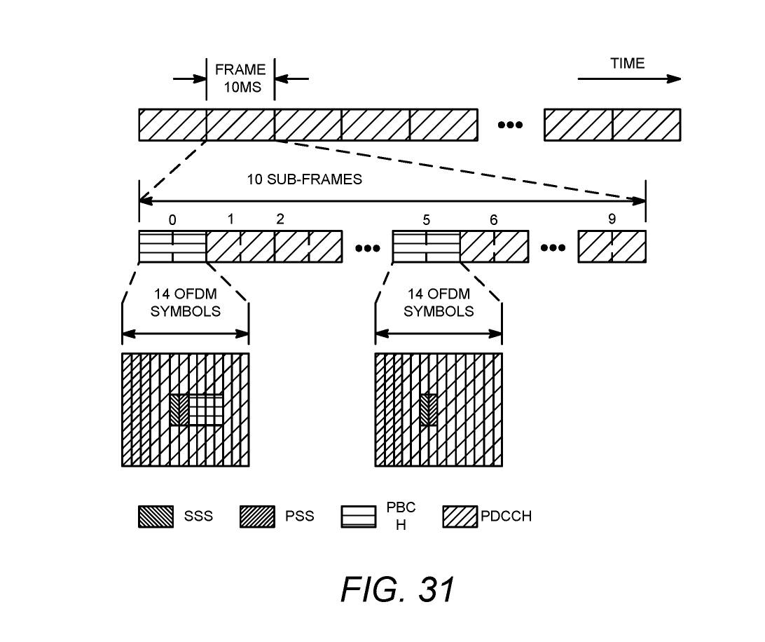

FIG. 31 is an example of frame structure in LTE physical signaling. Physical signals may comprise, for example, primary and secondary synchronization signals (PSS, SSS). PSS and SSS may be transmitted, for example, on 62 subcarriers out of 72 subcarriers with five subcarriers reserved on each side of edge. As shown in the example in FIG. 31, PSS and SSS may be centered on the DC subcarrier, for example, during the 0^{th} and 10^{th} slots of each. Synchronization (SYNC) signals may enable acquisition of symbol timing and initial frequency of the downlink (DL) carrier signal. SYNC signals also convey information pertaining to Cell ID.

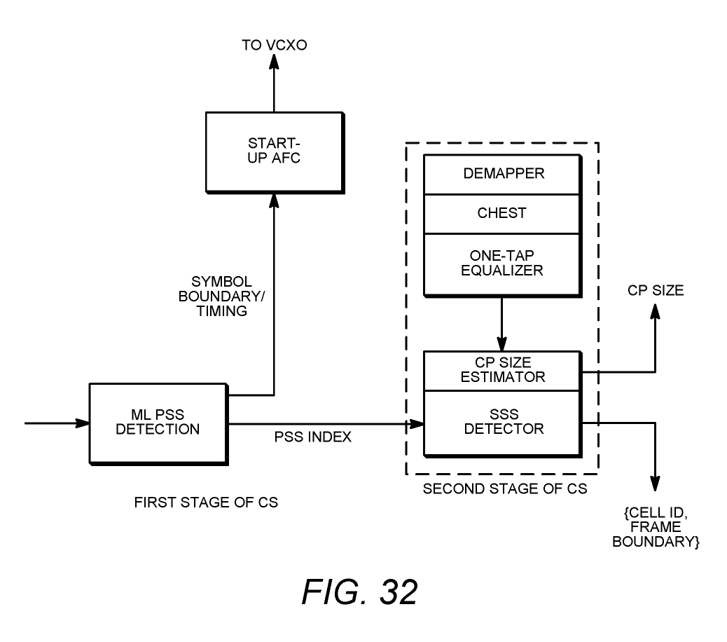

FIG. 32 is an example of Cell Search components. Cell Search procedures may be conducted in one or more stages. A stage may deduce various levels of information. A first stage may comprise PSS detection and processing. A second stage may comprise SSS detection and processing. A first stage may detect and/or process one or more of a PSS index, N_{ID}⁽²⁾={0, 1, 2}, an OFDM symbol timing (OST) and a start up AFC. A second stage may detect and/or process one or more of a Unique Cell ID, N_{ID}⁽¹⁾, a Sub-frame/Radio frame boundary and a CP type, which may be extended or normal CP. In an example, a first stage of CS components may include an MLPSS detector and startup AFC and a second stage of CS components may include a demapper, CHEST, one-tap equalizer, CP size estimator and SSS detector.

A WTRU may, for example during RF scanning, conduct a general frequency scan on one or more (e.g. all) rasters in one or more EUTRAN carrier band(s), during which an RSSI measurement for one or more (e.g. each) frequencies may performed, e.g., for frequency ranking. A PHY Cell Search component may be invoked, for example, to perform cell search on a selected frequency raster. An initial frequency offset may be within ±3 ppm, for example, with respect to an RF scanning operation.

An ICS function may detect and/or identify the strongest cell on a (e.g. the current) frequency, for example, within a particular time of a cell search request. An ICS function may be capable of maintaining a list of strongest “peaks” (e.g. correlations of PSS), and/or searching each peak (e.g., potentially searching in a sequential order based on a factor such as signal strength), for example, upon request of LPHY Control Unit. For example, a (e.g. each) request may trigger an initial cell search on a next highest peak that has not been searched. A CS component may return a result within a particular time. A CS component may generate and/or maintain a list of peaks and/or may track which peaks have been searched. A probability of correct detection may be, for example, at least 90%. An overall probability of false alarm may be, for example, less than or equal to 10⁻⁴.

A targeted Cell Search function may detect and/or identify a (e.g. specified) cell, for example, within T_{search} of a cell search request. T_{search} may be based on non-DRX targeted cell search times, for example, regardless whether DRX is in use by the WTRU. T_{search} for a target cell known by a WTRU may be, for example, 100 ms. A target cell may be known, for example, when it has been measured by the WTRU in the last 5 seconds. T_{search} for a target cell unknown by a WTRU may be, for example, 800 ms. A target cell may be unknown, for example, when it has not been measured by the WTRU in the last 5 seconds. Targeted cell search may, for example, use Frequency (EARFCN) and Physical Cell ID (PCI) as search criteria. Probabilities of correct detection and/or false alarm may be specified.

LTE cell search (e.g. a first stage of LTE CS) may comprise, for example, one or more of acquiring a coarse estimate of a carrier frequency offset (CFO) and detecting a Primary Synchronization Signal (PSS) index. A PSS may comprise cell identity within the cell-identity group, which may belong to the set of N_{ID}⁽²⁾={0, 1, 2}). CS (e.g. a first stage of CS) may determine a timing (e.g. a 5 ms timing) of a cell (e.g. half frame timing) and/or a location of the Secondary Synchronization Signal (SSS), which may be used by CS (e.g. a second stage of CS).

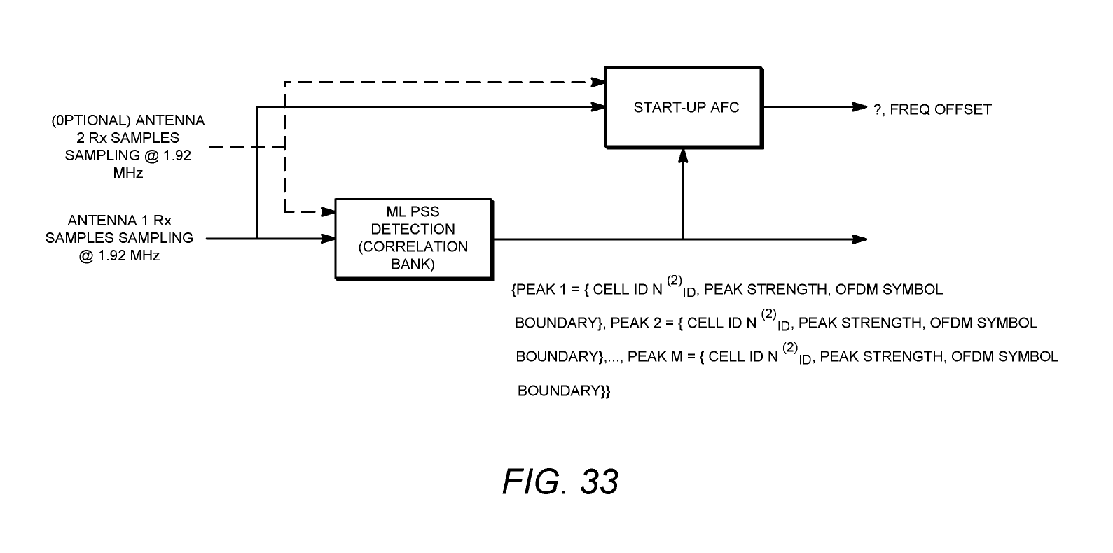

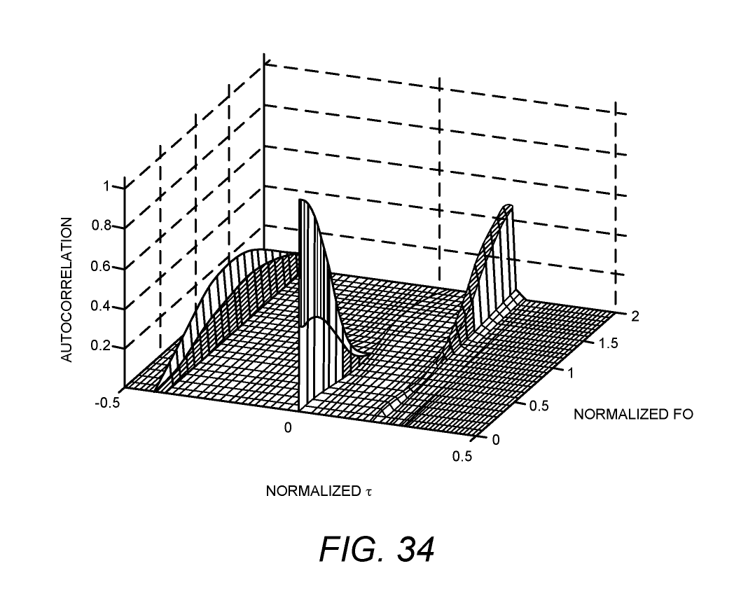

FIG. 33 is an example of cell search, e.g., a first stage of CS. CS (e.g. a first stage of CS) may comprise, for example, maximum likelihood (ML) PSS detection and/or start-up AFC. ML PSS detection may comprise, for example, a PSS Correlator Unit Bank and PSS Peak Detection. PSS peak detection may comprise, for example, Multiple PSS (e.g. N_{ID}⁽²⁾) peaks. A (e.g. each) peak output may be associated with OFDM symbol timing and peak strength (abs value). A peak attribute may be denoted, for example, in accordance with Eq. 1.

Peak m={Cell ID N_{ID}⁽²⁾,peak strength,OFDM Symbol boundary} Eq. 1

A start-up AFC may, for example, be computed through multiple bins used as part of a PSS correlator unit bank. A start-up AFC may use partial knowledge of CP location and/or PSS signal.

An incoming signal may pass through an LPF and down-sampling. An output of a preprocessor from a (e.g. each) receive antenna may be fed to an ML PSS detector. A function of an ML PSS detector may be, for example, to cross-correlate a received signal (e.g. at each receive antenna) with one or more pre-stored time-domain PSS sequences. A (e.g. each) pre-stored time-domain PSS sequence may be generated from a replica of original LTE PSS sequences. A (e.g. each) pre-stored time-domain PSS sequence may be multiplied by a predefined DFT sequence with a programmable normalized frequency offset parameter E. Quality of output of direct cross-correlation with receive samples may be inadequate, for example, when a frequency offset error is unknown to a PSS detector in an initial CS stage. A larger initial frequency offset may exist during an initial CS stage, for example, due to a low-cost RF front end (e.g. oscillator) device.

FIG. 34 is an example 3D plot of an LTE PSS aperiodic autocorrelation property for varying parameters of frequency offset (FO) and time delay (τ). As shown in FIG. 34, larger FO may lead to spurs in LTE PSS autocorrelation property at an incorrect time-delay location, which may result in an incorrect estimated time delay τ. As an example of interpreting FIG. 5, spurs occur at normalized time delay τ around 0.25 when the normalized FO=2.

An ML PSS detection method may be adapted for the initial CS stage, for example, to remedy an unknown initial FO that may cause inaccurate estimation of a time delay parameter τ. ML PSS detection may have a plurality of components. ML detection may have a bank of PSS correlation units. A (e.g. each) PSS correlation unit may be responsible for a (e.g. specific) frequency offset with, for example, three PSS sequences for direct-correlation computation. ML PSS detection may have three PSS convolution in one or more (e.g. all) PSS correlation units. A power estimator may be used for peak normalization in a (e.g. each) PSS correlation unit. Peak detection may be used, for example, to select one or more (e.g. the best) M peaks among the output of PSS correlation unit banks. An M value may be selected.

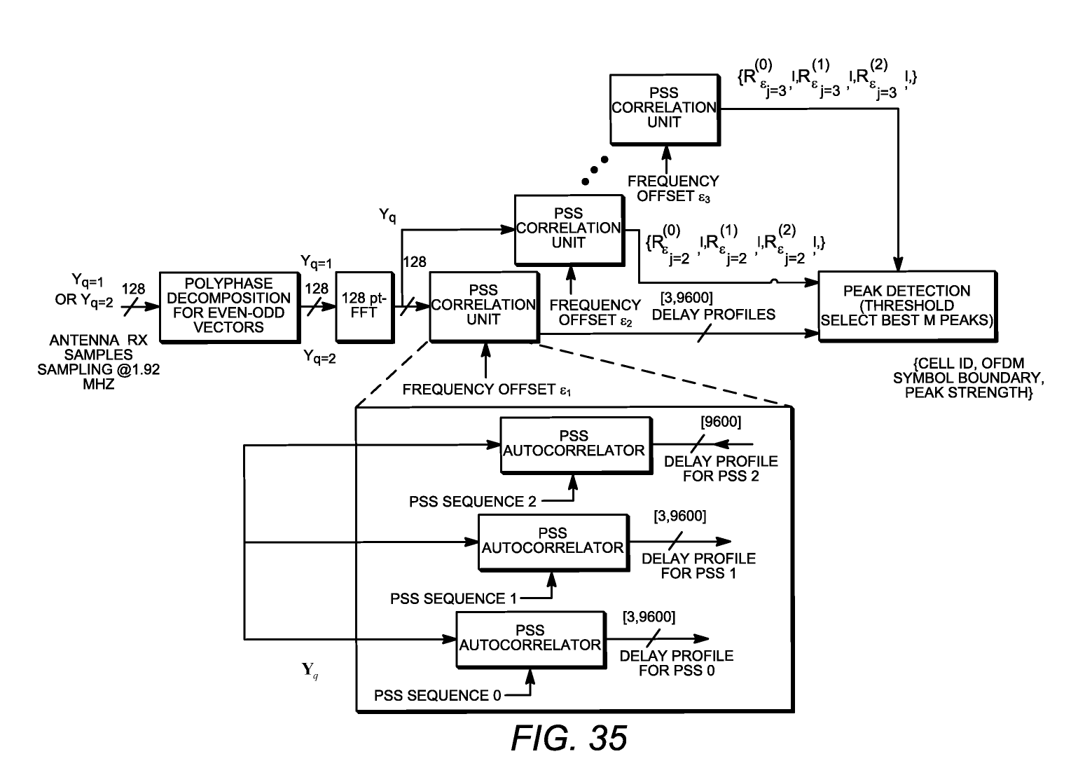

FIG. 35 is an example of an ML PSS detector. ML PSS detection may be a concurrent method of time-frequency synchronization processing. LTE subcarrier spacing may be defined, for example, as 15 KHz. An initial frequency offset may be unknown to the PSS detector in an initial CS stage. An initial frequency offset may be, for example, up to 30K Hz. In an example, frequency offset separation may be 3.75 KHz (Δf=3.75 KHz) between PSS correlation units. Continuing with the example, an ML PSS detection method may have 16 PSS correlator units

$$( u = \frac{\pm 30}{3.75} = 2 \times 8 = 16 ) .$$

A wide range of initial frequency may lead to higher implementation complexity for ML PSS detection. MLPSS synchronization design may trade-off implementation complexity and detection performance. An LTE system may have, for example, three distinct PSS sequences (i=0, 1, 2). A total number of PSS correlators may, in an example, be equal to v=3×u PSS correlators.

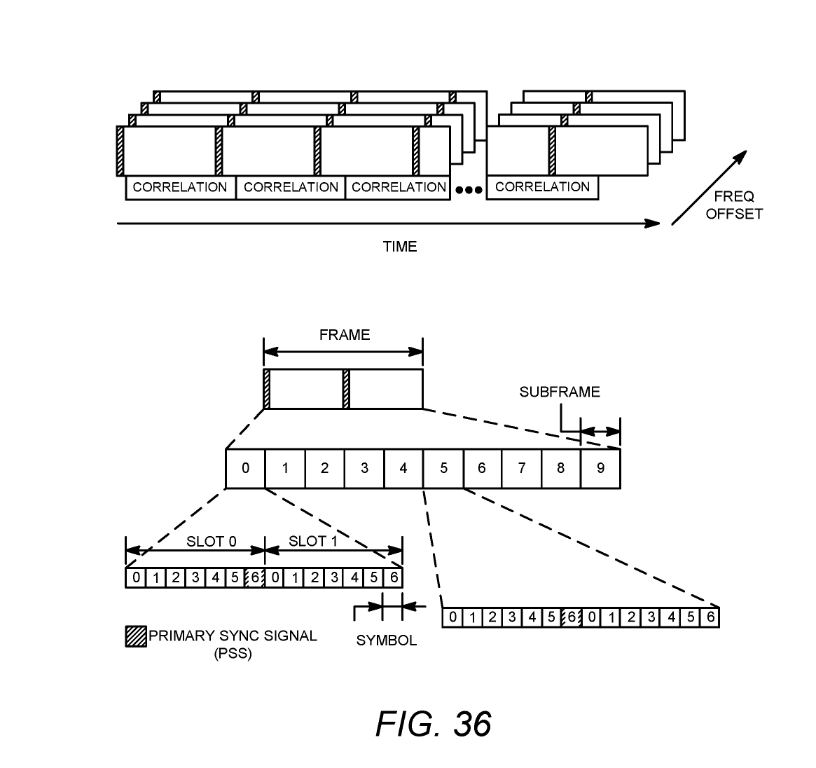

FIG. 36 is an example of a time-frequency synchronization property of ML PSS detection. In an example, there may be four (u=4) PSS corrleator units. A search range of frequency offset may be equal to u×Δf.

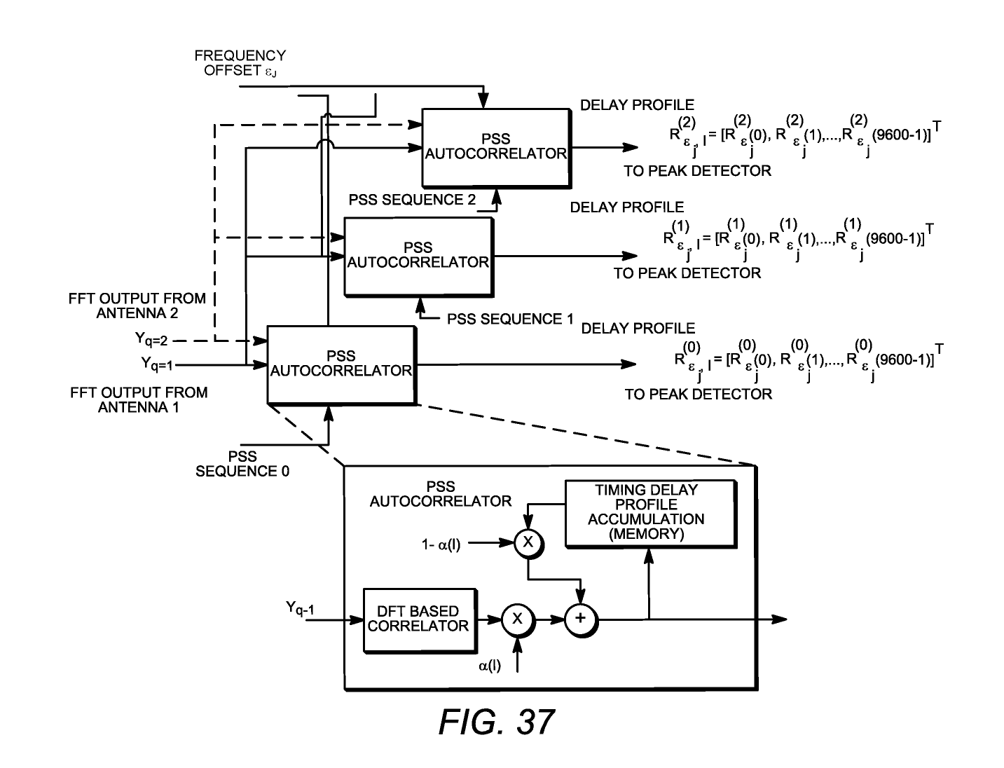

FIG. 37 is an example diagram of a PSS correlation unit. A PSS correlation unit may have, for example, three PSS autocorrelators. A (e.g. each) PSS autocorrelator may provide a response for the detection of a PSS sequence, e.g., PSS with N_{ID}⁽²⁾=0, 1 or 2. There may be a plurality of components in a (e.g. each) PSS autocorrelator, for example, an FFT based correlator and a timing delay memory for timing delay profile accumulation.

For example, at a sampling rate of 1.92 MHz for CS processing a correlation unit may receive 9600 samples every 5 ms per antenna. A range of timing delay d, may be a PSS symbol boundary location, e.g., from [0, . . . , 9599]. A direct cross-correlation output at u_{i,j}-th PSS autocorrelatror may be denoted as shown in Eq. 2:

R_{ε}_{ⱼ}ₗ⁽ⁱ⁾=[R_{ε}_{ⱼ}ₗ⁽ⁱ⁾(0),R_{ε}_{ⱼ}ₗ⁽ⁱ⁾(1), . . . ,R_{ε}_{ⱼ}ₗ⁽ⁱ⁾(9600−1)]^{T} Eq. 2

where i may represent the i-th PSS sequence ID, εⱼ may be a pre-defined normalized frequency offset and l may denote an l-th accumulation.

An FFT based correlator may be based on block-processing. A (e.g. each) processed block may have 64 output samples. As an example, a 5 ms PSS synchronization correlation processing window may have 150 output blocks (e.g. 9600/64=150 output blocks). At a k-th block, where k=1 . . . , 150, the symbol boundary location range may be represented by Eq. 3:

dε{kM−M, . . . ,kM−1}, d=0, . . . ,9599 Eq. 3

where M=64 may be a PSS sequence length. A 64 output of correlation at the q-th antenna may be denoted as r_{q,ε}_{ⱼ}⁽ⁱ⁾(d). An equivalent correlation output may be represented by Eq. 4:

Correlation output r_{q,ε}_{ⱼ}⁽ⁱ⁾(d) may be provided to a MIMO combiner, for example, when the number of receive antenna is greater than one. A number of receive antenna may default to one (or Q=1), for example, in a cat-0 WTRU. A MIMO combiner may or may not be utilized. An output of MIMO combiner be represented by Eq. 5 and Eq. 6:

$$\begin{matrix}{R}_{{ɛ}_{j} , l}^{( i )} ( d ) , d ∈ \{ kM - M , … , kM - 1 \} , & Eq . 5 \\ {R}_{{ɛ}_{j} , l}^{( i )} ( d ) = {\sum }_{q = 1}^{Q} \vert {r}_{q , {ɛ}_{j}}^{( i )} ( d ) \vert i ∈ \{ 0 , 1 , 2 \} & Eq . 6\end{matrix}$$

In a timing delay profile accumulation stage, an output of a MIMO combiner value R_{ε}_{ⱼ}ₗ⁽ⁱ⁾(d) may be averaged with a value of a previous timing delay profile R_{ε}_{ⱼ}ₗ₋₁⁽ⁱ⁾(d), e.g., 9600 locations for every location within 5 ms. An average-accumulated delay profile may be presented by Eq. 7:

R_{ε}_{ⱼ}ₗ⁽ⁱ⁾(d)=α(l)R_{ε}_{ⱼ}ₗ⁽ⁱ⁾(d)+(1−α(l))R_{ε}_{ⱼ}ₗ₋₁⁽ⁱ⁾(d) d=0, . . . ,9599, Eq. 7

where the parameter α(l) value for averaging may be a function of the l-th accumulation. The parameter α(l) accumulation may be presented by Eq. 8:

$$α ( l ) = \frac{1}{l} , l = 1 , 2 , … , CS 1\_accum \qquad Eq . 8$$

where CS1_accumεZ⁺ may be a maximum accumulation parameter.

As an example where CS1_accum is set to a value 10, which may be equivalent to 10×5 ms accumulation,

$$l = \{ 1 \frac{1}{2} \frac{1}{3} … \frac{1}{10} \} .$$

An output R_{ε}_{ⱼ}ₗ⁽ⁱ⁾(d) may be provided to a peak detection module for peak detection, e.g., periodically, such as every 5 ms. In an example where accumulation/counter reaches the input parameter CS1_accum, for example, data may be kept in the accumulated memory without any reset, which may be represented as R_{ε}_{ⱼ}ₗ⁽ⁱ⁾(d)=R_{ε}_{ⱼ}ₗ⁽ⁱ⁾(d), if mod(CS1_accum, l)=0 or data may be reset in the accumulated memory, which may be represented as R_{ε}_{ⱼ}ₗ⁽ⁱ⁾(d)=0, if mod(CS1_accum, l)=0.

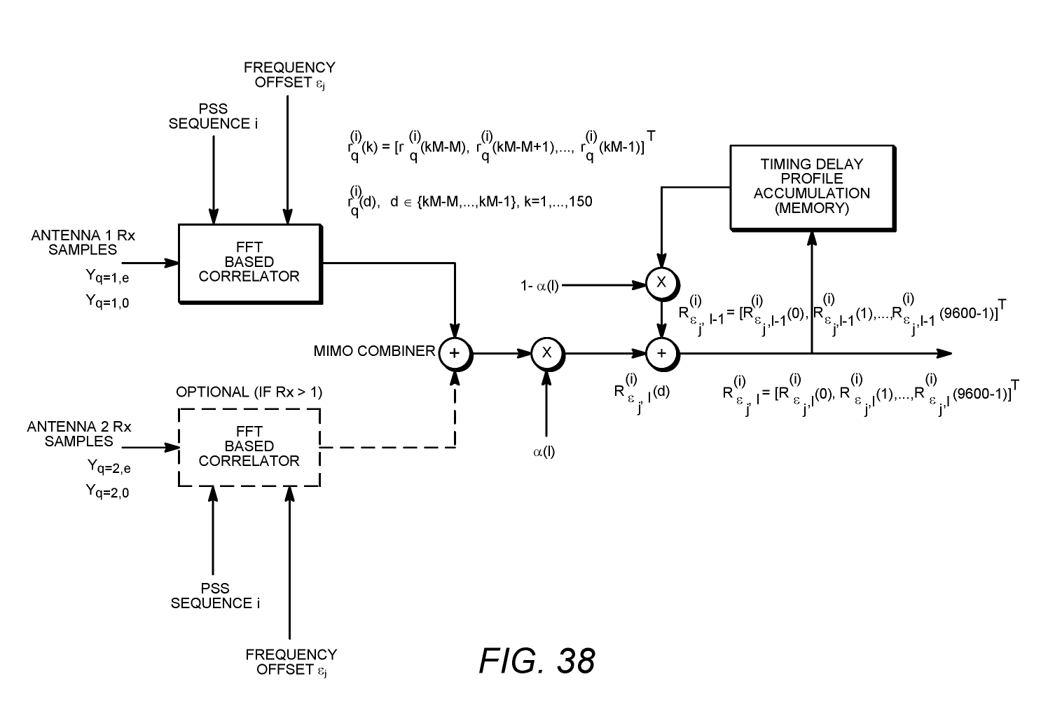

FIG. 38 is an example of a PSS autocorrelator. For example, with a 5 ms correlation window, received samples from the q-th antenna y_{q}(d), d=0, . . . , 9599 may be collected in the correlation window. Input signal y_{q}(d) may have 2× upsampling. Polyphase (even and odd phase) decomposition may be performed with input signal for FFT based correlator. The FFT based correlator may take, for example, 128 y_{q}(d) input samples for block correlation processing. Continuing with the example, the input (e.g. 128 input samples) may be split as even and odd phase samples and converted into k-th even and odd sample vectors that may be represented according to Eq. 9 and Eq. 10, respectively:

y_{q,e}(k)=└y_{g}(d=kN−N)y_{q}(kN−N+2) . . . y_{q}(kN−2)┘, Eq. 9

y_{q,o}(k)=└y_{q}(d=kN−N+1)y_{q}(kN−N+3) . . . y_{q}(kN−1)┘ Eq. 10

where N=128. Even and odd sample vectors may be concatenated to previous even and odd sample block sample vectors, for example, forming a length equal to 128 sample vectors. As an example, an input vector at the k−1-th and k-th of even sample vector block may be represented, respectively, by Eq. 11 and Eq. 12:

y_{q,e}(k−1)=└y_{q}((k−1)N−N),y_{q}((k−1)N−N+2) . . . y_{q}((k−1)N−2)┘ Eq. 11

y_{q,e}(k)=└y_{q}(kN−N),y_{q}(kN−N+2)y_{q}(kN−2)┘ Eq. 12

Back to back blocks, e.g., └y_{q,e}(k−1),y_{q,e}(k)┘ and └y_{q,o}(k−1),y_{q,o}(k)k′ may be used, for example, for the input of an FFT-based correlator.

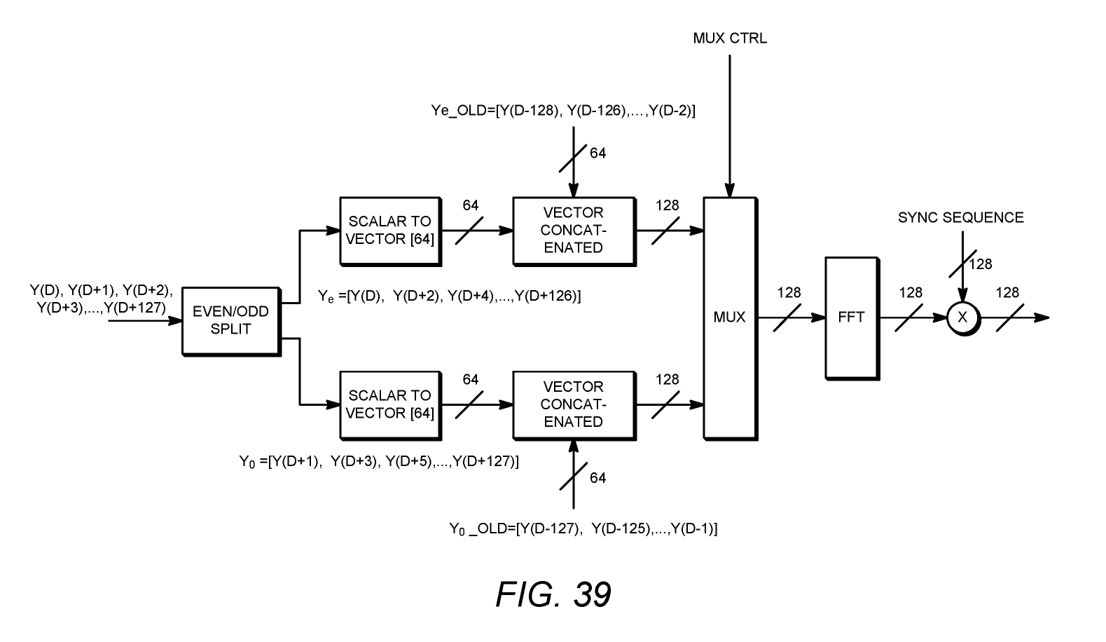

FIG. 39 is an example of polyphase decomposition for generation of even and odd sample vectors, e.g., in a 5 ms window.

There may be one or more, or a plurality of (e.g. three) PSS sequences defined in LTE. One or more (e.g. all) sequences may be used for Cell-ID detection/timing estimation, e.g., during a Cell Search process. PSSs may be constructed, for example, based on Zadoff-Chu (ZC) sequences pᵤ (n), which may have a length of 62 (truncated from 63) extended with five zeros at the edges. An example of a pᵤ (n) sequence may be represented by Eq. 13:

$${p}_{u} ( n ) = {e}^{- j \frac{π un ( n + 1 )}{63}} for n = 0 , … , 30 \\ {p}_{u} ( n ) = {p}_{u} ( 61 - n ) for n = 31 , … , 61 \qquad Eq . 13$$

where u={25, 29, 34}.

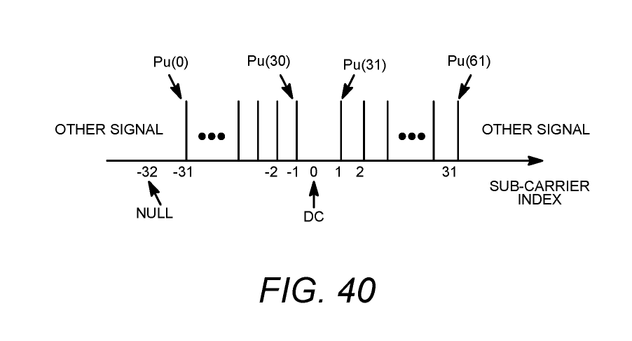

FIG. 40 is an example of mapping a PSS sequence to subcarriers. A pᵤ (n) sequence may be mapped to central subcarriers around a DC subcarrier in the frequency-domain. There may be different indexing schemes in the MIMO Receiver ACD.

A zero may be mapped on subcarrier index −32, for example, to generate a time-domain replica of the PSS sequence of size M=64. Mapping may be in conjunction with the ZC sequence and an FFT of size 64, which may provide a time-domain sequence of size 64. A time domain PSS sequence may be expressed in accordance with Eq. 14:

sᵢ=IFFT₆₄([0pᵤ(31:61)0pᵤ(0:30)]) iε{0,1,2} Eq. 14

A DFT sequence for a specific frequency offset εⱼ may be generated, for example, as shown in Eq. 15:

$${e}_{{ɛ}_{j}} ( m ) = {e}^{j \frac{2 π m {ɛ}_{j}}{M}} for m = 0 , … , M - 1 \qquad Eq . 15$$

For example, εⱼ=½ may be for frequency offset=7.5 KHz and εⱼ=¼ may be for frequency offset=3.75 KHz. A SYNC sequence for a specific frequency offset εⱼ may be generated, for example, as shown in Eq. 16:

c_{i,ε}_{ⱼ}(m)=sᵢ(m)e_{ε}_{ⱼ}(m) for m=0, . . . ,M−1 Eq. 16

A SYNC sequence may be written in vector form as a SYNC sequence vector c_{i,ε}_{ⱼ}=sᵢ·e_{ε}_{ⱼ}, where · denotes a Hadamard vector operation.

Notation may be simplified by simplifying the notation of r_{q,ε}_{ⱼ}⁽ⁱ⁾(d) as r_{q}⁽ⁱ⁾(d) and c_{i,ε}_{ⱼ} as cᵢ. An FFT-based correlator may be implemented, for example, because FFT-based algorithms may reduce computational complexity. An overlap-save method may be used, for example, because an overlap-add method may result in more computations than in an overlap-save method.

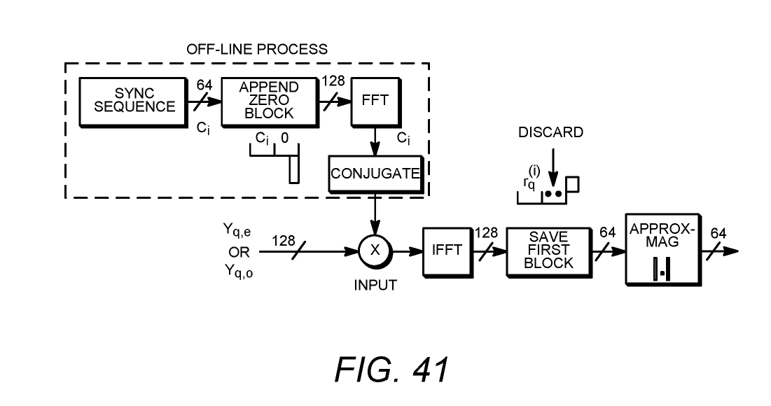

FIG. 41 is an example of an FFT-based correlator. An FFT-based correlator may be a one-part correlator scheme for qth antenna and for a (e.g. only one) PSS sequence.

For example, for the ith PSS sequence of size M, a sequence may be padded with an equal number of zeros. An N-point FFT may be used for the computation, for example, where N=2M. An N×1 vector Cᵢ may denote FFT processed coefficients of a zero padded PSS sequence, cᵢ, iε{1, 2, 3}, according to Eq. 17:

$${C}_{i} = FFT [ \begin{matrix}{c}_{i} \\ 0\end{matrix} ] \qquad Eq . 17$$

where 0 may be an M×1 null vector and FFT[ ] may denote a Fast Fourier Transform.

A frequency-domain Y_{q,e} (k) may denote an N×1 vector derived from the concatenation of two received blocks of size M×1 at qth antenna and even phase according to Eq. 18 and for odd phase according to Eq. 19:

$$\begin{matrix}{Y}_{q , e} ( k ) = F F T [ \begin{matrix}\underbrace{{y}_{q} ( ( k - 1 ) N - N ) , {y}_{q} ( ( k - 1 ) N - N + 2 ) … , {y}_{q} ( ( k - 1 ) N - 2 ) ,}_{k - 1 th block} \\ \underbrace{{y}_{q} ( kN - N ) , {y}_{q} ( kN - N + 2 ) … , {y}_{q} ( kN - 2 )}_{k - th block}\end{matrix} ] & Eq . 18 \\ {Y}_{q , o} ( k ) = F F T [ \begin{matrix}\underbrace{{y}_{q} ( ( k - 1 ) N - N + 1 ) , {y}_{q} ( ( k - 1 ) N - N + 3 ) … , {y}_{q} ( ( k - 1 ) N - 1 ) ,}_{k - 1 th block} \\ \underbrace{{y}_{q} ( kN - N + 1 ) , {y}_{q} ( kN - N + 3 ) … , {y}_{q} ( kN - 1 )}_{k - th block}\end{matrix} ] & Eq . 19\end{matrix}$$

An overlap-save method may be performed, for example, to perform linear correlation that yields the M×1 vector for even phase according to Eq. 20:

$$\begin{matrix}{r}_{q , e}^{( i )} ( k ) = {[ {r}_{q , e}^{( i )} ( kM - M ) , {r}_{q , e}^{( i )} ( kM - M + 1 ) , … , {r}_{q , e}^{( i )} ( kM - 1 ) ]}^{T} \\ = first M elementsof I F F T [ {Y}_{q , e} ( k ) \cdot {C}_{i}^{*} ]\end{matrix} \qquad Eq . 20$$

where IFFT[ ] denotes an inverse Fast Fourier Transform.

In an example, the first M elements may be retained and the last M elements may be discarded from the output. An overlap-save method may be performed, for example, to perform linear correlation that yields the M×1 vector for odd phase according to Eq. 21:

$$\begin{matrix}{r}_{q , o}^{( i )} ( k ) = {[ {r}_{q , o}^{( i )} ( kM - M ) , {r}_{q , o}^{( i )} ( kM - M + 1 ) , … , {r}_{q , o}^{( i )} ( kM - 1 ) ]}^{T} \\ = first M elementsof I F F T [ {Y}_{q , o} ( k ) \cdot {C}_{i}^{*} ]\end{matrix} \qquad Eq . 21$$

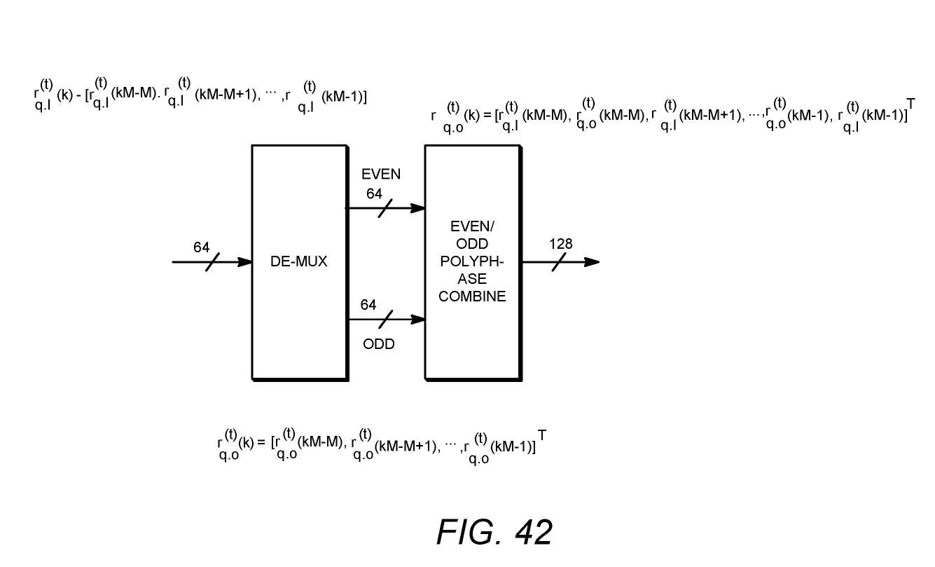

FIG. 42 is an example of even and odd polyphase combining. Even and odd polyphase output may be combined, as represented by Eq. 22:

r_{q}⁽ⁱ⁾(k)=[r_{q,e}⁽ⁱ⁾(kM−M),r_{q,o}⁽ⁱ⁾(kM−M),r_{q,e}⁽ⁱ⁾(kM−M+1), . . . ,r_{q,e}⁽ⁱ⁾(kM−1),r_{q,o}⁽ⁱ⁾(kM−1)]^{T} Eq. 22

A magnitude of the output of the correlator may be computed, for example, according to Eq. 23. The magnitude may be accumulated in a correlation buffer.

approx−mag(x)=max(real(|x|),imag(|x|))+0.5*min(real(|x|),imag(|x|)) Eq. 23

In a peak detector mode, an LTE Cell Search primitive may, for example, find the strongest cell in a specified carrier frequency/raster. Other types of cell search primitives may be implemented.

An exact location of an OFDM symbol containing a PSS from the output of a MIMO combiner may be detected using a peak detector, for example, with a probability (e.g. a small probability) of false alarm. The peak detector may examine samples at the output of a MIMO combiner to determine the maximum sample value and its location. In an example, a total number of samples needed to be examined by the peak detector corresponding to each PSS sequence may be equivalent to the number of samples comprising five sub-frames, for example, when the SYNC channel (PSS, SSS) is transmitted every five sub-frames. Continuing with the example, 9600 samples (5 ms×960 kHz) may be processed for each timing estimate update per PSS.

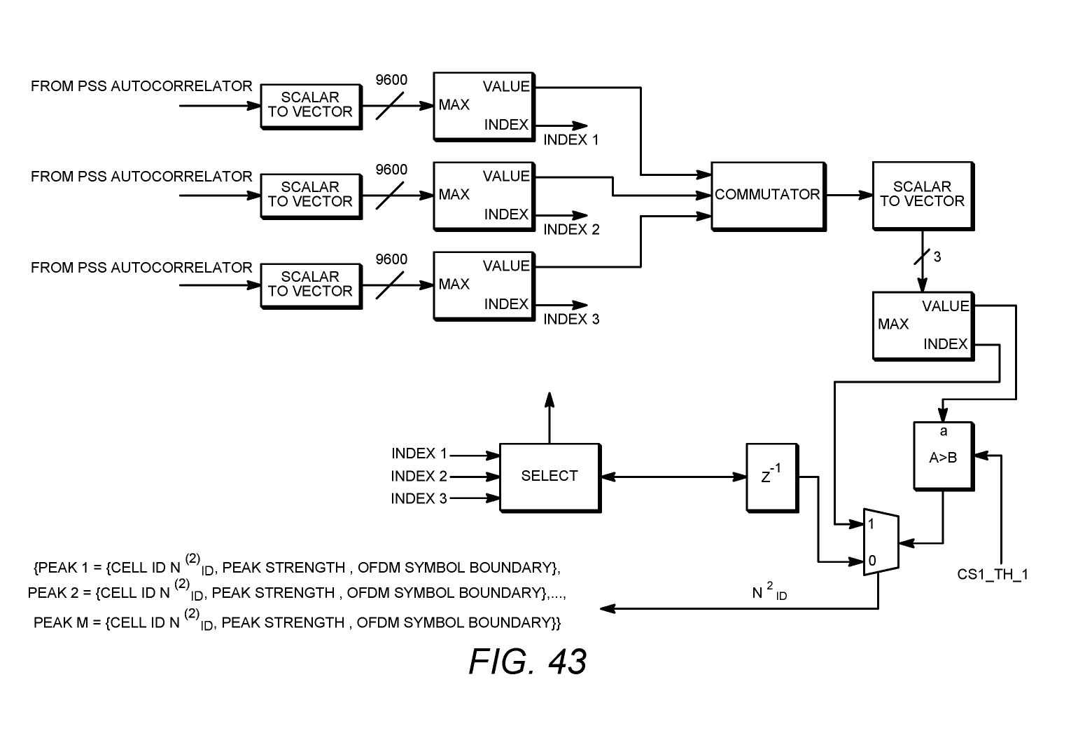

FIG. 43 is a block diagram of an example of a peak detector. A peak detector may determine a magnitude and an index of the maximum sample from the 9600 input samples corresponding to a (e.g. each) of the combined correlator pair outputs. A peak detector may compare multiple (e.g. all) maximum values and may select the highest maximum value. Multiple (e.g. two) threshold tests may be conducted, for example, to reduce a probability of false alarm. A test may be represented by Eq. 24, which may determine whether the magnitude of the maximum sample exceeds a predefined threshold, CS1_TH_1(l), multiplied by the combined received signal power:

$${R}_{max} ( d ) = {arg max}_{i , {ɛ}_{j}} \{ {R}_{{ɛ}_{j}}^{( i )} ( d ) , i ∈ \{ 0 , 1 , 2 \} \} \\ \hat{d} = {arg max}_{d} \{ {R}_{max} ( d ) > CS\_TH \_ 1 ( l ) , 0 \leq d \leq 9600 - 1 \} \qquad Eq . 24$$

A detected PSS index i and εⱼ may maximize the function. A physical-layer identity within a physical-layer cell-identity group may be denoted as N_{ID}⁽²⁾. N_{ID}⁽²⁾ parameter and a physical-layer cell-identity group parameter N_{ID}⁽¹⁾, which may be detected in a second stage of CS, may uniquely define a physical-layer cell identity according to Equation 25:

N_{ID}^{cell}=3N_{ID}⁽¹⁾+N_{ID}⁽²⁾ Eq. 25

The parameter N_{ID}⁽²⁾ may be communicated to start-up AFC and to a second stage of CS. A threshold test may mitigate the effect of fading channels on the timing estimate. SYNC signal detection may be declared, for example, when multiple threshold tests are passed.

A (e.g. second) threshold test may be applied, for example, during an initial CS. A second threshold test may be bypassed in other modes, for example, when an assumption may be made that the CFO has been compensated. A second test may be bypassed for a first call to the function, e.g. to initialize the function.

Peak detection may be performed periodically, e.g., every 5 ms. A unique threshold CS1_TH_1(l) may be specified for a (e.g. each) peak detection period. A peak output may be represented by Eq. 26:

{Peak₁={N_{ID}⁽²⁾ peak strength OFDM Symbol boundary},Peak₂={N_{ID}⁽²⁾ peak strength OFDM Symbol boundary}, . . . ,Peakₘ={N_{ID}⁽²⁾ peak strength OFDM Symbol boundary}} Eq. 26

M highest peaks (e.g. across N_{ID}⁽²⁾) may be reported during initial CS, for example, when more than zero peaks pass the CS1_TH_1(l) threshold at the l-th interval (e.g. 5 msec). M peaks may be reported in a cell reselection/targeted CS mode, for example, when a peak exceeds the CS1_TH_1(l) threshold at the l-th interval (e.g. 5 msec). M peaks may be distributed (e.g. equally distributed) between the three N_{ID}⁽²⁾.

AFC (e.g. a first stage or Stage 1 in AFC) may provide a coarse frequency correction, for example, to pull in the oscillator to within a range of the correct frequency. An AFC algorithm may estimate an integer frequency offset and/or a fractional frequency offset (FFO). An integer frequency offset may occur as multiples of a frequency (e.g. 15 KHz). An AFC may apply an estimate to the radio front end.

A first FO estimate in a first stage (e.g. stage-1) of CS may be referred to as “Cold-Start AFC.” A Cold-Start AFC estimate may comprise an IFO and FFO, e.g., for the radio front end. Subsequent frequency correction may occur, for example, using estimates from partial knowledge of CP and PSS. Subsequent frequency correction may be referred to as “CP-Based AFC” and “SS-based AFC,” respectively. Estimates may be accumulated in the NCO through a time averaging filter.

AFC design may be closed loop. An AFC algorithm may provide a sequence in which the different sources of frequency estimation trigger. There may be a variety of types of AFC algorithms.

A cold start AFC algorithm may provide PSS correlation metrics β_{τ,ε} for one or more (e.g. every) time instant τ frequency bins with center frequency ε and spacing S. A Cold-Start estimate εₑₛₜ may be obtained, for example, through parabolic interpolation.

A bin with center frequency εₘₐₓ, where the largest metric βₘₐₓ may be observed at τₘₐₓ across all frequency bins and timing, may be a mid-point in parabolic interpolation. βₘₐₓ may be represented by Eq. 27:

$${β}_{max} = {max}_{∀ τ , ɛ} ( {β}_{τ , ɛ} ) \qquad Eq . 27$$

A metric β_{left} on the left in a parabolic interpolation may be selected from the bin εₘₐₓ₋₁ according to Eq. 28:

β_{left}=max(β_{τ}_{ₘₐₓ}_{-1,ε}_{ₘₐₓ}₋₁,β_{τ}_{ₘₐₓ}_{,ε}_{ₘₐₓ}₋₁,β_{τ}_{ₘₐₓ}_{+1,ε}_{ₘₐₓ}₋₁) Eq. 28

A metric β_{right} on the right in a parabolic interpolation may be selected from the bin εₘₐₓ₊₁ according to Eq. 29:

β_{right}=max(β_{τ}_{ₘₐₓ}_{-1,ε}_{ₘₐₓ}₊₁,β_{τ}_{ₘₐₓ}_{,ε}_{ₘₐₓ}₊₁,β_{τ}_{ₘₐₓ}_{+1,ε}_{ₘₐₓ}₊₁) Eq. 29

An estimate εₑₛₜ may be computed according to Eq. 30:

$${ɛ}_{est} = \frac{S}{4} \frac{{β}_{left} - {β}_{right}}{{β}_{left} - 2 {β}_{max} + {β}_{right}} + {ɛ}_{max} \qquad Eq . 30$$

A Cold-Start estimate ε_{CS-est} may be obtained, for example, by averaging N εₑₛₜ estimates.

A CP signal may occur for a duration (e.g. 5.2083 us) at the beginning of a slot and for a duration (e.g. 4.6875 us) starting at a time (e.g. 61.9795 us) from the beginning of a slot, for example, for normal and extended CP symbols. In an example, a sampling rate of 1.92 MHz may translate to 10 samples in the 0^{th} symbol and 9 CP samples in the last symbol of a slot. Slot timing may be obtained from PSS peak detection. Samples may be used to generate a CP-based frequency offset estimate, for example, even though the CP types may be unknown.

For example, rₖ may correspond to received samples. Sample r₀ may correspond to a first sample in a slot. CP-based frequency estimate ε_{CP-est} may be determined, for example, using Eq. 31:

$${ɛ}_{CP - est} = arg ( {\sum }_{i = 1}^{K} ( {\sum }_{k = 0}^{9} {r}_{k} \cdot {r}_{k + 128}^{*} + {\sum }_{k = 823}^{831} {r}_{k} \cdot {r}_{k + 128}^{*} ) ) \qquad Eq . 31$$

where K may be the number of slots over which the averaging is performed.

A startup AFC may lower an initial CFO (e.g. initial CS or power up), for example, from ±25 ppm to less than ±1 ppm, which may correspond to lowering a frequency error of approximately ±50 kHz to less than ±2 kHz at carrier frequencies near 2 GHz. Other, e.g., higher, carrier frequencies may be supported with various startup AFC designs. A sampling error for startup AFC to function within its nominal range may be within ±10 samples.

Table 53 illustrates examples of inputs for CS stage 1:

TABLE 53
Example of CS Stage 1 Inputs

| Name | Description | Source | Comment |
|---|---|---|---|
| Y_{q=1} | Received samples | RF (NCO output) | @ 1.92 MHz |
| | from Rx antenna 1 | | sampling rate |
| Y_{q=2} | Received samples | RF (NCO output) | @ 1.92 MHz |
| | from Rx antenna 2 | | sampling rate |
| | (NA for Cat-0 | | |
| | WTRU) | | |

Table 54 presents an example of outputs for CS stage 1.

TABLE 54
Example of CS Stage 1 Outputs

| Name | Description | Comment |
|---|---|---|
| N_{ID}⁽²⁾ | physical-layer identity | Range: 0 to 2 |
| OST | OFDM symbol beginning | Range: 0 to 9599 |

Table 55 presents an example of outputs for CS stage 1.

TABLE 55
Example of CS Stage 1 Parameters

| Name | Description | Comment |
|---|---|---|
| nRxAnt | # of | For Cat-0 WTRU, nRxAnt = |
| | received | 1, q = 1, otherwise nRxAnt = |
| | antennas | 2. q = 1, 2 |
| CS1_accum | # of | Default = 10 (i.e., 10 × 5 = 50 ms |
| | accumulations of | accumulation) |
| | 5 ms window | |
| CS1_TH_1(l) | Threshold for | l = 1, 2, . . . , CS1_accum |
| | stage-1 of Peak | |
| | detector at | |
| | accumulation | |
| | level l | |

A second stage of Cell Search (e.g. CS Stage 2) may extract information from received SSS signals. As an example, CS stage 2 may extract Cell ID group (0˜167) N_{ID}⁽¹⁾, frame boundary (e.g. sub-frame 0 or 5) and/or CP length (e.g. short or long).

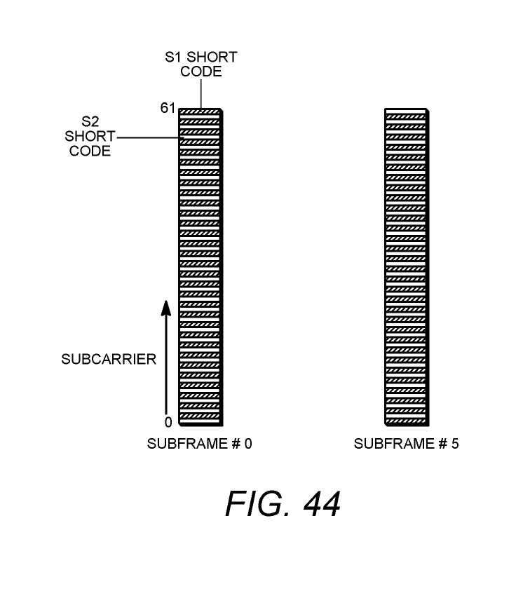

FIG. 44 is an example of subcarrier mapping for two SSS short sequences. For example, a plurality of (e.g. 62) subcarriers of SSS may be interlaced with, for example, two length-31 binary sequences, s0 and s1. An interlaced sequence may be scrambled. Eq. 32 presents an a scrambling example where an interlaced sequence is scrambled with a scrambling sequence, e.g. c0 and c1, given by a primary synchronization signal, and scrambled by a scrambling sequence, z1. A combination of two length-31 sequences defining an SSS signal may differ between sub-frame 0 and sub-frame 5 according to Eq. 32:

$$\begin{matrix}d ( 2 n ) = \{ \begin{matrix}{s}_{0}^{( {m}_{0} )} ( n ) {c}_{0} ( n ) & in subframe 0 \\ {s}_{1}^{( {m}_{1} )} ( n ) {c}_{0} ( n ) & in subframe 5\end{matrix} & Eq . 32 \\ d ( 2 n + 1 ) = \{ \begin{matrix}{s}_{1}^{( {m}_{1} )} ( n ) {c}_{1} ( n ) {z}_{1}^{( {m}_{0} )} ( n ) & in subframe 0 \\ {s}_{0}^{( {m}_{0} )} ( n ) {c}_{1} ( n ) {z}_{1}^{( {m}_{1} )} ( n ) & in subframe 5\end{matrix} & \end{matrix}$$

where 0≦n≦30. Binary sequences (s₀, s₁), (c₀, c₁), and z₁ may be maximal length sequences generated, for example, according to a generation function of x⁵+x²+1, x⁵+x³+1, and x⁵+x⁴+x²+x+1 respectively. Indices m₀ and m₁ may represent cyclic shifts and may be derived from a physical-layer cell-identity group N_{ID}⁽¹⁾.

One or more modes of operation may comprise one or more antenna configurations. An antenna configuration may be, for example, 1×1, e.g., one transmit antenna by one receive antenna. An antenna configuration may be, for example, 1×2, e.g., one transmit antenna by two receive antennas.

Cell Search Stage 1 may correct timing and frequency offset, for example, within a range of [±0.7] ppm. CS stage 1 may provide a number N_{ID}⁽²⁾, for example, in the range of 0 to 2, where the number may represent a physical-layer identity within a physical-layer cell-identity group. Received P-SCH and S-SCH may be obtained, for example, by passing time domain signals through an LPF.

One or more algorithms may be defined to perform one or more functions. For example, one or more functions may comprise, preprocessing for a received S-SCH, short and long CP removal, 128-point FFT, demapping resource elements to S-SCH sequences, channel estimation based on the knowledge of the P-SCH sequence, successive interference cancellation (SIC) based on the knowledge of cell IDs, S-SCH symbol estimation, detection for S-SCH symbol, averaging S-SCH symbols for multiple frames/time slots, S-SCH sequence decoding and detection, detection of indices m₀ and m₁ for physical-layer cell identity group N_{ID}⁽¹⁾, CP length or type (e.g. normal or extended) detection (e.g. distinguishing long or short CP), detection of frame boundary (e.g. sub-frame 0 or 5), cell ID computation and confirmation.

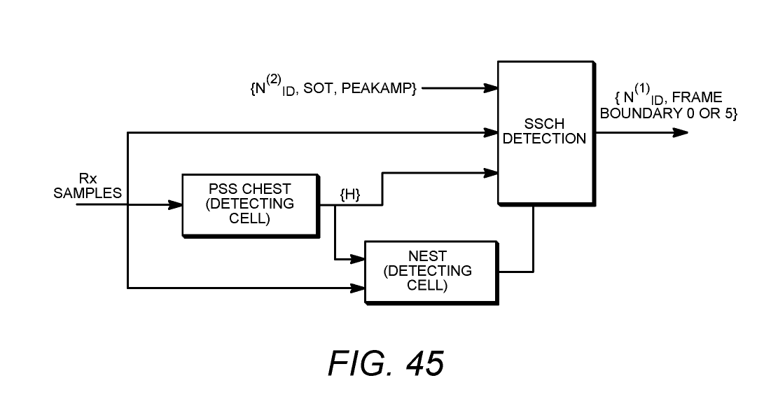

FIG. 45 is a diagram of an example of a second stage of cell search. One or more, for example two, sets of data samples associated with long and short CP may be obtained from received time domain S-SCH signals, for example, by removing long and short CP respectively.

Table 56 presents an example of OFDM parameters for N=2048.

TABLE 56
Example of OFDM Parameters for N = 2048

| | |
|---|---|
| Configuration | Cyclic prefix length N_{CP,l} |

| | | |
|---|---|---|
| Normal cyclic | | 160 for l = 0 |
| prefix | Δf = 15 kHz | 144 for l = 1, 2, . . . , 6 |
| Extended cyclic | Δf = 15 kHz | 512 for l = 0, 1, . . . , 5 |
| prefix | Δf = 7.5 kHz | 1024 for l = 0, 1, 2 |

Cyclical prefix (CP) lengths may be linearly scaled for a 128-point FFT. A length of the short CP may be 144×(128/2048)=9 and a length of the long CP may be 512×(128/2048)=32. One or more, for example two, sets of CP-removed time domain S-SCH signals may be transformed to frequency domain signals, for example, by 128-point FFTs and may be demapped to resource elements on central subcarriers around the DC subcarrier to the sequences of S-SCH. Short and long frequency domain data sets may be passed to an identical CS stage-2 detection and decoding processor. A detector may be shared for long and short CP detections by sequential processing.

A processing flow of cell search stage 2 functions may comprise, for example, two hypotheses for normal/extended CP, two hypotheses for subframe timing (e.g. 0 or 5), 168 hypotheses for nid1. CS stage-2 detection and decoding may have subfunctions.

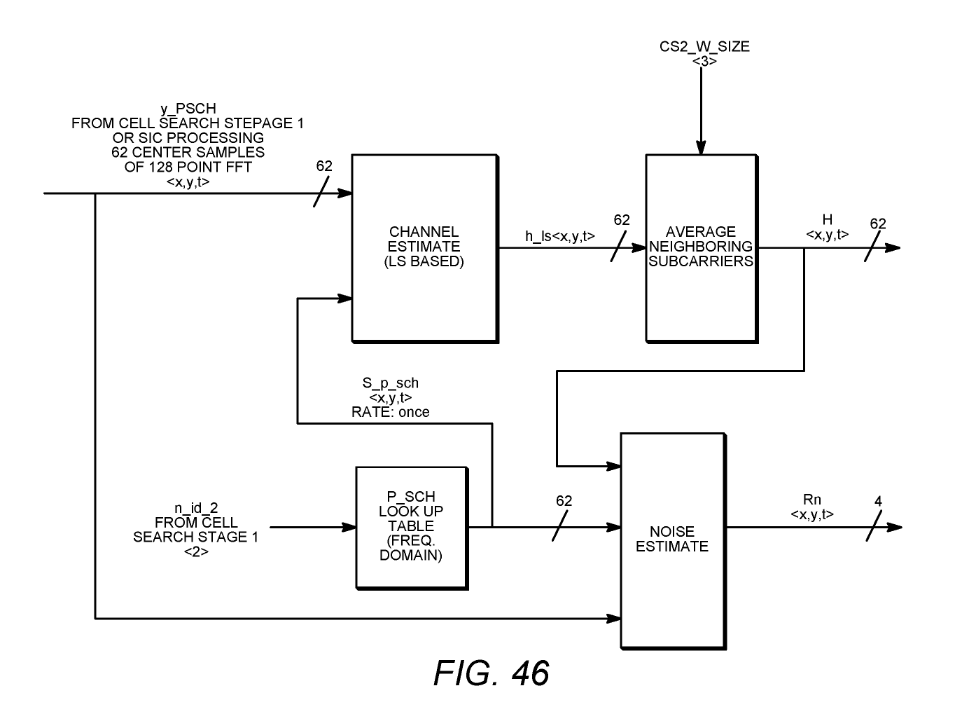

FIG. 46 is a diagram of an example of channel estimation (CHEST) and/or noise estimation (NEST) based on knowledge of P-SCH.

Channel information at subcarrier k, H(k), may be estimated, for example, by implementing a least square (LS) estimation based on the P-SCH signal according to Eq. 33:

H_{LS}(k)=y_{PSCH}(k)/s_{PSCH}(k) for k=0, . . . ,61 Eq. 33

where y_{PSCH}(k) may be received P-SCH samples in the frequency domain and s_{PSCH}(k) may be a known P-SCH sequence at subcarrier k, which may be a Zadoff-Chu sequence. One or more (e.g. each) element of the P-SCH sequences (1/s_{PSCH}(k)) may be inverted and stored in a look-up-table (LUT).

H(k) may be improved, for example, by averaging neighboring subcarriers with a sliding window according to Eq. 34, Eq. 35 and Eq. 36:

$$\begin{matrix}H ( k ) = \frac{1}{W} {\sum }_{i = 0}^{W - 1} {H}_{LS} ( i ) for k = 0 , … , {W}_{L} - 1 & Eq . 34 \\ H ( k ) = \frac{1}{W} {\sum }_{i = k - {W}_{L}}^{k + {W}_{H}} {H}_{LS} ( i ) for k = {W}_{L} , {W}_{L + 1 ,} … , 61 - {W}_{H} & Eq . 35 \\ H ( k ) = \frac{1}{W} {\sum }_{i = 61 - W + 1}^{61} {H}_{LS} ( i ) for k = 61 - {W}_{H} + 1 , … , 61 & Eq . 36\end{matrix}$$

where W may be the size of a sliding window, WL may be a floor(W/2), and WH may be W−WL−1.

Noise power, Rn, may be estimated, for example, based on received P-SCH according to Eq. 37 and Eq. 38:

$$\begin{matrix}{R}_{n} = \frac{1}{62} {\sum }_{k = 0}^{61} \tilde{n} ( k ) {\tilde{n} ( k )}^{*} & Eq . 37 \\ \tilde{n} ( k ) = {y}_{P - SCH} ( k ) - H ( k ) {s}_{P - SCH} ( k ) , k = 0 , … , 61 & Eq . 38\end{matrix}$$

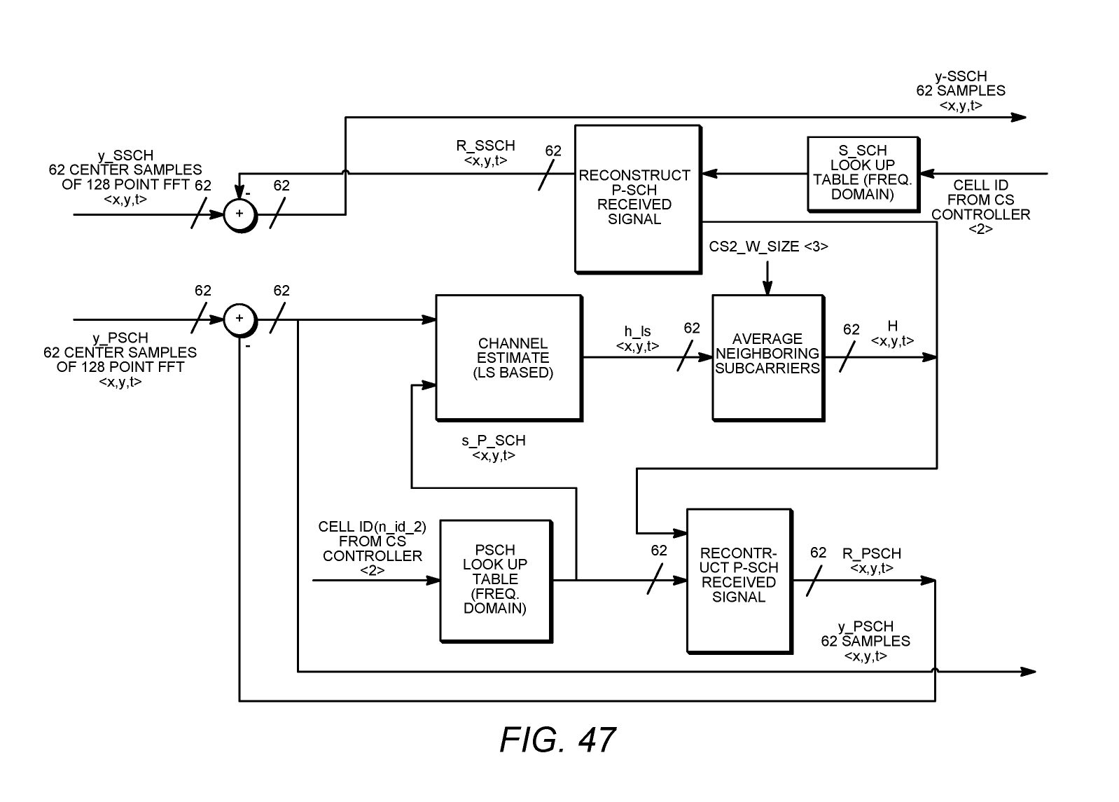

FIG. 47 is a diagram of an example of an SIC processor. A CS controller may control (e.g. turn on and off) a successive interference cancellation (SIC) processor, for example, based on knowledge of interferers. A CS controller may provide a number of interferers and their cell IDs in order of the power of the interferers (e.g. strongest power first). A sequence of S-SCH codes for reconstruction of the S-SCH signal may be generated, for example, based on the cell ID. N_{ID}⁽¹⁾ and N_{ID}⁽²⁾ may be computed from cell ID N_{ID}^{cell} according to Eq. 39 and Eq. 40:

$$\begin{matrix}{N}_{ID}^{( 2 )} = {N}_{ID}^{cell} mod 3 & Eq . 39 \\ {N}_{ID}^{( 1 )} = ⌊ \frac{{N}_{ID}^{cell}}{3} ⌋ & Eq . 40\end{matrix}$$

For example, m₀ and m₁ may be computed from N_{ID}⁽¹⁾, which may be implemented as an LUT.

SIC processing may be performed, for example, sequentially for all interferers such that the strongest interferer may be removed from received signals first. An example of SIC processing may be: (a) perform i=1 to N (for all interferers, the strongest one first), (b) estimate H from CHEST (input: y_{PSCH}ⁱ⁻¹), s_{PSCH}ⁱ(k)) based on P-SCH, (c) construct and subtract interference signal according to Eq. 41 and Eq. 42:

y_{PSCH}ⁱ(k) [symbol] y_{PSCH}ⁱ⁻¹(k)−Hⁱ(k)s_{P-SCH}ⁱ(k), k=0, . . . ,61 Eq. 41

y_{SSCH}ⁱ(k) [symbol] y_{SSCH}ⁱ⁻¹(k)−Hⁱ(k)s_{P-SCH}ⁱ(k), k=0, . . . ,61 Eq. 42

where y_{PSCH}⁰(k) is the received P-SCH signal and y_{SSCH}⁰(k) is the received S-SCH signal.

A CS controller may generate an CS2_SIC_Enable flag, for example, based on one or more prerequisites. Examples of prerequisites may be, for example: N_{ID}⁽²⁾ of multi-cells should be different, received signals from multi-cell should be aligned in time within a number of samples in terms of the 128-point FFT, CP lengths of multi-cells should be identical.

Binary data of an S-SCH symbol for short CP and/or long CP may be estimated by an MMSE detector, for example, according to Eq. 43:

\tilde{d}_{SSCH}(k)=real{(Rₛ⁻¹+H*(k)Rₙ⁻¹H(k))⁻¹H(k)*Rₙ⁻¹y_{SSCH}(k)} k=0, . . . ,61 Eq. 43

where Rₛ may be normalized signal power, e.g., an identity matrix with the size of the number of transmit antennas, and Rₙ may be noise and interference power from a NEST.

Frame timing might not be known. Combinations of two length-31 sequences that define the S-SCH signal may differ between sub-frame 0 and sub-frame 5 as shown in equations. Estimated S-SCH symbols may be accumulated into multiple (e.g. two) separate (e.g. even and odd) accumulators, which may alternate for multiple frames, e.g., starting with the even accumulator. Even/odd accumulation may be performed, for example, according to Eq. 44 and Eq. 45:

\tilde{d}^{EvenAcc}(k,i)=\tilde{d}^{EvenAcc}(k,i−1)+\tilde{d}_{SSCH}(k,i) for k=0, . . . ,61 Eq. 44

\tilde{d}^{OddAcc}(k,i)=\tilde{d}^{OddAcc}(k,i−1)+\tilde{d}_{SSCH}(k,i) for k=0, . . . ,61 Eq. 45

Even/odd averaging may be performed, for example, according to Eq. 46 and Eq. 47:

\tilde{d}^{EvenAv}(k,i)=\tilde{d}^{EvenAcc}(k,i)/i for k=0, . . . ,61 Eq. 46

\tilde{d}^{OddAv}(k,i)=\tilde{d}^{OddAcc}(k,i)/i for k=0, . . . ,61 Eq. 47

For example, \tilde{d}^{OddAcc}(k,0) and \tilde{d}^{EvenAcc}(k,0) may be initialized to 0 for multiple (e.g. all) subcarriers k, and i may be the number of accumulations. For example, i may be limited by the parameter of the maximum number of accumulations Max_FrIntg_Count. The same processing may be performed for long and short CP.

Indices m₀ and/or m₁ may be derived from a physical-layer cell-identity group N_{ID}⁽¹⁾, for example, according to Eq. 48:

$${m}_{0} = {m}^{′} mod 31 \\ {m}_{1} = ( {m}_{0} + ⌊ {m}^{′} / 31 ⌋ + 1 ) mod 31 \\ {m}^{′} = {N}_{ID}^{( 1 )} + q ( q + 1 ) / 2 , q = ⌊ \frac{{N}_{ID}^{( 1 )} + {q}^{′} ( {q}^{′} + 1 ) / 2}{30} ⌋ , \\ {q}^{′} = ⌊ {N}_{ID}^{( 1 )} / 30 ⌋ \qquad Eq . 48$$

Sequences s₀^{(m}^{₀}⁾(n) and s₁^{(m}^{₁}⁾(n) from x⁵+x²+1 may be defined as two different cyclic shifts of the m-sequence \tilde{s}(n), for example, according to Eq. 49:

s₀^{(m}^{₀}⁾(n)=\tilde{s}((n+m₀) mod 31)

s₁^{(m}^{₁}⁾(n)=\tilde{s}((n+m₁) mod 31) Eq. 49

where \tilde{s}(i)=1−2x(i), 0≦i≦30, may be defined by Eq. 50:

x(ī+5)=(x(ī+2)+x(i̅))mod 2, 0≦ī≦25 Eq. 50

For example, initial conditions may be x(0)=0, x(1)=0, x(2)=0, x(3)=0, x(4)=1.

Scrambling sequences c₀(n) and c₁(n) from x⁵+x²+1 may depend on a primary synchronization signal and/or may be defined by at least two different cyclic shifts of the m-sequence \tilde{c}(n), for example, according to Eq. 51:

c₀(n)=\tilde{c}((n+N_{ID}⁽²⁾) mod 31)

c₁(n)=\tilde{c}((n+N_{ID}⁽²⁾+3) mod 31) Eq. 51

where N_{ID}⁽²⁾ε{0, 1, 2} may be a physical-layer identity within the physical-layer cell identity group N_{ID}⁽¹⁾ and where \tilde{c}(i)=1−2x(i), 0≦i≦30, may be defined by Eq. 52:

x(ī+5)=(x(ī+3)+x(i̅)) mod 2, 0≦ī≦25 Eq. 52

For example, initial conditions may be x(0)=0, x(1)=0, x(2)=0, x(3)=0, x(4)=1.

Scrambling sequences z₁^{(m}^{₀}⁾(n) and z₁^{(m}^{₁}⁾(n) from x⁵+x⁴+x²+x+1 may be defined by a cyclic shift of the m-sequence \tilde{z}(n), for example, according to Eq. 53 and Eq. 54:

z₁^{(m}^{₀}⁾(n)=\tilde{z}((n+(m₀ mod 8)) mod 31) Eq. 53

z₁^{(m}^{₁}⁾(n)=\tilde{z}((n+(m₁ mod 8)) mod 31) Eq. 54

where \tilde{z}(i)=1−2x(i), 0≦i≦30, may be defined by Eq. 55:

x(ī+5)=(x(ī+4)+x(ī+2)+x(ī+1)+x(i̅)) mod 2, 0≦ī≦25 Eq. 55

For example, initial conditions may be x(0)=0, x(1)=0, x(2)=0, x(3)=0, x(4)=1.

Sequences of s(=s₀^{(m}^{₀}⁾ and s₁^{(m}^{₁}⁾), c(=c₀ and C₁), and z₁(=z₁^{(m}^{₀}⁾ and z₁^{(m}^{₁}⁾) may be stored as look-up tables for (e.g. only for) zero cyclic shift, (e.g. m₀=0, m₁=0, and N_{ID}⁽²⁾=0).

Table 57 presents an example of mapping between cell-identity Group N_{ID}⁽¹⁾ and the Indices m₀ and m₁.

TABLE 57
Example of Mapping Between Cell-identity
Group N_{ID}⁽¹⁾ and the Indices m₀ and m₁

| N_{ID}⁽¹⁾ | m₀ | m₁ |
|---|---|---|
| 0 | 0 | 1 |
| 1 | 1 | 2 |
| 2 | 2 | 3 |
| 3 | 3 | 4 |
| 4 | 4 | 5 |
| 5 | 5 | 6 |
| 6 | 6 | 7 |
| 7 | 7 | 8 |
| 8 | 8 | 9 |
| 9 | 9 | 10 |
| 10 | 10 | 11 |
| 11 | 11 | 12 |
| 12 | 12 | 13 |
| 13 | 13 | 14 |
| 14 | 14 | 15 |
| 15 | 15 | 16 |
| 16 | 16 | 17 |
| 17 | 17 | 18 |
| 18 | 18 | 19 |
| 19 | 19 | 20 |
| 20 | 20 | 21 |
| 21 | 21 | 22 |
| 22 | 22 | 23 |
| 23 | 23 | 24 |
| 24 | 24 | 25 |
| 25 | 25 | 26 |
| 26 | 26 | 27 |
| 27 | 27 | 28 |
| 28 | 28 | 29 |
| 29 | 29 | 30 |
| 30 | 0 | 2 |
| 31 | 1 | 3 |
| 32 | 2 | 4 |
| 33 | 3 | 5 |
| 34 | 4 | 6 |
| 35 | 5 | 7 |
| 36 | 6 | 8 |
| 37 | 7 | 9 |
| 38 | 8 | 10 |
| 39 | 9 | 11 |
| 40 | 10 | 12 |
| 41 | 11 | 13 |
| 42 | 12 | 14 |
| 43 | 13 | 15 |
| 44 | 14 | 16 |
| 45 | 15 | 17 |
| 46 | 16 | 18 |
| 47 | 17 | 19 |
| 48 | 18 | 20 |
| 49 | 19 | 21 |
| 50 | 20 | 22 |
| 51 | 21 | 23 |
| 52 | 22 | 24 |
| 53 | 23 | 25 |
| 54 | 24 | 26 |
| 55 | 25 | 27 |
| 56 | 26 | 28 |
| 57 | 27 | 29 |
| 58 | 28 | 30 |
| 59 | 0 | 3 |
| 60 | 1 | 4 |
| 61 | 2 | 5 |
| 62 | 3 | 6 |
| 63 | 4 | 7 |
| 64 | 5 | 8 |
| 65 | 6 | 9 |
| 66 | 7 | 10 |
| 67 | 8 | 11 |
| 68 | 9 | 12 |
| 69 | 10 | 13 |
| 70 | 11 | 14 |
| 71 | 12 | 15 |
| 72 | 13 | 16 |
| 73 | 14 | 17 |
| 74 | 15 | 18 |
| 75 | 16 | 19 |
| 76 | 17 | 20 |
| 77 | 18 | 21 |
| 78 | 19 | 22 |
| 79 | 20 | 23 |
| 80 | 21 | 24 |
| 81 | 22 | 25 |
| 82 | 23 | 26 |
| 83 | 24 | 27 |
| 84 | 25 | 28 |
| 85 | 26 | 29 |
| 86 | 27 | 30 |
| 87 | 0 | 4 |
| 88 | 1 | 5 |
| 89 | 2 | 6 |
| 90 | 3 | 7 |
| 91 | 4 | 8 |
| 92 | 5 | 9 |
| 93 | 6 | 10 |
| 94 | 7 | 11 |
| 95 | 8 | 12 |
| 96 | 9 | 13 |
| 97 | 10 | 14 |
| 98 | 11 | 15 |
| 99 | 12 | 16 |
| 100 | 13 | 17 |
| 101 | 14 | 18 |
| 102 | 15 | 19 |
| 103 | 16 | 20 |
| 104 | 17 | 21 |
| 105 | 18 | 22 |
| 106 | 19 | 23 |
| 107 | 20 | 24 |
| 108 | 21 | 25 |
| 109 | 22 | 26 |
| 110 | 23 | 27 |
| 111 | 24 | 28 |
| 112 | 25 | 29 |
| 113 | 26 | 30 |
| 114 | 0 | 5 |
| 115 | 1 | 6 |
| 116 | 2 | 7 |
| 117 | 3 | 8 |
| 118 | 4 | 9 |
| 119 | 5 | 10 |
| 120 | 6 | 11 |
| 121 | 7 | 12 |
| 122 | 8 | 13 |
| 123 | 9 | 14 |
| 124 | 10 | 15 |
| 125 | 11 | 16 |
| 126 | 12 | 17 |
| 127 | 13 | 18 |
| 128 | 14 | 19 |
| 129 | 15 | 20 |
| 130 | 16 | 21 |
| 131 | 17 | 22 |
| 132 | 18 | 23 |
| 133 | 19 | 24 |
| 134 | 20 | 25 |
| 135 | 21 | 26 |
| 136 | 22 | 27 |
| 137 | 23 | 28 |
| 138 | 24 | 29 |
| 139 | 25 | 30 |
| 140 | 0 | 6 |
| 141 | 1 | 7 |
| 142 | 2 | 8 |
| 143 | 3 | 9 |
| 144 | 4 | 10 |
| 145 | 5 | 11 |
| 146 | 6 | 12 |
| 147 | 7 | 13 |
| 148 | 8 | 14 |
| 149 | 9 | 15 |
| 150 | 10 | 16 |
| 151 | 11 | 17 |
| 152 | 12 | 18 |
| 153 | 13 | 19 |
| 154 | 14 | 20 |
| 155 | 15 | 21 |
| 156 | 16 | 22 |
| 157 | 17 | 23 |
| 158 | 18 | 24 |
| 159 | 19 | 25 |
| 160 | 20 | 26 |
| 161 | 21 | 27 |
| 162 | 22 | 28 |
| 163 | 23 | 29 |
| 164 | 24 | 30 |
| 165 | 0 | 7 |
| 166 | 1 | 8 |
| 167 | 2 | 9 |
| — | — | — |
| — | — | — |

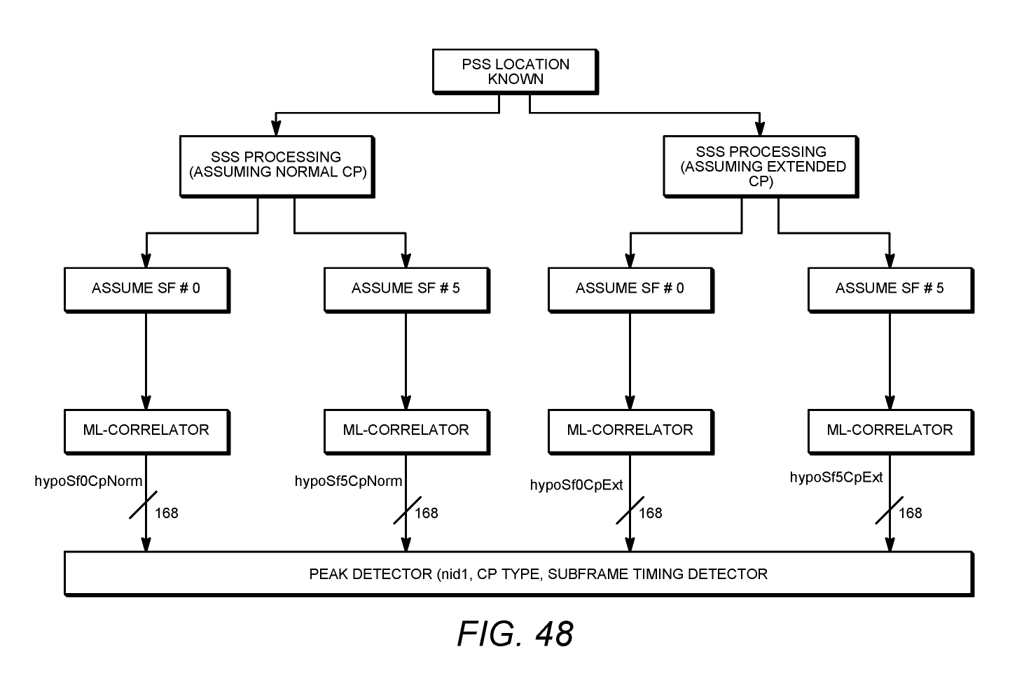

FIG. 48 is a diagram of an example of maximum likelihood based peak detection. In an example, a Maximum Likelihood (ML) detector may be used to detect N_{ID}⁽¹⁾, frame boundary and CP type, for example, from a total of 672 hypotheses−168 (for N_{ID}⁽¹⁾)*2 (for CP type−normal or extended)*2 (for 0^{th} or 5^{th} subframe).

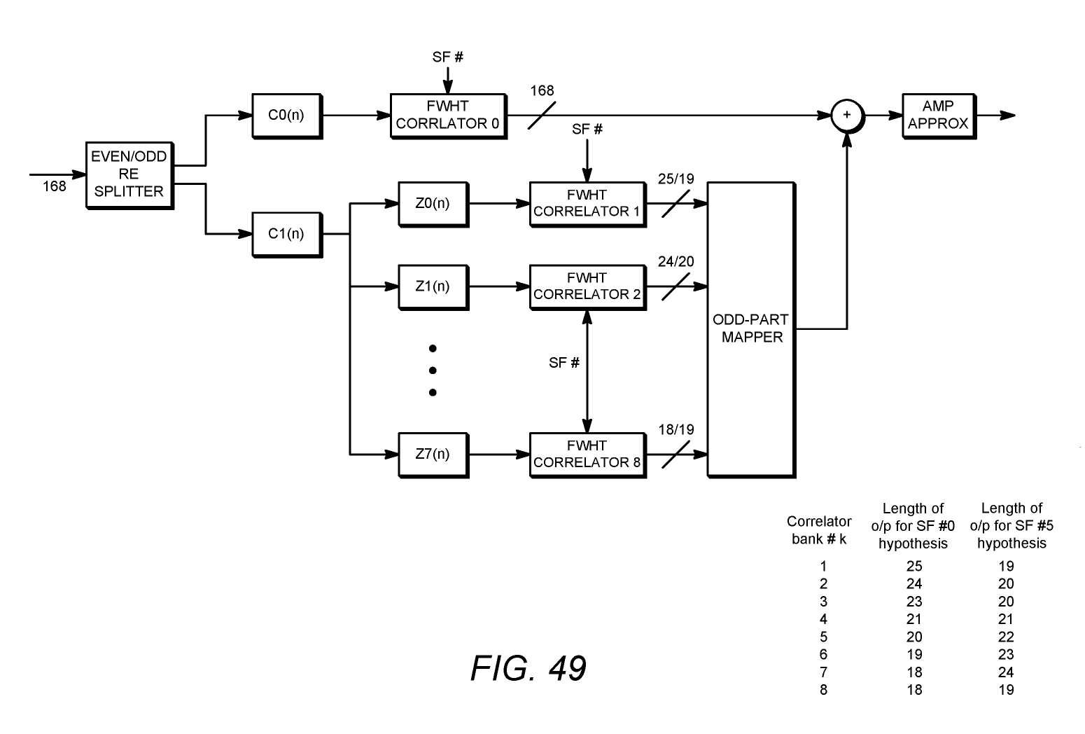

FIG. 49 is a diagram of an example of maximum likelihood based SSS Detection. For example, ML-based SSS detection may have nine ML correlator banks numbered 0-8, with numbers 1-8 on an odd data branch and number 0 on an even data branch, complex i/p, o/p, an i/p length of 31 and a variable number of o/ps. Behavior may depend, for example, on bank number k and on Sf number hypothesis.

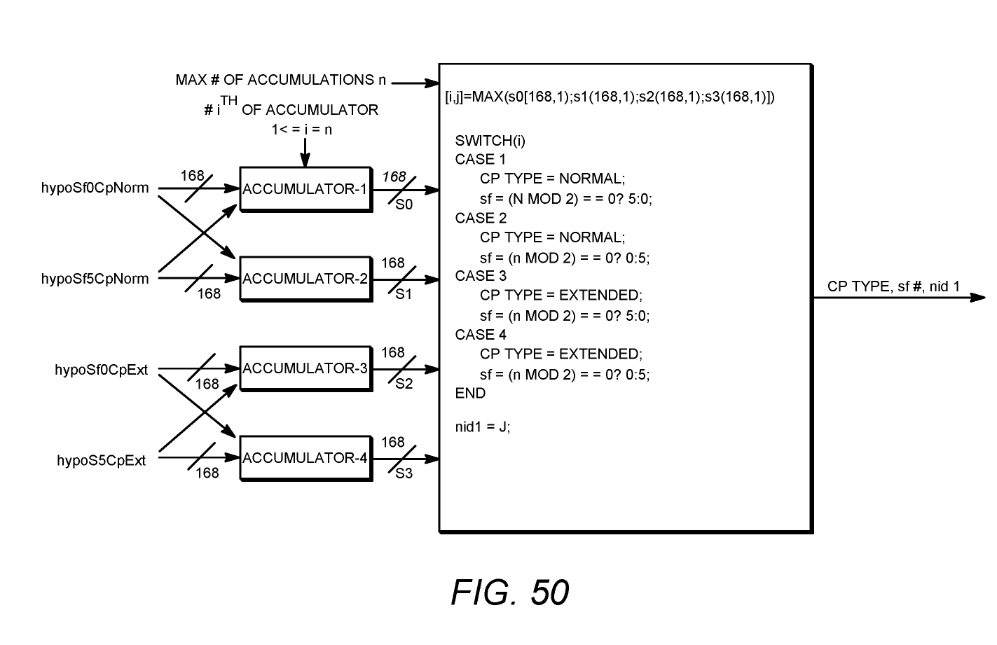

A peak detector may find the peak from a number of (e.g. 672) hypotheses and may output the detected N_{ID}⁽¹⁾, CP type and frame timing. A peak detector may accumulate metrics from the ML-correlator across multiple SSS symbols for one or more (e.g. each) of the assumed CP types and frame timing. Non-coherent accumulation of the peaks may improve the quality of the estimates. Each correlation bank (0-8) in FIG. 20 can be implemented by a modified fast Walsh-Hadamard transform (FWHT) algorithm (e.g., such as a maximum likelihood Fast Wash Hadamard Transform (ML-FWHT). The Indices m₀ and m₁ may be jointly detected in the proposed peak detector illustrated in FIG. 50 and described herein.

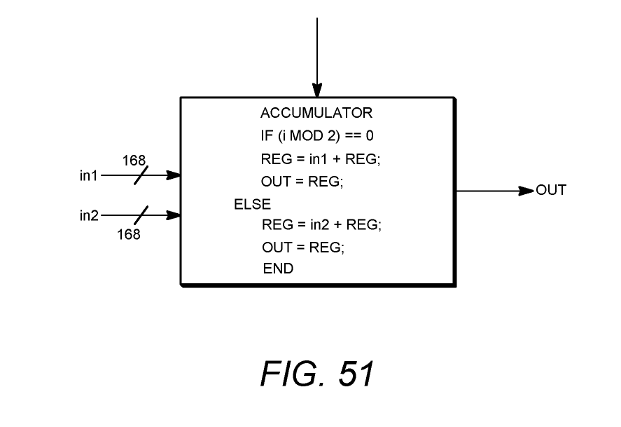

FIG. 50 is a diagram of an example of peak detector logic. A peak detector may have an accumulator. FIG. 51 is a diagram of an example of accumulator logic. For example, a peak detector may have an accumulator for one or more of (e.g. each) of four hypotheses (e.g. normal/extended CP, 0/5^{th} subframe). An accumulator may accumulate outputs for n SSS symbols for one or more ML-correlators. Inputs to successive accumulations may, for example, alternate between assumption of processing the 0^{th} and 5^{th} subframe.

A peak detector may search for the maximum metric amongst outputs of one or more, for example four, accumulators and may output the corresponding N_{ID}⁽¹⁾, CP type and frame timing.

CS stage 2 may have functional performance specifications. As an example of performance specifications, P_{d}>95% for P_{fa}<1×10⁻⁴ @ SNR=−8 dB under AWGN channel assuming no frequency offset (or 0.05 ppm).

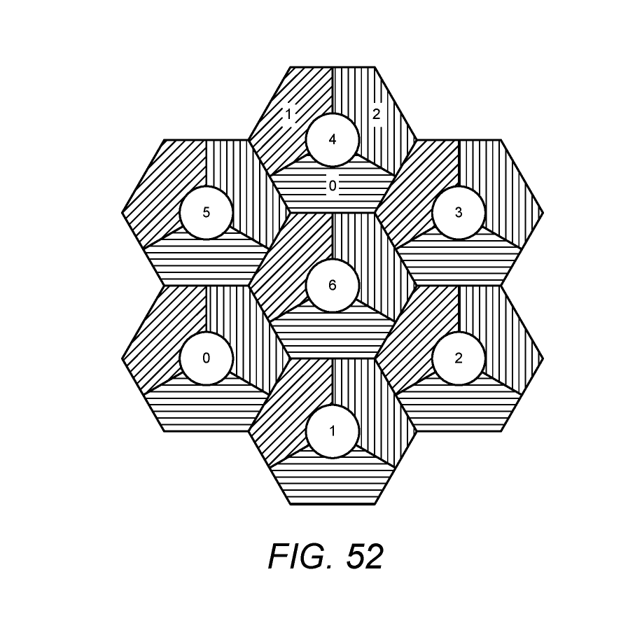

FIG. 52 is an example of deployment. A deployment may be used, for example, to analyze scenario dependent requirements.

Table 58 illustrates an example of CS stage 2 inputs.

TABLE 58
Example of CS Stage 2 Inputs

| Name | Description | Source | Comment |
|---|---|---|---|
| y_{PSCH} | P-SCH samples in | CS Stage-1 signal | 62 samples out of |
| | freq domain | processing | 128-points FFT |
| Y_{SSCH} | S-SCH samples in | CS Stage-1 signal | 62 samples out of |
| | freq domain, a | processing | 128-points FFT |
| | vector (N_{R} × 1) | | |
| N_{ID}⁽²⁾ | Physical-layer | CS controller | Range: 0 to 2 |
| | identity within the | | |
| | physical-layer cell- | | |
| | identity group | | |
| Nrx | Number of receive | CS controller/system | 1 or 2 |
| | antennas | parameter | |
| CS2_SIC_Enable | Enable SIC function | CS controller | On, off |
| CS2_SIC_N_Intf | Number of | CS controller | 1 to 5 |
| | interferers for SIC | | |
| CS2_SIC_Intf_Cell_ID | Cell ID per interferer | CS controller | 1 to 5 |
| | for SIC | | |

Table 59 illustrates examples of Stage 2 Outputs.

TABLE 59
Examples of Stage 2 Outputs.

| Name | Description | Comment |
|---|---|---|
| N_{ID}⁽¹⁾ | physical-layer cell-identity | Range: 0 to 167 |
| | group | |
| CS2_fr | Radio frame boundary | Frame number 0 or 5 |
| CS2_CP_length | CP length | Short or extended |
| CS2_ID_count | Number of cell IDs detected | 0 to 2 |

Table 60 presents an example of Stage 2 Parameters.

TABLE 60
Example of Stage 2 Parameters.

| Name | Description | Comment |
|---|---|---|
| CS2_W_size | Size of sliding window for | Default: 5 |
| | CHEST | |
| CS2_Max_FrIntg_Count | Maximum number of frame | 1 to 4 |
| | integration | |
| CS2_TH_1 | Threshold for stage-1 of S- | Default: 6, 12 |
| | SCH detection | for SIC |
| | (Even_Detector) | processing |
| CS2_TH_2 | Threshold for stage-2 of S- | Default: 3, 10 |
| | SCH detection | for SIC |
| | (Odd_Detector) | processing |
| CS2_TH_3 | Threshold for subframe | Default: |
| | combining | CS2_TH1 + |
| | | CS2_TH2 + 1 |
| CS2_1TS_TH_1 | Threshold for no frame | Default: |
| | integration (one time slot) | CS_TH1 + 2 |
| | (Even_Detector) | |
| CS2_1TS_TH_2 | Threshold for no frame | Default: |
| | integration (one time slot) | CS_TH2 + 2 |
| | (Odd_Detector) | |
| CS2_SIC_THs | Threshold scale factor for | Default: 2 |
| | SIC processing | |

A CS stage 2 function may process N significant paths in a specified time.

Systems, methods, and instrumentalities have been disclosed for LTE cell search and measurements component design. Cell search operating modes may comprise, for example, initial cell selection, stored information cell selection and target cell selection. An LTE cell search (CS) may be performed, for example, by acquiring a coarse estimate of a carrier frequency offset (CFO), detecting a primary synchronization signal (PSS) index, e.g., by maximum likelihood (ML) PSS detection, determining a secondary synchronization sequence (SSS), extracting from the SSS a cell identity (ID) group, a frame boundary and a cyclic prefix (CP) length or type and determining a cell ID. The processes and instrumentalities described herein may apply in any combination, may apply to other wireless technologies, and for other services.

A WTRU may refer to an identity of the physical device, or to the user's identity such as subscription related identities, e.g., MSISDN, SIP URI, etc. WTRU may refer to application-based identities, e.g., user names that may be used per application.

One or more techniques contemplate efficient implementation of SSS detection in LTE/LTE-A.

In LTE/LTE-A systems, the cell search procedure may involve detecting and/or measuring one or more, or multiple, cells. During secondary synchronization signal/sequence (SSS) detection, candidate peaks may be processed to determine the nid1 of one or more, or all, the observed cells. SSS detection may be performed in the frequency domain. This may imply that one or more, or multiple FFTs may be performed to process one or more, or all, of the observed multipath.

In a low cost MTC design where hardware and/or power may be constrained, there may be a premium on how many times an FFT engine can run. One or more techniques may provide a way to efficiently reuse the FFT engine and/or minimize the number of times it may run to process the SSS signal, perhaps for example while keeping the performance degradation within acceptable limits.

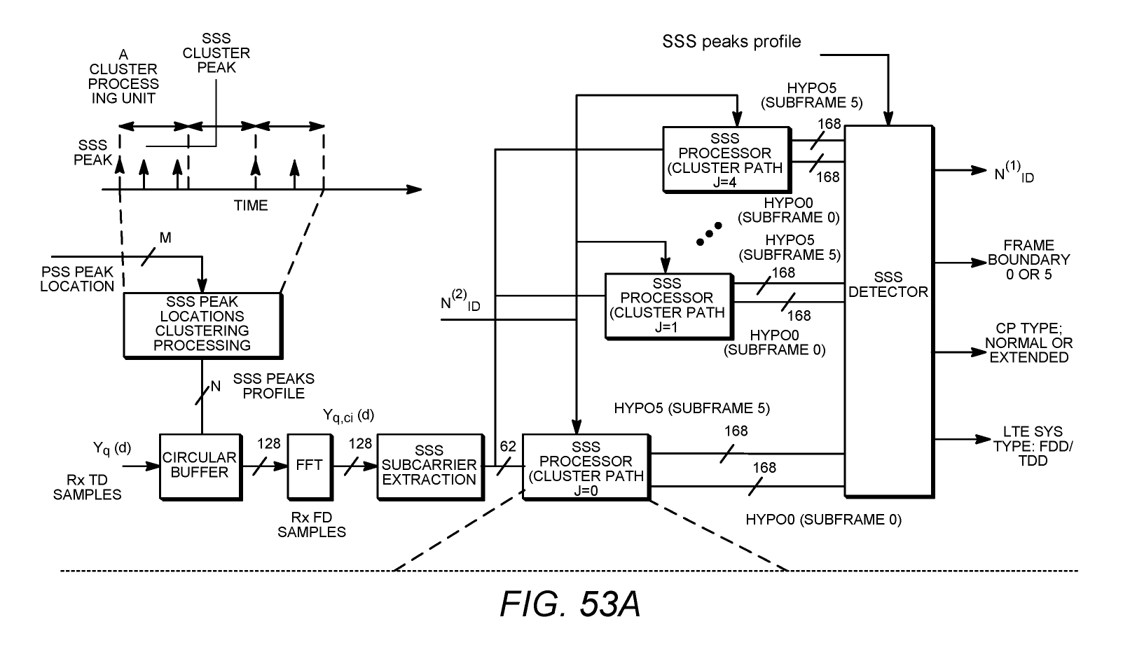

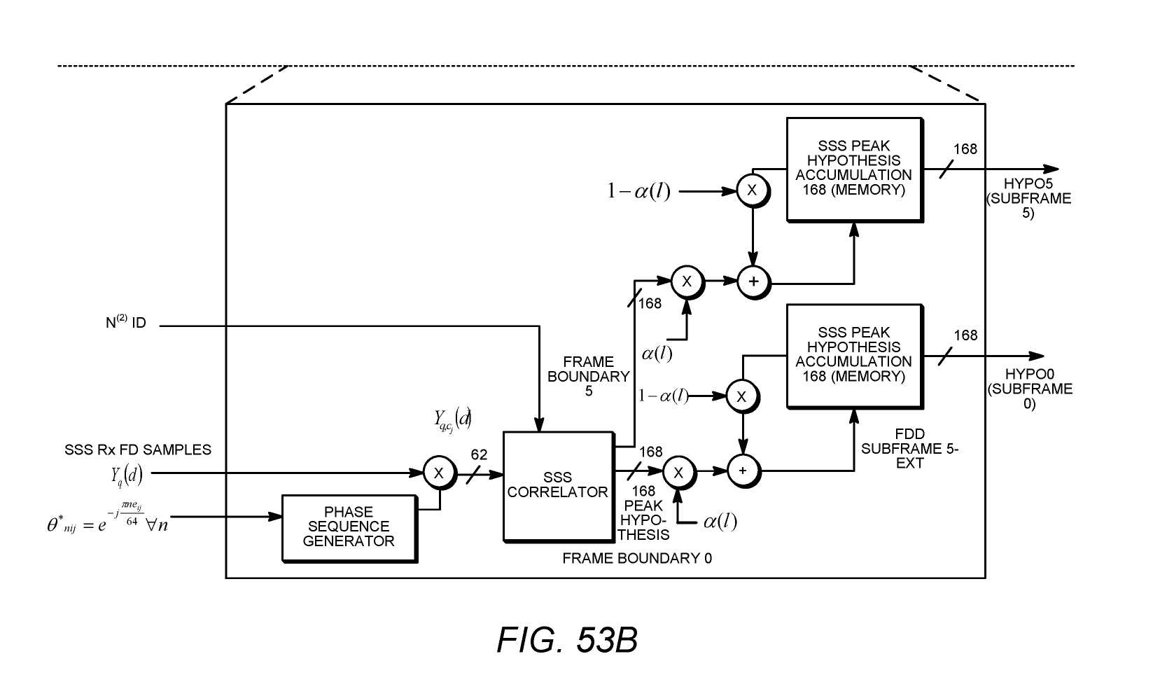

FIG. 53A and FIG. 53B show how one or more, or multiple, SSS peaks may be detected. Perhaps for example based on the detected primary synchronization signal/sequence (PSS) candidate locations, segments of samples corresponding to associated SSS hypotheses may be extracted from the input signal to process for SSS peaks. One or more PSS location and/or (e.g., correspondingly) one or more SSS location may be processed. This may occur for example in TDD deployments where cells may be synchronous and/or may cause the location of the synchronization signals from different cells to overlap in time and/or their multipath may be co-located (e.g., within a few is of each other).

The locations to be processed may be grouped into one or more clusters, perhaps for example based on proximity of the locations to each other. A FFT may be performed (for example, only one FFT) for a given cluster at a reference location. The same FFT output may be reused with a phase correction for other SSS candidate locations within that cluster. By obviating the need for additional FFTs, the described techniques may save N*log(N) multiplies per additional FFT and/or may remove the associated latency that may arise from the multiple stages of the FFT.

The phase correction vector may be deterministic and/or based on the time difference between the reference location and the true location of the candidate SSS peak. Techniques may use inter-symbol interference (ISI) for locations other than the reference. The ISI (and/or consequent performance loss) may be traded-off against hardware complexity and/or power savings. The cluster size and/or location of the reference may be selected dynamically and/or deterministically.

The cluster size and/or location of the reference within the cluster can be designed such that the increased ISI causes negligible performance penalty. For example, consider a design where the latency through an FFT engine is 1.5 μs and the received signal is sampled at 1.92 MHz. The sample interval here may be 0.52 μs. A cluster size of 4 samples may exceed the FFT engine latency. One or more techniques may obviate the need for running multiple FFT engines in parallel, perhaps when one or more, or multiple, SSS locations may be processed within this cluster (for example, as may be the case in TDD and/or synchronous FDD).

FIG. 53A and FIG. 53B show an example architecture of the proposed scheme in the SSS detection stage of cell search. The FFT block runs per cluster (for example once per cluster). The phase correction is shown as part of the zoomed-in SSS-processor in FIG. 53B.

FIG. 53A and FIG. 53B may assume that the input time signal is 1.4 MHz and/or is sampled at 1.92 MHz. The input time domain SSS signal is denoted as y_{q}(d). For the i-th SSS cluster, the SSS signal denoted as y_{q,c}_{ᵢ}(d) may be processed through an FFT engine. The FFT output is denoted as W_{q,c}_{ᵢ}(k), k=0, . . . , 127. 62 subcarriers are extracted from W_{q,c}_{ᵢ}(k). The extraction rule for each cluster i is denoted as Y_{q,c}_{_{i,j}}=└Y_{q,c}_{_{i,j,}}(0)=W_{q,c}_{ᵢ}(97),Y_{q,c}_{_{i,j}}(1)=W_{q,c}_{ᵢ}(98), . . . Y_{q,c}_{_{i,j}}(30)=W_{q,c}_{ᵢ}(127),Y_{q,c}_{_{i,j}}(31)=W_{q,c}_{ᵢ}(1), . . . Y_{q,c}_{_{i,j}}(61)=W_{q,c}_{ᵢ}(31)┘. The extracted Y_{q,c}_{_{i,j}} is corrected by phase vector θ*ₙᵢⱼ=[θ(0), θ(1), . . . , θ(61)] respectively, where

$${θ}_{nij}^{*} ( k ) = \{ \begin{matrix}{e}^{- j \frac{π ( k - 31 ) {e}_{ij}}{64}} , & k = 0 , … 30 \\ {e}^{- j \frac{π ( k - 30 ) {e}_{ij}}{64}} , & k = 31 , … 61\end{matrix}$$

The phase corrected signal may be further processed downstream to detect the nid1.

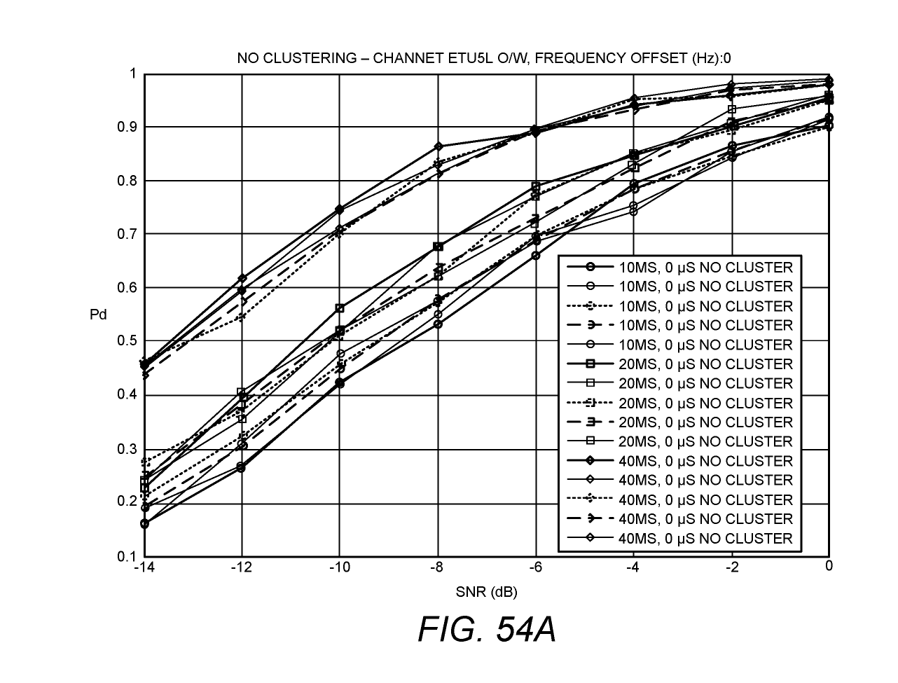

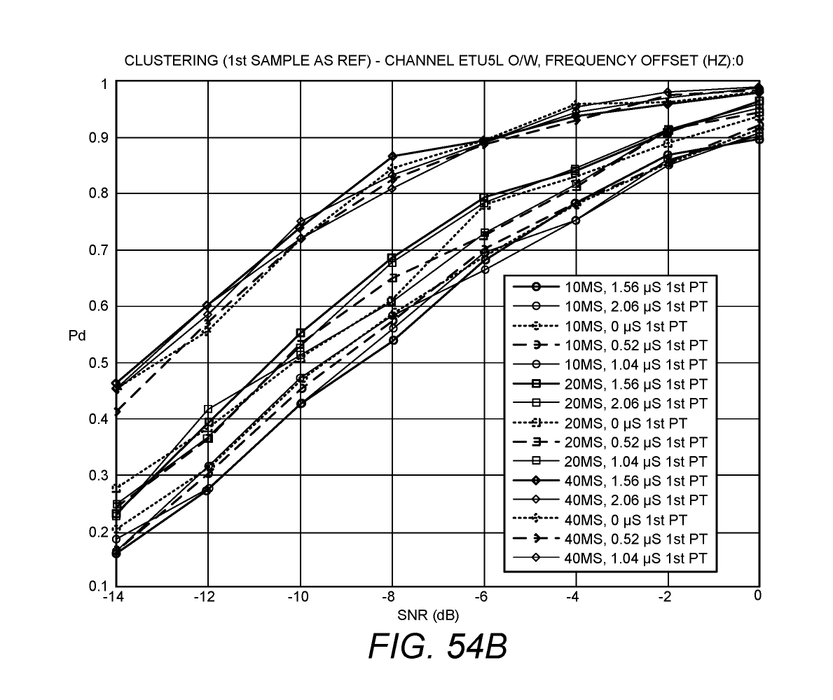

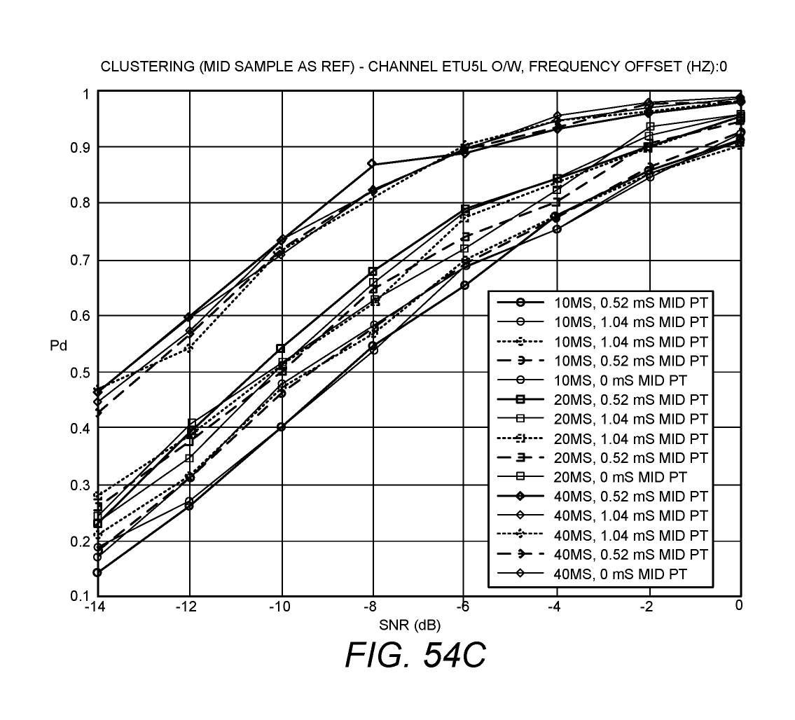

When the time difference is small between the reference and candidate location (for example within a few μs), the loss in performance may be negligible. For the example of cluster size of 4, FIG. 54A, FIG. 54B, and FIG. 54C show the probability of detection P_{d} with and without clustering. FIG. 54A shows the observed P_{d} without clustering. FIG. 54B and FIG. 54C show P_{d} with clustering using the first and mid-point of the cluster as a reference, respectively, for different locations of the candidate SSS peak. There is no observable loss in the described techniques with respect to no clustering.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

What is claimed is:

1. A method of performing channel estimation in a wireless transmit/receive unit (WTRU), the method comprising:
receiving, via a receiver, a downlink Orthogonal Frequency Division Multiplexing (OFDM) signal;
determining one or more Cell-Specific Reference Signal (CRS) symbols from the OFDM signal;
determining a mid-point resource element (RE) in time-domain (TD mid-point RE) using CRS from at least two of the one or more CRS symbols;
determining a mid-point resource element (RE) in frequency-domain (FD mid-point RE) using a multiple-tap sinc filter, the FD mid-point RE being based on at least one of the one or more CRS symbols that aligns with the TD mid-point RE;
determining a weighted average of the TD mid-point RE and the FD mid-point RE, the weighted average being a two-domain (2-D) mid-point RE; and
performing channel estimation based, at least in part, on the 2-D mid-point RE.

2. The method of claim 1, wherein the at least two of the one or more CRS symbols are respectively located in adjacent slots.

3. The method of claim 1, wherein a first of the at least two of the one or more CRS symbols precedes the TD mid-point RE in time and a second of the at least two of the one or more CRS symbols follows the TD mid-point RE in time.

4. The method of claim 1, wherein the weighted average includes a time-weighting factor and a frequency-weighting factor.

5. The method of claim 1, wherein the one or more CRS symbols are de-rotated.

6. The method of claim 1, wherein the multiple-tap sinc filter is a four-tap Finite Impulse Response (FIR) filter, and the four taps of the FIR filter are symmetric.

7. The method of claim 6, wherein the four-tap FIR filter includes at least two coefficients, the method further comprising applying the at least two coefficients to four-tap FIR filter based on the symmetry of the four taps.

8. The method of claim 1, wherein the determining the FD mid-point RE is further based on four reference signals (RS), a first RS and second RS of the four RS being lower in frequency than the FD mid-point RE and a third RS and a fourth RS being higher in frequency than the FD mid-point RE.

9. The method of claim 1, wherein the 2-D mid-point RE includes band-edge subcarriers (BE SC), the method further comprising:
extracting one or more BE SC from the 2-D mid-point RE prior to application of an Inverse Fast Fourier Transform (IFFT);
applying an Exponential Moving Average (EVA) Filter to the extracted one or more BE SC, the EVA filter minimizing band-edge distortion;
evaluating a signal to noise ratio (SNR) value following the application of an FFT to the 2-D mid-point RE; and
replacing at least one of the one or more BE SC with at least one of the extracted one or more EVA filtered BE SC upon the SNR exceeding a threshold.

10. The method of claim 1, further comprising:
interpolating with a non-uniform sample rate around a direct current (DC) subcarrier of the 2-D mid-point RE using two eight-tap poly-phase Finite Impulse Response (FIR) filters;
normalizing an output of the two FIR filters to restore one or more reference signal (RS) subcarriers and one or more mid-point subcarriers; and
downsampling the normalized output of the two FIR filters to a reference signal (RS) spacing and a mid-point subcarrier spacing, the downsampling performed prior to an application of an Exponential Moving Average (EVA) Filter.

11. The method of claim 1, wherein the production of the 2-D mid-point RE includes an image of a channel impulse response (CIR), the method further comprising:
generating one or more additional 2-D mid-point REs, the one or more additional 2-D mid-point REs including a respective image of the CIR, the one or more additional 2-D mid-point REs being associated with one or more CRS REs, and the one or more additional 2-D mid-point REs and the one or more CRS REs having an alternating pattern in consecutive symbols;
coherently combining the one or more CRS REs and the one or more additional 2-D mid-point REs such that the images of the CIR are effectively suppressed.

12. A method for generating a channel quality indicator (CQI) signal by a wireless transmit/receive unit (WTRU), the method comprising:
determining a first interim effective Signal to Noise and Interference Ratio (ESINR) (first ESINR) value corresponding to a first code word (first CW) of one or more code words using a first beta value;
determining a second ESINR value corresponding to the first CW using a second beta value;
determining a third ESINR value corresponding to the first CW using a third beta value;
mapping the first ESINR value to a first interim CQI index based on a linear SINR to CQI mapping;
mapping the second ESINR value to a second interim CQI index based on the linear SINR to CQI mapping;
mapping the third ESINR value to a third interim CQI index based on the linear SINR to CQI mapping;
determine a final CQI from at least one of: the first interim CQI index, the second interim CQI index, or the third interim CQI index;
generating the CQI signal based at least in part on the final CQI; and
sending, via a transmitter, the CQI signal.

13. The method of claim 12, wherein the first ESINR value, the second ESINR value, and the third ESINR value represent sub-band Signal to Noise and Interference Ratio (SINR) values for the first CW.

14. The method of claim 12, wherein the first beta value, the second beta value, and the third beta value are determined based at least in part on a wideband Signal to Noise and Interference Ratio (SINR) for the first CW as part of an exponential effective SINR mapping (EESM).

15. A method for primary synchronization sequence (PSS) detection performed by a wireless transmit/receive unit (WTRU), the method comprising:
receiving, via an antenna, a signal;
performing Maximum Likelihood (ML) PSS detection on the signal, the ML PSS detection producing one or more PSS correlation values for one or more frequency bins;
performing parabolic interpolation using the one or more PSS correlation values between the one or more frequency bins;
determining a first frequency bin of the one or more frequency bins, the first frequency bin including a largest PSS correlation value of the one or more PSS correlation values;
determining an initial estimate of a frequency offset (FO) for the PSS based at least in part on the parabolic interpolation; and
determining a PSS timing based at least in part on the first frequency bin.

16. The method of claim 15, wherein the one or more PSS correlation values are produced at least in part by one or more PSS Correlation Units.

17. The method of claim 16, wherein each of the one or more PSS Correlation Units include one or more PSS Autocorrelation Units.

18. The method of claim 15, further comprising:
identifying one or more samples of Orthogonal Frequency Division Multiplexing OFDM symbols based on the PSS timing; and
determining a further estimate of the FO based on the one or more samples, the further estimate determined without a determination of any Cyclic Prefix (CP) type.

19. The method for secondary synchronization sequence (SSS) detection performed by a wireless transmit/receive unit (WTRU), the method comprising:
determining a plurality of SSS candidate locations in time domain;
grouping one or more of the plurality of SSS candidate locations into one or more clusters based on a proximity of the SSS candidate locations to each other;
selecting a first cluster of the one or more clusters;
determining a reference location for the first cluster;
performing a Fast Fourier Transform (FFT) on the reference location of the first cluster;
applying an output of the FFT to a first SSS candidate location of the first cluster along with a first phase correction to produce a frequency domain representation of the first SSS candidate location; and
applying the output of the FFT to a second SSS candidate location of the first cluster along with a second phase correction to produce a frequency domain representation of the second SSS candidate location.

20. The method of claim 19, wherein the first phase correction compensates for a time difference between the reference location and the first SSS candidate location; and the second phase correction compensates for a time difference between the reference location and the second SSS candidate location.

21. The method of claim 19, wherein the FFT is a single FFT.

22. The method of claim 19, wherein at least one of a size of the first cluster, or the reference location of the first cluster is selected dynamically.
